(19) United States
(12) Patent Application Publication
(10) Pub. No.: US 2021/0379786 A1
(43) Pub. Date: Dec. 9, 2021

(54) CUTTING MACHINE

(71) Applicants: Michio NAGAI, Kawaguchi-shi, Saitama (JP); Yasuhito NAGAI, Kawaguchi-shi, Saitama (JP)

(72) Inventor: Michio NAGAI, Kawaguchi-shi, Saitama (JP)

(21) Appl. No.: 17/267,036

(22) PCT Filed: Jun. 10, 2019
(86) PCT No.: PCT/JP2019/022838

§ 371 Date: Feb. 9, 2021

(30) Foreign Application Priority Data
Jun. 8, 2018 (JP) 2018-110192
Jun. 8, 2018 (JP) 2018-115164
Jun. 13, 2018 (JP) 2018-112422
Jun. 15, 2018 (JP) 2018-114912
Aug. 10, 2018 (JP) 2018-151911
Sep. 3, 2018 (JP) 2018-164940
Sep. 3, 2018 (JP) 2018-164960
Sep. 4, 2018 (JP) 2018-165070
Sep. 12, 2018 (JP) 2018-170232
Nov. 5, 2018 (JP) 2018-208017
Nov. 14, 2018 (JP) 2018-213517
Nov. 19, 2018 (JP) 2018-216286
Dec. 5, 2018 (JP) 2018-227896
Jan. 21, 2019 (JP) 2019-007454

(51) Int. Cl. B26D 7/02; B26D 7/22

(52) U.S. Cl. CPC B26D 7/025; B26D 7/22

(57) ABSTRACT

Provide a safer cutting machine. A front portion detection means that is spaced downward from the lower end of the clamp gauge by a first predetermined distance and is positioned near the front edge of the clamp gauge in die front-rear direction of the clamp gauge, and a first predetermined distance from the lower end of the clamp gauge. The rear portion detection means and the clamp gauge which arc spaced apart from each other by a second predetermined distance different from the above distance and which are arranged at the rear portion of the front portion detection means in the front-rear direction of the clamp gauge move in the vertical direction. The height of the clamp gauge when the detection state/non-detection state of the rear portion detection means is switched by the paper stack when it is moving or not moving, and the front portion by an unknown object when the clamp gauge is moving vertically The height of the clamp gauge when the detection state/non-detection state of Ok detection means is switched, the difference between the first predetermined distance and the second predetermined distance, and the class of the intruding object. Based on the estimated dimension in the vertical direction of Pugeji to detect an intrusion object.

### TECHNICAL FIELD

The present invention relates to a cutting machine kw cutting a pew stack.

### BACKGROUND

Cutting machines for cutting paper and the like are widely used.

Referring to FIGS. 1, 2, and 3, the cutting machine includes a frame 901, a table 101, a back gauge 905, and a knife 907.

Referring FIGS. 4, 5, and 6, the cutting machine also includes a clamp gauge 107.

As shown in FIG. 6, the clamp gauge 107 is disposed behind the knife 907 with a slight gap from the knife 907. The clamp gauge 107 is suspended from above by a spring (not shown), a chain (not shown), and a sprocket (not shown). The clamp gauge 107 is lowered by a hydraulic cylinder (not shown) driven by a hydraulic circuit (not shown) and a predetermined mechanism (not shown).

A paper stack (not shown) placed on the table 101 is abutted against a back gauge 905 that has moved to the vicinity of the beck of the table 101 by an operator, for example. The back gauge 905 can be moved in the front-rear direction by the computer and the back gauge driving mechanism, and stops at a position according to the trimming dimension of the paper stack set in the computer by the user.

The paper stack that is stopped while being in contact with the back gauge 905 is clamped by the clamp gauge 107 that has descended from above slightly behind the knife 907.

The paper stack in the clamped state is cut by a knife 907 that swings down from above.

### PATENT DOCUMENT 1

JP 2016-147358 A

### DISCLOSURE OF THE INVENTION

### Problems to be Solved by the Invention

By the way, when actually cutting the paper stack, the operator finely adjusts the position of the back gauge 905 by operating a dial for adjusting the back gauge position or the operation panel when the clamp gauge 107 is near the top dead center. When the back gauge 905 teaches a desired position, the paper stack is abutted against the back gauge 905 with a finger or an auxiliary tool, and the clamp paper is clamped from above by pressing the clamp pedal. In this state, the paper stack is cut by the knife 907 when the operator presses the two-hand button for lowering the knife.

The actual work is more complicated than this, and the position of the back gauge 905 is finely adjusted while the paper stack is abutted against the back gauge 905 with fingers, and the clamp gauge 107 is depressed by depressing the pedal during the fine adjustment. Sometimes the paper stack is clamped on a trial basis.

In such an operation, the operator adjusts the position of the loaded paper while directly holding or grasping the loaded paper from the front or diagonally with his/her fingers. Therefore, the vicinity of the tip of the finger may get on the loaded paper and enter below the clamp gauge 107. At this time, if the operator depresses the pedal by mistake and lowers the clamp gauge 107, the finger or the like may be pinched by the paper stack and the clamp gauge 107, and the finger may be injured.

Therefore, it is desired that such danger does not occur.

Some cutting machines have a so-called “soft clamp”. According to this “soft clamp”, the clamp gauge is controlled so that the target clamp pressure is generated only after the clamp gauge reaches the paper stack. However, actually, the clamp pressure generated when a finger or the like is pinched before the clamp gauge reaches the paper stack becomes high, which may cause the finger to be injured.

The cutting machine disclosed in the Patent Document 1 is intended to detect a finger or the like placed on a paper stack by using two sensors having different positions in the vertical direction and the depth direction and a predetermined logic. It is. There is an explanation that when it is determined that a finger or the like is placed on the paper stack by a predetermined logic, the clamp gauge performs an operation opposite to the clamp operation.

Therefore, it can be said that the cutting machine disclosed in the Patent Document 1 is considerably safer than the “soft clamp” because the former avoids that the clamp gauge pinches the finger with the loaded paper in the first place and the latter assumes that the clamp gauge has pinched a finger with the loaded paper.

However, it cannot be said that the cutting machine disclosed in the Patent Document 1 has sufficient safety measures.

The Patent Document 1 has an explanation that an intruding object can be distinguished from a wave or wrinkle of a paper stack, but the explanation is unclear and its feasibility is doubtful.

Therefore, an object of the present invention is to provide the cutting machine which can surely prevent the accident which damages a finger with a clamp gauge.

### Means for Solving the Problems

According to the present invention,
A cutting machine for clamping a paper stack loaded on a table with a clamp gauge from above and cutting with a knife.
A front portion detection means that is spaced downward from the lower end of the clamp gauge by a first predetermined distance, and is disposed at a position near the front edge of the clamp gauge in the longitudinal direction of the clamp gauge;
The clamp gauge is spaced downward by a second predetermined distance different from the first predetermined distance from the lower end of the clamp gauge, and is arranged at a position behind the front portion detection means in the front-rear direction of the clamp gauge. Rear portion detection means,
The height of the clamp gauge when the detection state/non-detection state of the rear portion detection means is switched by the paper stack when the clamp gauge is moving in the vertical direction, and the clamp gauge is moving in the vertical direction. The height of the clamp gauge when the detection state/non-detection state of the front portion detection means is switched by an unknown object when it is moving or not moving, and the difference between the first predetermined distance and the second predetermined distance And a determining means for determining whether the unknown object is the paper stack or the intruding object based on the estimated size of the intruding object in the vertical direction of the clamp gauge;
A cutting machine is provided.

Moreover, according to the present invention,
A cutting machine for clamping a paper stack loaded on a table with a clamp gauge from above and cutting with a knife.
A front portion detection means that is spaced downward from the lower end of the clamp gauge by a first predetermined distance, and is disposed at position near the front edge of the clamp gauge in the longitudinal direction of the clamp gauge;
The clamp gauge is spaced downward by a second predetermined distance different from the first predetermined distance from the lower end of the clamp gauge, and is arranged at a position behind the front portion detection means in the front-rear direction of the clamp gauge. Rear portion detection means,
The time when the detection state/non-detection state of the rear portion detection means is switched by the paper stack when the clamp gauge is moving in the vertical direction, and then the clamp gauge is continuously moved in the same direction. When the detection state/non-detection state of the front portion detection means is switched by an unknown object when moving, and the difference between the first predetermined distance and the second predetermined distance, and the intruding object Determination means for determining whether the unknown object is the paper stack or the intruding object based on the estimated dimension of the clamp gauge in the vertical direction and the velocity of ascending or descending of the clamp gauge;
A cutting machine is provided.

Furthermore, according to the present invention,
A cutting machine for clamping a paper stack loaded on a table with a clamp gauge from above and cutting with a knife.
A front portion detection means that is spaced downward from the lower end of the clamp gauge by a first predetermined distance, and is disposed at a position near the front edge of the clamp gauge in the longitudinal direction of the clamp gauge;
A rear portion detection means that is spaced apart from the lower end of the clamp gauge by the first predetermined distance, and is arranged at a position on the rear portion of the front portion detection means in the front-rear direction of the clamp gauge;
If the front portion detection means does not change from the non-detection state to the detection state even after the first predetermined period has elapsed since the front portion detection means changes from the non-detection state to the detection state due to an unknown object, the unknown A determination means for determining that the object is an intruding object;
A cutting machine is provided.

Furthermore, according to the present invention,
A cutting machine for clamping a paper stack loaded on a table with a clamp gauge from above and cutting with a knife.
The front portion of the clamp gauge that is disposed in the vicinity of the front edge of the clamp gauge in the front-rear direction of the clamp gauge and that measures the distance from the object below the front edge of the clamp gauge to the clamp gauge as the front portion detection distance Detection means;
An object that is disposed at a position behind the front portion detection means in the front-rear direction of the clamp gauge, and that is below the plan gauge on the rear portion than a position at which the front portion detection means measures a distance in the front-rear direction. A rear portion detecting means for measuring a distance from the clamp gauge as a rear portion detection distance;
Determination means for determining whether an intruding object is placed on the paper stack based on a difference between the front portion detection distance and the rear portion detection distance;
A cutting machine is provided.

Furthermore, according to the present invention,
A cutting machine for clamping a paper stack loaded on a table with a clamp gauge from above and cutting with a knife.

The front portion of the clamp gauge that is disposed in the vicinity of the front edge of the clamp gauge in the front-rear direction of the clamp gauge and that measures the distance from the object below the frost edge of the clamp gauge to the clamp gauge as the front portion detection distance Detection means;
An object that is disposed at a position behind the front portion detection means in the front-rear direction of the clamp gauge, and that is below the plan gauge on the rear portion than a position at which the front portion detection means measures a distance in the front-rear direction. A rear portion detecting means for measuring a distance from the clamp gauge as a rear portion detection distance;
Based on a temporal change in the difference between the front portion detection distance and the rear portion detection distance, a determination unit for determining whether an object has entered the paper stack;
A cutting machine is provided.
Furthermore, according to the present invention,

A cutting machine for clamping a paper stack loaded on a table with a clamp gauge from above and cutting with a knife.

The front portion of the clamp gauge that is disposed in the vicinity of the front edge of the clamp gauge in the front-rear direction of the clamp gauge and that measures the distance from the object below the front edge of the clamp gauge to the clamp gauge as the front portion detection distance Detection means;
A height detecting means for measuring the height of the plan gauge;
Determination means for determining whether or not an object has entered the paper stack based on a temporal change in the difference between the front portion detection distance and the height; A cutting machine is provided.

### The Invention's Effect

### Advantage of the Invention

According to this invention, the accident which damages a finger with a clamp gauge can be surely prevented.

### BRIEF DESCRIPTION OF THE DRAWINGS

FIG. 1 is a front view of the cutting machine;

FIG. 2 is a top view of the cutting machine;

FIG. 3 is a side view of the cutting machine;

FIG. 4 is another front view of the cutting machine;

FIG. 5 is another top view of the cutting machine;

FIG. 6 is another side view of the cutting machine;

FIG. 7 is a conceptual front view showing a clamp gauge and its peripheral part according to a first embodiment of the present invention;

FIG. 8 is a conceptual side view showing the clamp gauge and its peripheral part according to the first embodiment of the present invention;

FIG. 9 is a first conceptual front view for explaining the principle of the clamp gauge control device according to the first embodiment of the present invention;

FIG. 10 is a second conceptual front view for explaining the principle of the clamp gauge control device according to the first embodiment of the present invention;

FIG. 11 is a third conceptual front view for explaining the principle of the clamp gauge control device according to the first embodiment of the present invention;

FIG. 12 is a fourth conceptual front view for explaining the principle of the clamp gauge control device according to the first embodiment of the present invention;

FIG. 13 is a flowchart for explaining the operation of the clamp gauge control device according to the first embodiment of the present invention;

FIG. 14 is a side view which shows a case where it is detected that a finger is placed on the paper stack provided that the height difference between a preceding detection device and a main detection device is larger than the thickness of the finger to be detected in a third embodiment of the present invention;

FIG. 15 is a side view which shows a case where it is detected that a finger is not placed on the paper stack provided that the height difference between the preceding detection device and the main detection device is larger than the thickness of the finger to be detected in a third embodiment of the present invention;

FIG. 16 shows how to determine, on the basis of detection heights by the preceding detection device and the main detection device, whether or not a finger is placed on the paper stack provided that the height difference between the preceding detection device and the main detection device is larger than the thickness of the finger to be detected in a third embodiment of the present invention;

FIG. 17 shows how to determine, on the basis of detection times by the preceding detection device and the main detection device, whether or not a finger is placed on the paper stack provided that the height difference between the preceding detection device and the main detection device is larger than the thickness of the finger to be detected in a third embodiment of the present invention;

FIG. 18 is a side view which shows a case where it is detected that a finger is placed on the paper stack provided that the height difference between a preceding detection device and a main detection device is smaller than the thickness of the finger to be detected in a third embodiment of the present invention;

FIG. 19 is a side view which shows a case where it is detected that a finger is not placed at the paper stack provided that the height difference between the preceding detection device and the main detection device is smaller than the thickness of the finger to be detected in a third embodiment of the present invention;

FIG. 20 shows how to determine, on the basis of detection heights by the preceding detection device and the main detection device, whether or not a finger is placed on the paper stack provided that the height difference between the preceding detection device and the main detection device is smaller than the thickness of the finger to be detected in a third embodiment of the preset invention;

FIG. 21 shows how to determine, on the basis of detection heights by the preceding detection device and the main detection device, whether or not a finger is placed on the paper stack provided that the height difference between the preceding detection device and the main detection device is smaller than the thickness of the finger to be detected in a third embodiment of the present invention;

FIG. 22 is a flowchart for explaining an operation of the clamp gauge control device according to the third embodiment of the present invention;

FIG. 23 is a diagram for explaining the principle of a method for detecting the presence or absence of a finger using a height difference according to the third embodiment of the present invention;

FIG. 24 is a diagram for explaining a range in which the presence/absence of a finger is detected by the method described with reference to FIG. 22;

FIG. 25 is a flowchart for explaining another operation of the clamp gauge control device according to the third embodiment of the present invention;

FIG. 26 is a diagram for explaining the principle of a method for detecting the presence/absence of a finger using a time difference according to the third embodiment of the present invention;

FIG. 27 is a diagram for explaining a range in which the presence/absence of a finger is detected by the method described with reference to FIG. 25;

FIG. 28 is a flow chart illustrating a simplified variation method of the third embodiment of the present invention;

FIG. 29 is a conceptual front view showing a clamp gauge and its peripheral part according to a fourth embodiment of the present invention;

FIG. 30 is a conceptual side view showing a clamp gauge and its periphery according to the fourth embodiment of the present invention;

FIG. 31 is a first flowchart for explaining the operation of the clamp gauge control device according to the fourth embodiment of the present invention;

FIG. 32 is a second flowchart for explaining the operation of the clamp gauge control device according to the fourth embodiment of the present invention;

FIG. 33 is a third flowchart for explaining the operation of the clamp gauge control device according to the fourth embodiment of the present invention;

FIG. 34 is a first state transition diagram for explaining the sixth and seventh embodiments of the present invention;

FIG. 35 is a second state transition diagram for explaining a sixth embodiment of the present invention;

FIG. 36 is a second state transition diagram for explaining the seventh embodiment of the present invention;

FIG. 37 is a conceptual first view showing a clamp gauge and its peripheral part according to a ninth embodiment of the present invention;

FIG. 38 is a conceptual side view showing a clamp gauge and its peripheral part according to the ninth embodiment of the present invention;

FIGS. 39A to 39C are diagrams for explaining the detection status of the line detection device for each of the three distances of the paper stack and the clamp gauge in the ninth embodiment of the present invention;

FIG. 40 is a graph showing the relationship of the distance between the paper stack and the clamp gauge with the detected light intensity in the ninth embodiment of the present invention;

FIG. 41 is a diagram showing detected light intensity P, detected light intensity Q, and their difference R along the time axis when nothing enters between the paper stack and the clamp gauge in the ninth embodiment of the present invention;

FIG. 42 is a diagram showing detected light intensity P, detected light intensity Q and their difference R along the time axis when nothing enters between the paper stack and the clamp gauge in the ninth embodiment of the present invention;

FIGS. 43A to 43C are diagrams for explaining an operation example when a finger enters between the paper stack and the stack paper separated by a certain distance from the paper stack in the ninth embodiment of the present invention;

FIG. 44 is a diagram illustrating detected light intensity P, detected light intensity Q, and a difference R thereof along the time axis in the operation example illustrated in FIG. 71;

FIGS. 45A to 45C are diagrams for explaining an operation example when a finger enters between the paper stack and the clamp gauge separated by another certain distance from the paper stack in the ninth embodiment of the present invention;

FIG. 46 is a diagram showing detected light intensity P, detected light intensity Q, and a difference R thereof along the time axis in the operation example shown in FIG. 74;

FIG. 47 illustrates an operation example when a finger enters a shallow position in the depth direction between a paper stack and a paper stack separated by a certain distance from the paper stack in the ninth embodiment of the present invention;

FIGS. 48A to 48C are diagrams for explaining an operation example when a finger enters between a paper stack and a paper stack that is separated from the paper stack by a certain distance and has a raised front end in the ninth embodiment of the present invention;

FIG. 49 is a diagram showing detected light intensity P and detected light intensity Q along the time axis in the operation example shown in FIG. 48;

FIG. 50 is a diagram showing the difference R between the detected light intensity P and the detected light intensity Q, the delayed difference R between the detected light intensity P and the detected light intensity Q, and the secondary Mimeo RR along the time axis in the operation ample shown in FIG. 48;

FIGS. 51A to 51C are diagrams for explaining an operation example when a finger enters between a paper stack and a paper stack separated by a certain distance from the paper stack in the ninth embodiment of the present invention;

FIG. 52 shows a case where a finger enters between the paper stack end the paper stack which is separated from the paper stack by a certain distance and has a flat upper surface (as shown in FIG. 51) in the ninth embodiment of the invention. It is a figure which shows the detected light intensity P, the detected light intensity Q, and the detected light intensity P along the time axis in an operation example;

FIG. 53 shows a case in which a finger enters between the paper stack and a paper stack that is separated from the paper stack by a certain distance and has a flat upper surface in the ninth embodiment of the present invention (as shown in FIG. 51). It is a figure which shows the difference R of the detected light intensity P and the detected light intensity Q along the time axis in this operation example, the delayed difference R′ of the detected light intensity P and the detected light intensity Q, and the secondary difference RR;

FIGS. 54A to 54C are diagrams for explaining an operation example when the clamp gauge descends to a flat paper stack in the ninth embodiment of the present invention;

FIG. 55 is a diagram showing detected light intensity P and detected light intensity Q along the time axis in the operation example shown in FIG. 54;

FIG. 56 is a diagram showing the difference R between the detected light intensity P and the detected light intensity Q, the delayed difference R′ between the detected light intensity P and the detected light intensity Q, and the secondary difference RR along the time axis in the operation example shown in FIG. 54;

FIGS. 57A to 57C are diagrams for explaining an operation example when the clamp gauge descends to a paper stack comprised with a step in the ninth embodiment of the present invention;

FIG. 58 is a diagram showing detected light intensity P and detected light intensity Q along the time axis in the operative example shown in FIG. 57;

FIG. 59 is a diagram showing the difference R between the detected light intensity P and the detected light intensity Q, the delayed difference R′ between the detected light intensity P and the detected light intensity Q, and the secondary difference RR along the time axis in the operation example shown in FIG. 57;

FIGS. 60A to 60C are diagrams for explaining an operation example when a finger enters between the clamp gauge and a flat paper stack when the clamp gauge is lowered to the flat paper stack in the ninth embodiment of the present invention;

FIG. 61 is a diagram illustrating the detected light intensity P, the detected light intensity Q, and the difference R between the detected light intensity P and the detected light intensity Q along the time axis in the operation example illustrated in FIG. 60;

FIG. 62 shows, the difference R between the detected light intensity P and the detected light intensity Q, the delayed difference R′ between the detected light intensity P and the detected light intensity Q, and the secondary difference RR along the time axis in the operation example shown in FIG. 60;

FIGS. 63A to 63C are diagrams for explaining an operation example when an object lower than a finger enters between the clamp gauge and a flat paper stack when the clamp gauge descends to the flat paper stack in the ninth embodiment of the present invention;

FIG. 64 is a diagram showing the detected light intensity P, the detected light intensity Q, and the difference R between the detected light intensity P and the detected light intensity Q along the time axis in the operation example shown in FIG. 63;

FIG. 65 is a diagram showing the difference R between the detected light intensity P and the detected light intensity Q, the delayed difference R′ between the detected light intensity P and the detected light intensity Q, and the secondary difference RR along the time axis in the operation example shown In FIG. 63;

FIGS. 66A to 66C are diagrams for explaining an operation example when an object lower than a finger enters between the clamp gauge and a paper stack comprised with a step when the clamp gauge descends to the paper stack in the ninth embodiment of the present invention;

FIG. 67 is a diagram illustrating the detected light intensity P, the detected light intensity Q, and the difference R between the detected light intensity P and the detected light intensity Q along the time axis in the operation example illustrated in FIG. 66;

FIG. 68 is a diagram showing the difference R between the detected light intensity P and the detected light intensity Q, the delayed difference R′ between the detected light intensity P and the detected light intensity Q, and the secondary difference RR along the time axis in the operation example shown in FIG. 66;

FIG. 69 is a flowchart for explaining the operation of the clamp gauge control device according to the ninth embodiment of the present invention;

FIG. 70 is a flowchart for explaining another operation of the clamp gauge control device according to the ninth embodiment of the present invention;

FIG. 71 is a conceptual front view showing a clamp gauge and its peripheral part according to a tenth embodiment of the present invention;

FIG. 72 is a conceptual side view showing a clamp gauge and its peripheral part according to a tenth embodiment of the preset invention;

FIG. 73 is a conceptual from view showing a clamp gauge and its periphery according to an eleventh embodiment of the present invention;

FIG. 74 is a conceptual side view showing a clamp gauge and its periphery according to an eleventh embodiment of the present invention;

FIG. 75 is a diagram for explaining an operation when a finger enters during a period in which the clamp gauge according to the eleventh embodiment of the present invention is stationary;

FIG. 76 is a diagram for explaining an operation when a finger enters during a period in which the clamp gauge according to the eleventh embodiment of the present invention is ascending;

FIG. 77 is a diagram for explaining an operation when a finger enters during a period in which the clamp gauge according to the eleventh embodiment of the present invention is descending;

FIG. 78 is a diagram for explaining an operation when nothing enters during a period in which the clamp gauge according to the eleventh embodiment of the present invention is ascending;

FIG. 79 is a diagram for explaining an operation when nothing enters during the period in which the clamp gauge of the eleventh embodiment of the present invention is descending;

FIG. 80 is a conceptual front view showing a clamp gauge and its periphery according to a twelfth embodiment of the present invention;

FIG. 81 is a conceptual side view showing a clamp gauge and its periphery according to a twelfth embodiment of the present invention;

FIG. 82 is a conceptual front view showing a clamp gauge and its periphery according to a thirteenth embodiment of the invention;

FIG. 83 is a conceptual side view showing a clamp gauge and its periphery according to a thirteenth embodiment of the invention;

FIG. 84 is a diagram for explaining an operation when a finger enters during a period in which the clamp gauge according to the thirteenth embodiment of the present invention is stationary;

FIG. 85 is a diagram for explaining an operation when a finger enters during a period in which the clamp gauge according to the thirteenth embodiment of the present invention is ascending;

FIG. 86 is a diagram for explaining an operation when a finger enters dining a period in which the clamp gauge according to the thirteenth embodiment of the present invention is descending;

FIG. 87 is a diagram for explaining the operation when nothing enters during the period when the clamp gauge according to the thirteenth embodiment of the present invention is ascending;

FIG. 88 is a diagram for explaining an operation when nothing enters during a period in which the clamp gauge according to the thirteenth embodiment of the present invention is descending;

FIG. 89 is a front view for illustrating a finger detection method according to the fourteenth embodiment of the present invention;

FIG. 90 is a front view showing a method for detecting a rolled-up paper according to a fourteenth embodiment of the present invention;

FIG. 91 is a conceptual front view showing a clamp gauge and its periphery according to a fifteenth embodiment of the present invention;

FIG. 92 is a conceptual side view showing a clamp gauge and its periphery according to a fifteenth embodiment of the present invention;

FIG. 93 is a front view showing a clamp and a safety device attached thereto according to a sixteenth embodiment of the present invention;

FIG. 94 is a side view showing a clamp and a safety device attached thereto according to a sixteenth embodiment of the present invention;

FIG. 95 is a diagram showing a first state in a case where a finger is placed on paper in the sixteenth embodiment of the present invention;

FIG. 96 is a diagram showing a second state in a case where a finger is placed on paper in the sixteenth embodiment of the present invention;

FIG. 97 is a side view showing a clamp and a safety device attached thereto according to a sixteenth embodiment of the present invention;

FIG. 98 is a diagram showing a first state in a case where a finger is not placed on paper in the sixteenth embodiment of the present invention;

FIG. 99 is a diagram showing a second state in a case where a finger is not placed on paper in the sixteenth embodiment of the present invention;

FIG. 100 is a flowchart for explaining the operation of the sixteenth embodiment of the present invention;

FIG. 101 is a diagram showing state transitions of the immediately lower front portico detection device and the immediately lower rear portion detection device provided that a paper stack is flat according to the seventeenth embodiment of the present invention;

FIG. 102 is a diagram showing state transitions of the immediately lower front portion detection device and the immediately lower rear portion detection device provided that the front portion of the paper stack is raised according to the seventeenth embodiment of the present invention;

FIG. 103 is a timing diagram for explaining a method of detecting a transition from state #N3 to state #N4 shown in FIG. 103;

FIG. 104 is a timing diagram for explaining a method of detecting a transition from state #N3 to state #N4 via state #N4B shown in FIG. 102;

FIG. 105 is a timing diagram for explaining a method of detecting a transition from state #N3 to state #E12 shown in FIG. 101 or FIG. 102;

FIG. 106 is a diagram illustrating a difference in the amount of protrusion on the front portion with respect to the far side of the paper stack;

FIG. 107 is a diagram showing a state transition in the case where the rear portion of the paper stack is raised with respect to the front portion in the seventeenth embodiment of the present invention;

FIG. 108 is a diagram showing a state transition in a case where the paper stack is flat in the seventeenth embodiment of the present invention;

FIG. 109 shows two timing diagrams comparing two types of elapsed times from when the immediately below detection device changes from the non-detection state to the detection state until the immediately lower rear portion detection device changes from the non-detection state to the detection state while the clamp gauge is descending toward a paper stack respectively in two cases, one of which is a case where the paper stack is comprised with the front portion raised relative to the rear portion, and the other of which is a case where the paler stack is flat and a finger is on the paper stack;

FIG. 110 shows two timing diagrams taking the time when the immediately lower rear portion detection device changes from the non-detection state to the detection state as a reference time and comparing two types of elapsed times from when the immediately below detection device changes from the non-detection state to the detection state until the immediately lower rear portion detection device changes from the non-detection state to the detection state while the clamp gauge is descending toward a paper stack respectively in two cases;

FIG. 111 shows two timing diagrams taking the time when the immediately lower front portion detection device changes from the non-detection state to the detection state as a reference time and comparing two types of elapsed times from when the immediately below detection device changes from the non-detection state to the detection state until the immediately lower rear portion detection device changes from the non-detection state to the detection state while the clamp gauge is descending toward a paper stack respectively in two cases;

FIG. 112 is a conceptual diagram illustrating that, if a time threshold is set adequately, then it becomes possible to accurately discriminate whether or not a finger is placed on the paper stack, no only in a case where the paper stack is flat but also in a case where the paper stack is comprised with a ridge in front or behind;

FIG. 113 is a flowchart for explaining the operation of the clamp gauge control device according to the seventeenth embodiment of the present invention;

FIG. 114 is a flowchart for explaining another operation of the clamp gauge control device according to the seventeenth embodiment of the present invention;

FIG. 115 is a front view showing the configuration according to the nineteenth embodiment;

FIG. 116 is a side view showing the configuration according to the nineteenth embodiment;

FIG. 117 is a front view showing a configuration according to a twenty-second embodiment;

FIG. 118 is a side view showing the configuration according to the twenty-second embodiment;

FIG. 119 is a front view showing another configuration according to the twenty-second embodiment;

FIG. 120 is a side view showing another configuration according to the twenty-second embodiment;

FIG. 121 is a diagram for explaining a twenty-third embodiment of the present invention;

FIG. 122 is a conceptual front view and side view showing another configuration form of the line-type immediately lower detection device and the line-type immediately lower detection device in a twenty-fourth embodiment of the present invention;

FIG. 123 is a conceptual diagram showing an example of an optical system in the clamp gauge control device of the form shown in FIG. 122;

FIG. 124 is a conceptual diagram showing another example of the optical system in the clamp gauge control apparatus of the form shown in FIG. 122;

FIG. 125 is a diagram showing an optical path when the height of the clamp gauge in the optical system shown in FIG. 124 is low;

FIG. 126 is a diagram showing an optical path when height of the clamp gauge in the optical system shown in FIG. 124 is medium;

FIG. 127 is a diagram showing an optical path when the height of the clamp gauge in the optical system shown in FIG. 124 is high;

FIG. 128 is a graph showing the relationship between the height of the clamp gauge and the detected light intensity in the twenty-fourth embodiment of the invention;

FIG. 129 is a conceptual diagram showing another configuration of the line-type immediately lower front portion detection device and its peripheral portion according to the twenty-fourth embodiment of the present invention;

FIG. 130 is a diagram for explaining a distance detection method using the line-type immediately lower front portion detection device according to the twenty-fourth embodiment of the present invention; and

FIG. 131 is a conceptual diagram showing an example of an optical path in the case of using the line-type immediately lower front portion detection device according to the twenty-fourth embodiment of the present invention.

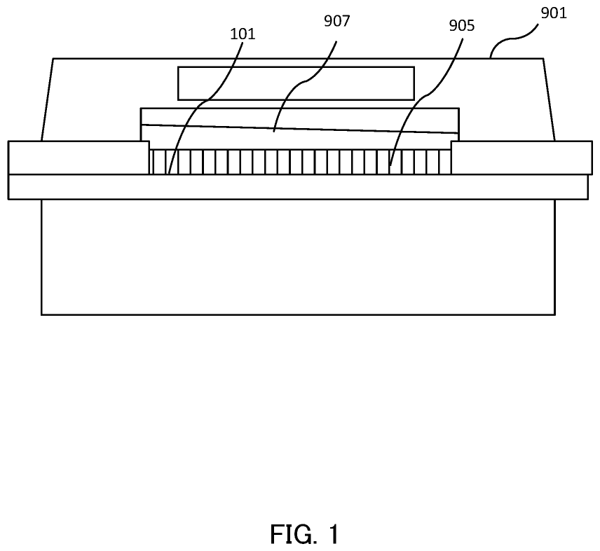

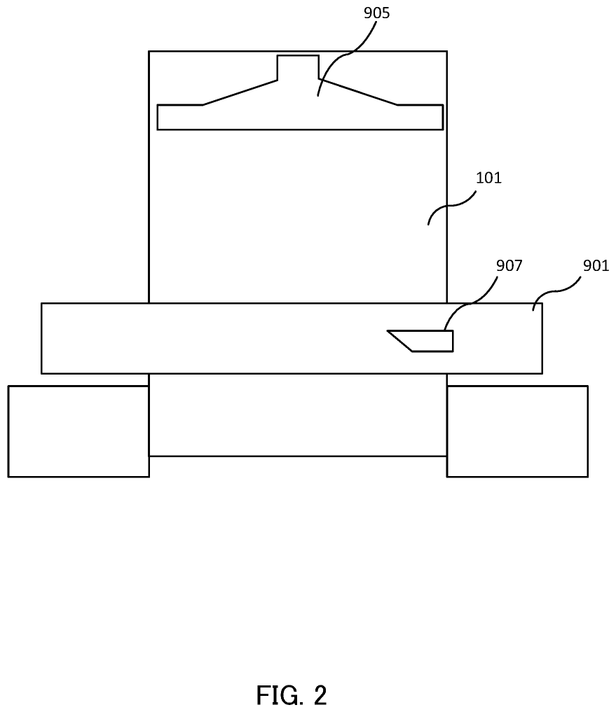

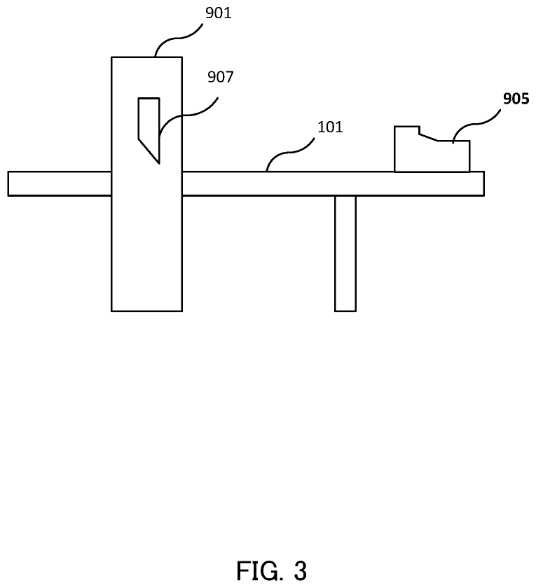

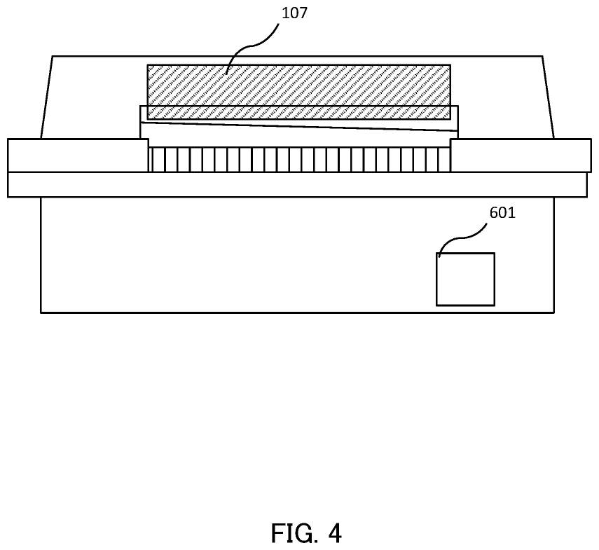

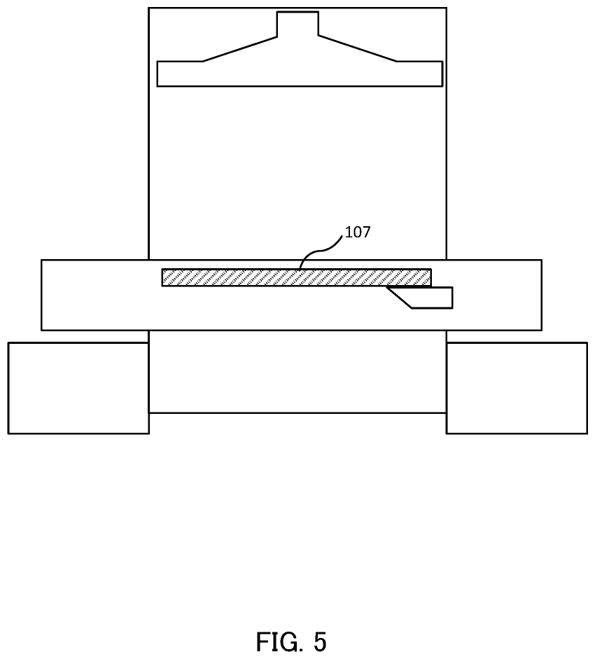

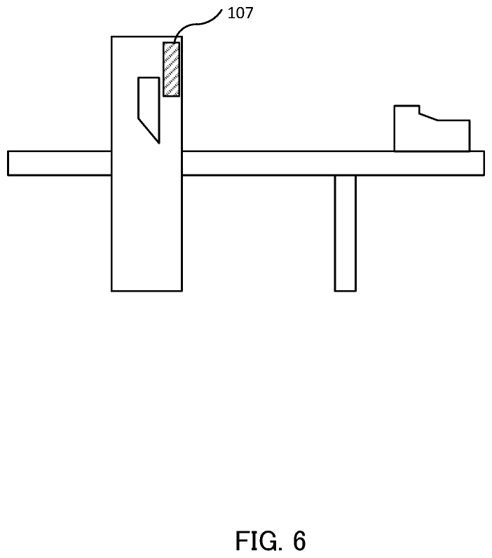

### BEST MODE FOR CARRYING OUT THE INVENTION

### Description of Embodiments

Hereinafter, embodiments for carrying out the present invention will be described in detail with reference to the drawings.

### First Embodiment

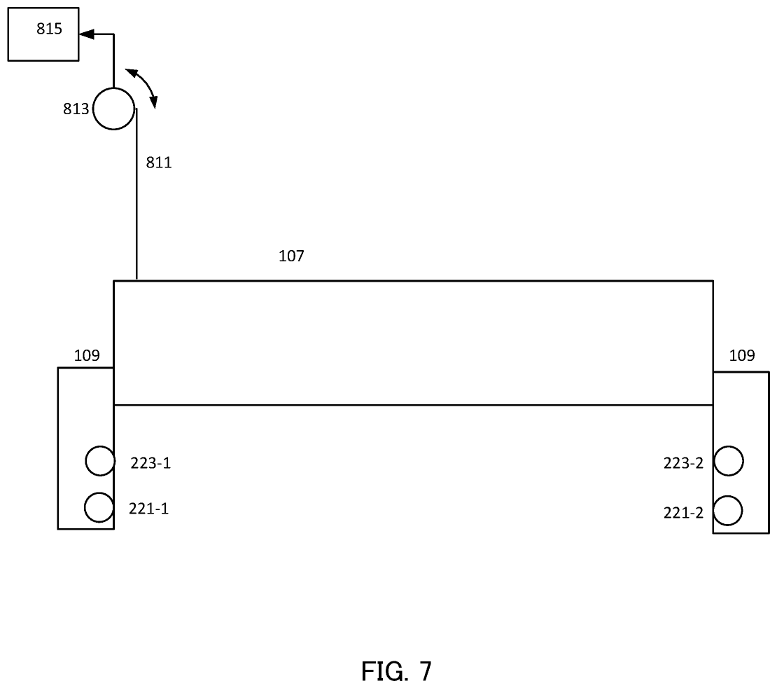

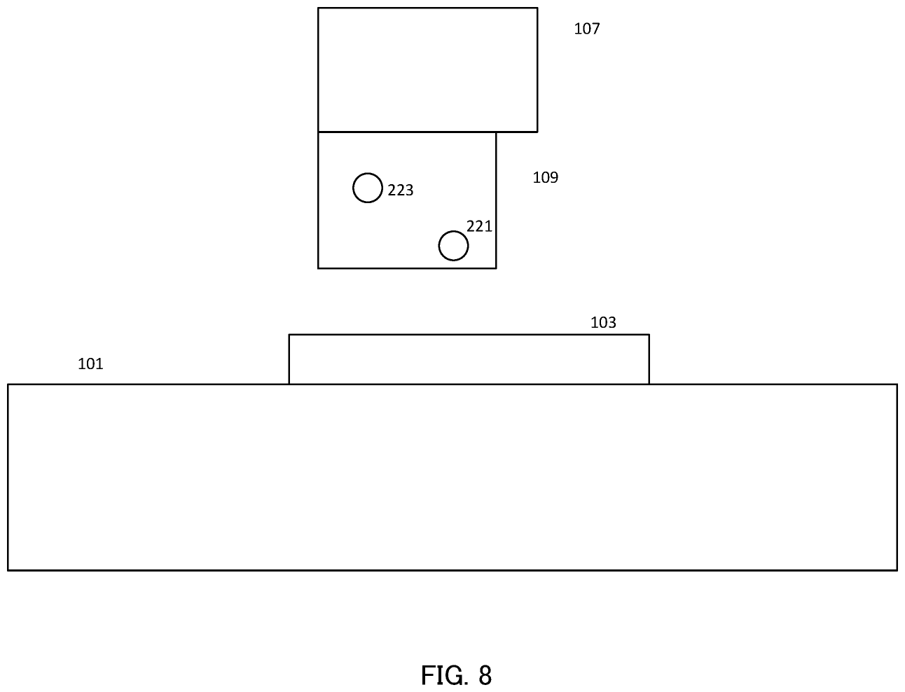

In the first embodiment, as shown in FIGS. 7 and 8, a pair of detection device mounting plates 109 are attached to both axis of the clamp gauge 107. A preceding detection device 221 and a main detection device 223 are attached to the detection device mounting plates 109. Note that the detection device mounting plates 109 may be attached to both ends of the lower surface of the clamp gauge 107. Further, a link bar that pulls the clamp gauge 107 from below may be used as the detection device mounting plate 109.

Both the preceding detection device 221 and the main detection device 223 are of a light transmission type. For example, the light emission side preceding detection device 221-1 and the light emission side main detection device 223-1 are attached to the left detection device attachment plate 109. The light receiving side preceding detection device 221-2 and the light receiving side main detection device 223-2 are attached to the detection device mounting plate 109 on the right side.

The preceding detection device 221 is for detecting that the clamp gauge 107 is lowered and approaches the paper stack 103, and enters a detection state (ON) if the distance from the upper end surface of the paper stack 103 to the lower end surface of the clamp gauge 107 becomes a predetermined value. Hereinafter, the distance from the upper end surface of the paper stack 103 to the lower end surface of the clamp gauge 107 may be simply referred to as the distance from the paper stack 103 to the clamp gauge 107. For example, the preceding detection device 221 is arranged so as to be separated from the lower end surface of the clamp gauge 107 by a height of about 20 millimeters below to about 100 millimeters below. In a case where the detection positions are arranged so as to be separated by a distance of a height of 35 millimeters below, when the distance from the paper stack 103 to the clamp gauge 107 becomes 35 millimeters which is the same distance, the preceding detection device 221 enters a detection state (ON).

It should be noted that the preceding detection device 221 is placed at a position on the rear portion to some extent (for example, a position corresponding to a detection position in the depth direction about 50 mm behind the front end of the clamp gauge 107.) so as not to mistakenly detect an intruding object such as a finger that has entered the upper surface near the front end of the paper stack 103 as a paper stack. However, the present Invention is not limited to this. In other words, the preceding detection device 221 can be placed at any other depth position as long as the preceding detection device 221 can detect the paper stack 103 but does not detect an intruding object such as a finger or a hand on the upper surface of the paper stack 103.

The main detection device 223 can detect the paper stack 103 in the same manner as the preceding detection device 221. The main detection device 223 can also detect a finger or the like placed on the paper stack 103. The main detection device 223 is disposed at a position closer to the lower end of the clamp gauge 107 than the preceding detection device 221 in the height direction. As an example, the main detection device 223 and the preceding detection device 221 are arranged so that the height difference between them is 20 to 30 millimeters. Further, in the depth direction, the main detection device 223 has a detection position in the depth direction within a predetermined range from the front end of the clamp gauge 107 (for example, between minus 5 millimeters to plus 5 millimeters) so that a finger on the upper surface near the front end of the paper stack 103 can be reliably detected. The detection position may be just the front end position. Further, the detection position may be a position protruding from the front end of the clamp gauge 107 if required in order to provide a guard region for example.

In a case where the height diffidence between the preceding detection device 221 and the main detection device 223 is 25 millimeters, if the main detection device 223 detects a second object when the clamp gauge 107 is further lowered by 25 millimeters after the preceding detection device 221 detects a first object, both objects have the same height. Therefore, it can be determined that the first object and the second object are the flat paper stack 103, and it can be determined that no intruding object is placed thereon. On the other hand, if the main detection device 223 detects a second object before the clamp gauge 107 is further lowered by 25 millimeters after the preceding detection device 221 detects a first object, both objects do not have the same height. Therefore, it can be determined that the first object is the paper stack and the second object is a finger on the paper stack. For example, if the thickness of the finger is 18 millimeter, the main detection device 223 detects a second object when the clamp gauge 107 is further lowered by 7 millimeters after the preceding detection device 221 detects a first object.

The positions of the preceding detection device 221 and the main detection device 223 may be adjustable. The position that can be adjusted may be only the position in the vertical direction, only the position in the depth direction, or both. In this case, the position can be adjusted based on the actual physique of the worker, the state of the paper stack, and the purpose of use.

As shown in FIG. 7, a wire 811 is attached to the clamp gauge 107. The wire 811 is wound or unwound in accordance with the rise and fall of the clamp gauge 107 without slack and without expanding, and the rotary encoder 813 detects this. The motion detection device 815 can measure the vertical height, velocity, and acceleration of the clamp gauge 107 based on the detection signal output from the rotary encoder 813.

A rack and pinion may be used instead of the wire 811. In this case, the rotary encoder 813 is connected to the pinion.

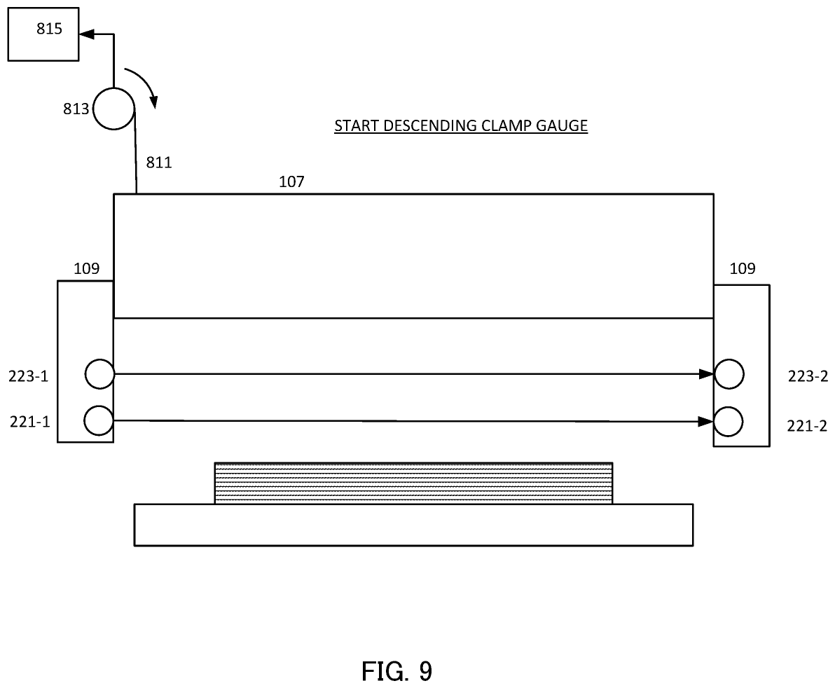

Next, the principle of the method for detecting an intruding object such as a finger or a hand according to the present embodiment will be described with reference to FIGS. 9 to 12.

Referring to FIG. 9, when the clamp gauge 107 starts to descend from the vicinity of the top dead center, the preceding detection device 221 and the main detection device 223 are in a non-detection state (OFF).

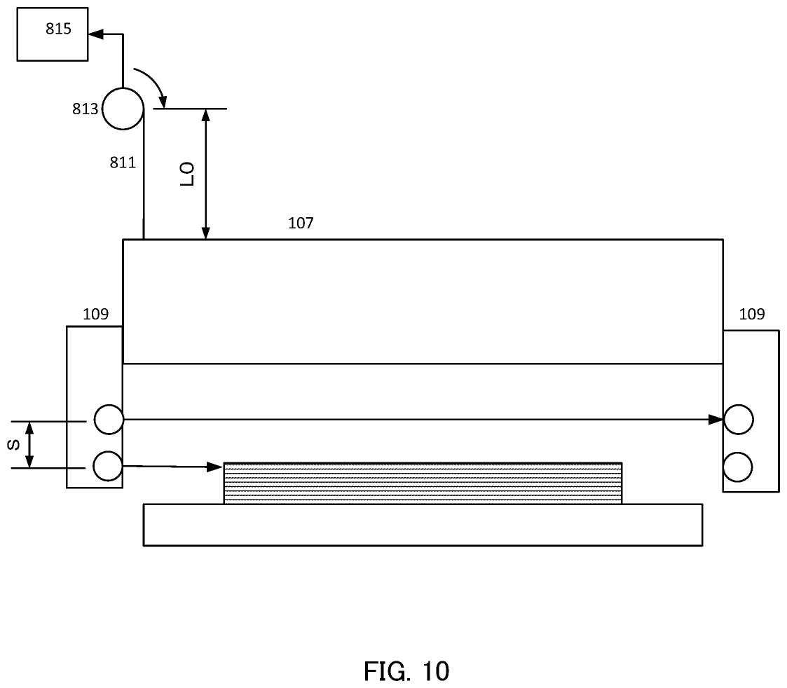

Next, when the clamp gauge 107 continues to descend, as shown in FIG. 10, the preceding detection device 221 detects the upper end surface of the paper stack 103 and changes to a detection state (ON). At this time, a reference distance L0 that is an index of the height of the clamp gauge 107 is measured.

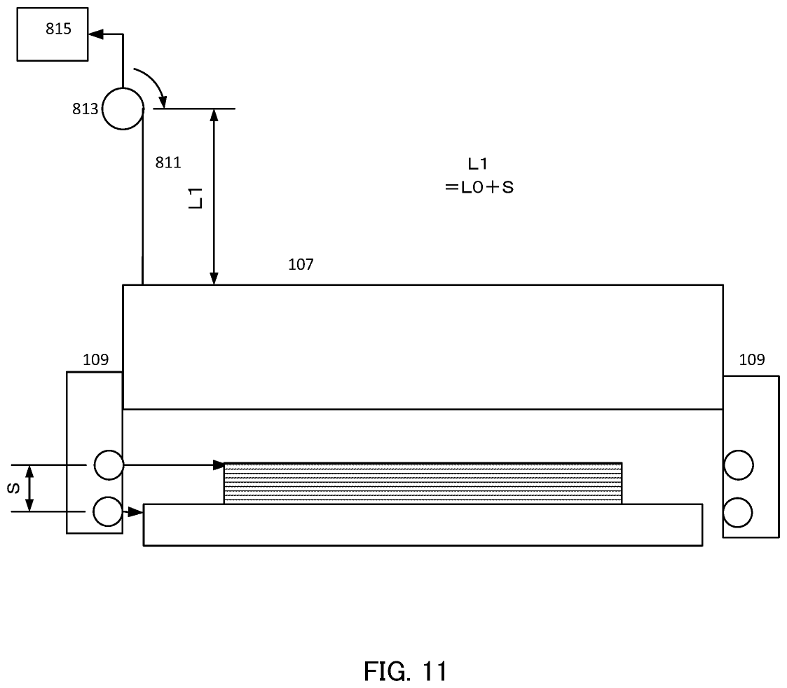

Next, in a case where an intruding object such as a finger is not put on the paper stack 103, when the preceding detection device 221 detects the upper end surface of the paper stack 103 and the clamp gauge 107 further continues to descend, As shown in FIG. 11, the main detection device 223 detects the upper end surface of the paper stack and changes to a detection state (ON). In this case, the reference distance L1 serving as an index of the height of the clamp gauge 107 at this time is measured.

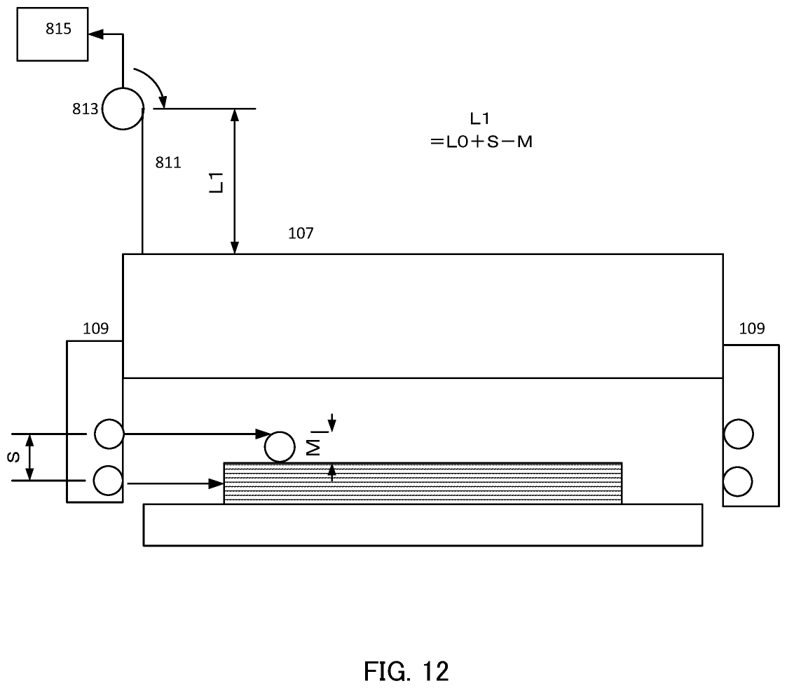

On the other hand, in a case where an intruding object such as a finger is put on the paper stack 103, when the preceding detection device 221 detects the upper end surface of the paper stack 103, the clamp gauge 107 further continues to descend. As shown in FIG. 12, the main detection device 223 detects the upper end surface of an intruding object such as a finger and changes to a detection state (ON). In this case, the reference distance L1 serving as an index of the height of the clamp gauge 107 at this time is measured.

Therefore, the presence or absence of an intruding object can be detected as follows:

The height difference between the preceding detection device 221 and the main detection device 223 is S, and the height of the intruding object is M. Then, it can be determined that

If L1+L0=S, there is no intruding object,

If L1−L0=S=M, there is an intruding object with height M.

The above expression can be transformed as follows:

If L1−L0−S=0, these is no intruding object.

If L1−L0−S=−M, then there is an intruding object with height M.

Therefore, if an intruding object-derived correction value M′M/2 is provided, it can be determined that

If L1−L0−S>−M′, there is no intruding object,

If L1−L0−S<M′, there is an intruding object with height M.

If the reference distance L0 is initialized to zero, it can be determined that

If L1−S>−M′, there is no intruding object,

If L1=S<−M′, there is an intruding object with height M.

The above expression can be transformed as follows:

If L1>S−M′, there is no intruding object,

If L1<S−M′, there is an intruding object with height M.

That is, the descending distance L1 from when the preceding detection device 221 detects an object until the main detection device 223 detects the object is longer than the difference obtained by subtracting half of the object height M from the height difference S between the preceding detection device 221 and the main detection device 223, it can be determined that there is no intruding object, otherwise it can be determined that there is an intruding object. Note that M′ is half of the height M is merely an example, and a value obtained by multiplying M by another coefficient exceeding zero and less than 1 may be used as M′. That means

If L1>S−M′, there is no intruding object,

If L1<S−M′, there is an intruding object with height M

Here, the intruding object-derived correction value M′=M×α

Here,
M is the height of the intruding object

0<α<0
For example, α=½

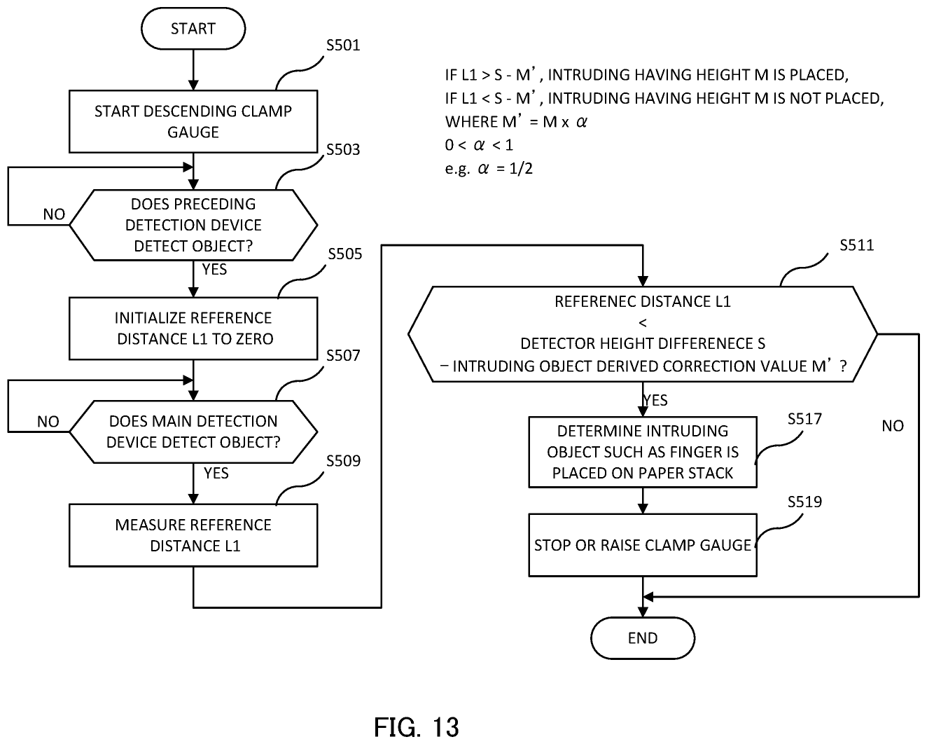

Next, an intruding object detection method using this principle will be described with reference to FIG. 13.

First, lowering of the clamp gauge is started (step S501).

Next, stay waiting (NO in step S503) for the preceding detection device 221 detects an object.

Next, if the preceding detection device 221 detects an object (YES in step S503), the reference distance L1 is initialized to zero (step S505).

Neat, stay waiting (NO in step S507) for the main detection device 223 detects an object.

Next, if the main detection device 223 detects an object (YES in step S507), the reference distance L1 is measured (step S509).

Next, it is determined whether or not

reference distance L1<detector height difference S−intruding object derived correction value M′

is satisfied (step S511).

If so (YES in step S511), it is determined that an intruding object such as a finger is placed on the paper stack (step S517), and the clamp gauge 107 is stopped or raised se a collision avoidance process. (Step S519).

Otherwise (NO in step S511), it is determined that no intruding object such as a finger is placed on the paper stack, and the process ends. When the processing is completed, the clamp gauge 107 reaches the paper stack 103 and clamps the paper stack 103 by a mechanism that drives the clamp gauge 107.

In step S505, the reference distance L1 need not be initialized. In this case, in step 511, the difference obtained by subtracting the reference distance L0 acquired in step S505 than the reference distance L1 acquired in step S509 is compared with the detection apparatus height difference S−M′.

### Second Embodiment

In the first embodiment, S>M. On the other hand, in the second embodiment, S<M. That is, in the second embodiment, the height difference S between the preceding detection device 221 and the main detection device 223 is small, and the height M of the intruding object such as a finger is larger than the height difference S.

In the second embodiment, in a case where an intruding object is placed on the paper stack 103, if the clamp gauge 107 is lowered, the main detector 223 detects the intruding object and thereafter, the receding detector 221 detects the paper stack.

In a case where no intruding object is placed on the paper stack, the main detection device 223 detects the paper stack after the preceding detection device 221 detects the paper stack. A reference distance serving as an index of the height of the clamp gauge 107 when the receding detection device 221 detects the paper stack is L0. In addition, a reference distance serving as an index of the height of the clamp gauge 107 when the main detection device 223 detects the paper stack is L10. Then, the difference L between the reference distance L0 and the reference distance L10 is equal to the height difference S between the main detection device 223 and the preceding detection device 221.

In a case where an intruding object is placed on the paper stack, the main detection device 223 detects the paper stack and then the preceding detection device 221 detects the paper stack. The reference distance that is an index of the height of the clamp gauge 107 when the preceding detection device 221 detects the paper stack in a case where an intruding object is placed on the paper stack is the same as that, i.e., L0 in a case where no intruding object is placed on the paper stack. On the other hand, in a case where the intruding object is placed on the paper stack, the reference distance L11 serving as an index of the height of the clamp gauge when the main detection device 223 detects the intruding object is placed on the paper stack is shorter than that, i.e., L10 in a case where no intruding object is placed on the paper stack by the height M of the intruding object.

These are summarized as follows:

In a case where any intruding object is not placed on the paper stack, the reference distance of the clamp gauge when the preceding detection device 223 detects the paper stack is L0.

In a case where any intruding object is not placed on the paper stack, the reference distance of the clamp gauge when the main detection device 223 detects the paper stack is L10.

The difference between the reference distance L0 and the reference distance L10 is equal to the height difference S between the two detection devices 221 and 223.

In a case where an intruding object of height M is placed on the paper stack, the reference distance of the clamp gauge when the preceding detection device 221 detects the paper stack is L0.

In a case where an intruding object of height M is placed on the paper stack, the reference distance of the clamp gauge when the main detection device 223 detects the paper stack is L11=L10−M.

Therefore, supposing that the reference distance of the clamp gauge when the main detection device 223 detects some object is L, and the reference distance of the clamp gauge when the preceding detection device 221 detects the paper stack is L0, if

L−L0=S

is satisfied, it can be determined that no intruding object is placed on the paper stack.

Also, if

L−L0=S−M(<0)

Is satisfied, it can be determined that an intruding object is placed on the paper stack. Therefore, for example, upon intruding object-derived correction value of M′=M/2, if

L−L0>SM′

is satisfied, it can be determined that there is no intruding object on the paper stack, while if

L−L0≤SM′

is satisfied, it can be determined that an intruding object is placed on the paper stack.

Further, in a case where the intruding object having the height M is placed on the paper stack, the preceding detection device 221 detects the paper stack after the main detection device 223 detects the intruding object.

Since the determination is made after acquiring the height L and the height L0, it cannot be determined at that moment that the main detection device 223 detects the intruding object. However, after that, when the preceding detection device 221 detects the paper stack, it can be determined.

### Third Embodiment

Here, a configuration for reducing erroneous detection due to paper uplift or curling is added.

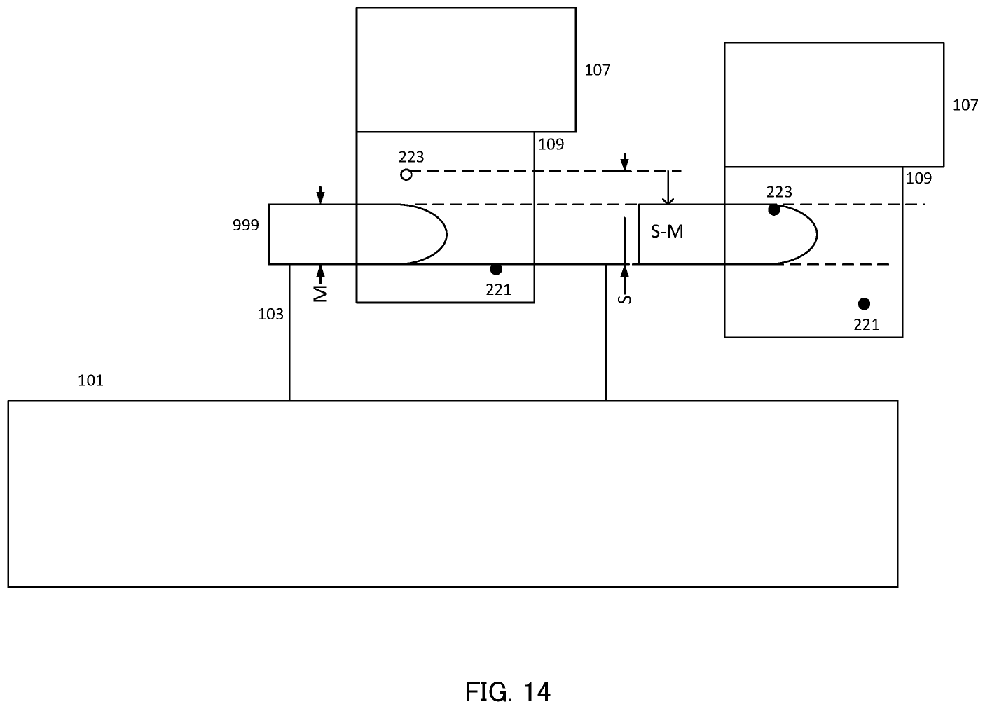

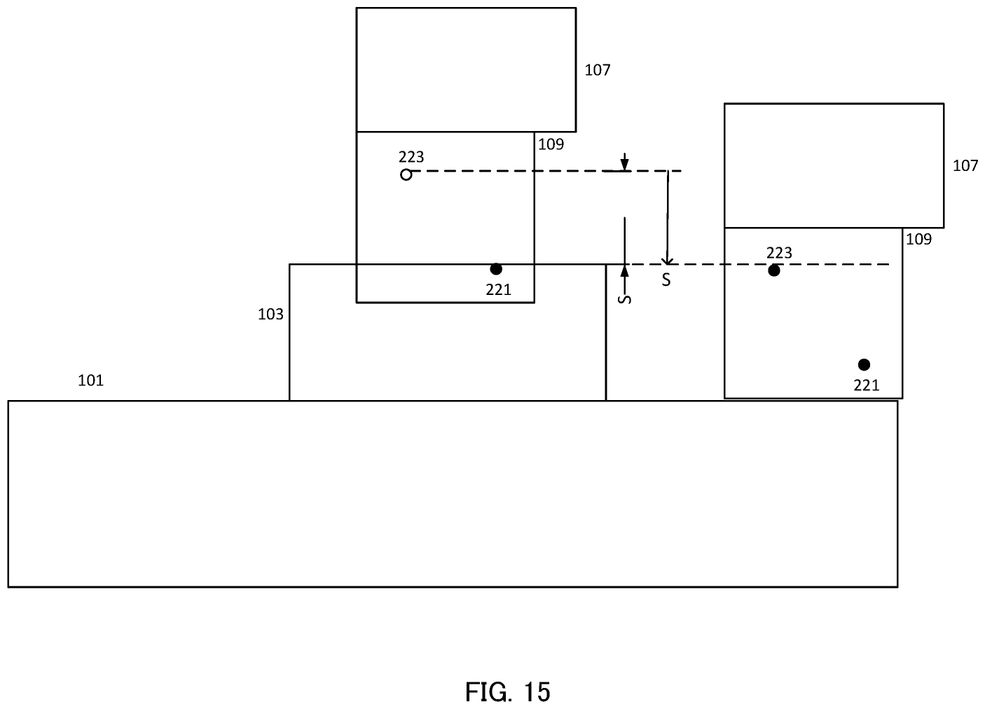

As shown in FIGS. 14 and 13, it is possible to arrange the preceding detection device 221 and the main detection device 223 so that the height difference S between the preceding detection device 221 and the main detection device 223 will be larger than the thickness of the finger to be detected is M, i.e., S<M.

In such an arrangement, in a case where the finger 999 is placed on the paper stack 103 as shown in FIG. 14, if we observe the height of the clamp gauge 107, the height when the preceding detection device 221 detects the paper stack 103 is higher than the height when the main detection device 223 detects a finger by S−M. In addition, in a case where the finger 999 is not placed on the paper stack 103 as shown in FIG. 14, if we observe the height of the clamp gauge 107, the height when the preceding detection device 221 detects the paper stack 103 is higher than the height when the main detection device 723 detects a finger by S.

In such an arrangement, provided that the clamp gauge 101 descends with a predetermined descending velocity, in a case where the finger 999 is placed on the paper stack 103 as shown in FIG. 14, if we observe the time, the time when the preceding detection device 221 detects the paper stack 103 is before the time when the main detection device 223 detects a finger by

(S−M)/(descending velocity).

In addition, provided that the clamp gauge 107 descents with a predetermined descending velocity, in a case where the finger 999 is not placed on the paper stack 103 as shown in FIG. 14, if we observe the time, the time when the preceding detection device 221 detects the paper stack 103 is before the time when the main detection device 223 detects a finger by

S/(descending velocity).

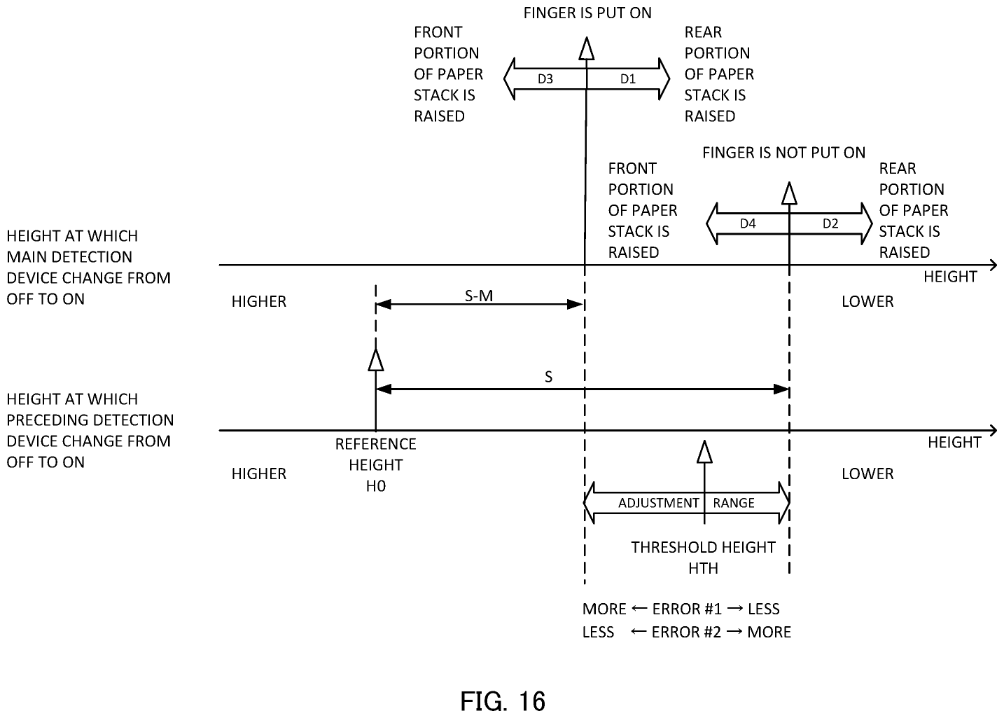

FIG. 16 is a diagram summarizing the height. Although the description partially overlaps, if we regards the height at which the preceding detection device 221 changes from OFF to ON as a reference height, the height at which the main detection device 223 detects the finger is lower than the reference height by S−M in a case where the finger is placed on the paper stack 103, while the height at which the main detection device 223 detects the paper stack 103 is lower than the reference height by S.

Therefore, it is possible to determine whether or not the finger 999 is put on the paper stack 103 by setting the height at which the preceding detection device 221 changes firm OFF to ON as a reference height, setting a height threshold HTH to fall between the height which is lower than the reference height by S−M and the height which is lower than the reference height by S, and comparing the height when the main detection device detects something with the threshold. That is, if the height at which the main detection device detects something is higher than the threshold which is set to fall between the height which is lower than the reference height by S−M and the height which is lower than the reference height by S, then it is determined the finger 999 is put on the paper stack 103, while if the height at which the main detection device detects something is lower than such a threshold, then it is determined the finger 999 is not put on the paper stack 103.

Here, in a case where the rear portion of the paper stack 103 is raised as compared with the front portion, the height for detecting the finger placed on the paper stack 103 tends to move apart from the reference height (arrow D1), and the height for detecting the paper stack 103 on which no finger is placed also tends to move apart from the reference height (arrow D2). On the other hand, in a case where the front portion of the paper stack 103 is raised as compared with the rear portion, the height for detecting the finger placed on the paper stack 103 tends to move closer to the reference height (arrow D3), and the height for detecting the paper stack 103 on which no finger is placed also tends to move closer to the reference height (arrow D4).

If the height at which the main detection device 223 detects a finger placed on the paper stack 103 moves apart from the reference height due to the rear portion of the paper stack 103 being raised as compared with the front portion (arrow D1), there is a higher possibility that such an error (error #1) that the finger on the paper stack 103 cannot be detected. If the height at which the main detection device 223 detects a finger placed on the paper stack 103 moves closer to the reference height due to the front portion of the paper stack 103 being raised as compared with the rear portion (arrow D4), there is a higher possibility that such an error (error #2) that, even though the finger is not placed on the paper stack 103, it is erroneously determined that the finger is place.

By setting the threshold height HTH to be lower (by setting the distance from the reference height to be longer), the possibility of occurrence of error #1 can be reduced. By setting the threshold height HTH to be higher (by setting the distance from the reference height to be shorter), the possibility of occurrence of error #2 can be reduced. Therefore, if importance is placed on the safety of the finger, the threshold height HTH is set lower (the distance from the reference height is set longer). For example, provided that S=25 mm and M=18 mm, the possibility that the finger placed on the paper stack is not detected caused by setting the threshold height HTH to be lower than the reference height by 25−18/2=16 mm can be reduce by alternatively setting the threshold height HTH to be lower than the reference height by 25−18/3=19 mm.

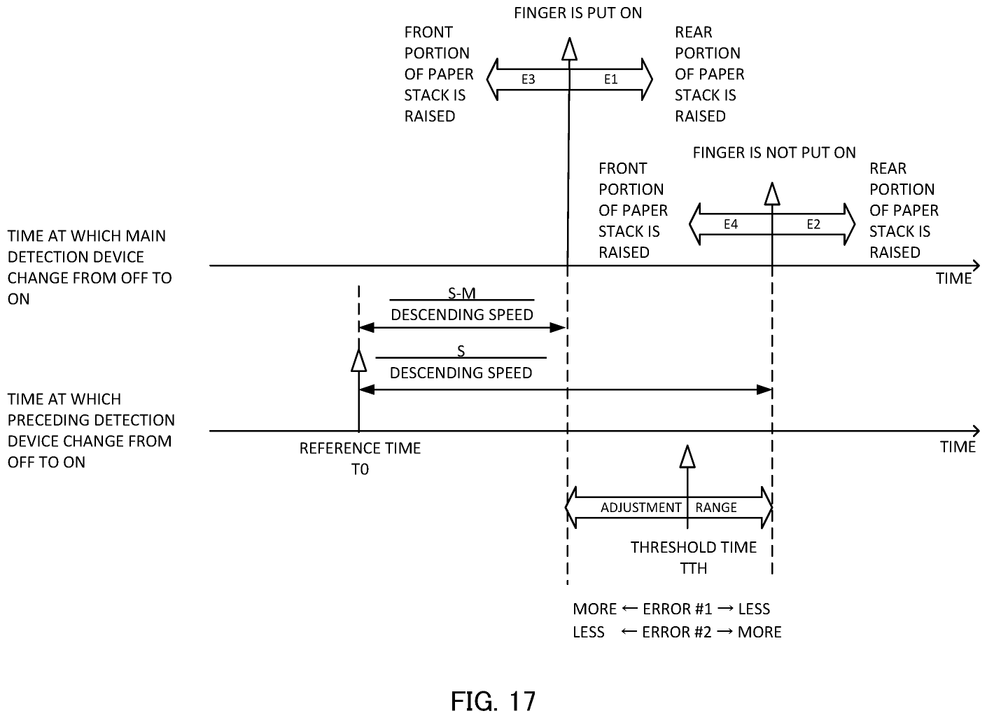

FIG. 17 is a diagram summarizing the time. It is assumed that the clamp gauge 107 descends at a predetermined descending velocity or a velocity close thereto. If we regard the time at which the preceding detection device 221 changes from OFF to ON at a reference time, the time at which the main detection device 223 detects the finger is later than the reference time by

S−M/descending speed

in a case where the finger is placed on the paper stack 103, while the time at which the main detection device 223 detects the paper stack 103 is later than the reference time by S.

Therefore, it is possible to determine whether or not the finger 999 is put on the paper stack 103 by setting a time threshold TTH to fall between the time which is later than the reference time by

(S−M)/(descending velocity)

and the time which is later than the reference time by

S/(descending velocity),

and comparing the time when the main detection device detects something with the threshold. That is, if the time at which the main detection device detects something is before the threshold which is set to fall between the time which is later than the referees time by

(S−M)/(descending velocity)

and the time which is later than the reference height by

S/(descending velocity),

than it is determined the finger 999 is put on the paper stack 103, while if the time at which the main detection device detects something is before such a threshold, then it is determined the finger 999 is not put on the paper stack 103.

Here, in a case where the rear portion of the paper stack 103 is raised as compared with the front portion, the time for detecting the finger placed on the paper stack 103 tends to move apart from the reference time (arrow E1), and the time for detecting the paper stack 103 on which no finger is placed also tends to move apart from the reference time (arrow E2). On the other hand, in a case where the front portion of the paper stack 103 is raised as compared with the rear portion, the time for detecting the finger placed on the paper stack 103 tends to move closer to the reference time (arrow E3), and the time for detecting the paper stack 103 on which no finger is placed also tends to move closer to the reference time (arrow E4).

If the time at which the main detection device detects a finger placed on the paper stack 103 moves apart from the reference time due to the rear portion of the paper stack 103 being raised as compared with the front portion (arrow E1), there is a higher possibility that such an error (error #1) that the finger on the paper stack 103 cannot be detected. If the time at which the main detection device detects a finger placed on the paper stack 103 moves closer to the reference time due to the front portion of the paper stack 103 being raised as compared with the rear portion (arrow E4), there is a higher possibility that such an error (error #2) that, even though the finger is not placed on the paper stack 103, it is erroneously determined that the finger is place.

By setting the threshold time TTH to be later, the possibility of occurrence of error #1 can be reduced. By setting the threshold time TTH to be earlier, the possibility of occurrence of error #2 can be reduced. Therefore, if importance is placed on the safety of the finger, the threshold time TTH is set later. For example, provided that S=23 mm and M=18 mm, the possibility that the finger placed on the paper stack is not detected caused by setting the threshold time TTH to be later than the reference time by

(25−18/2)/V=16/V [mm/sec]

can be reduce by alternatively setting the threshold time TTH to be lower than the reference height by

(25−18/3)/V=19/V [mm/sec].

Here, V in the above equation is the descending velocity of the clamp gauge.

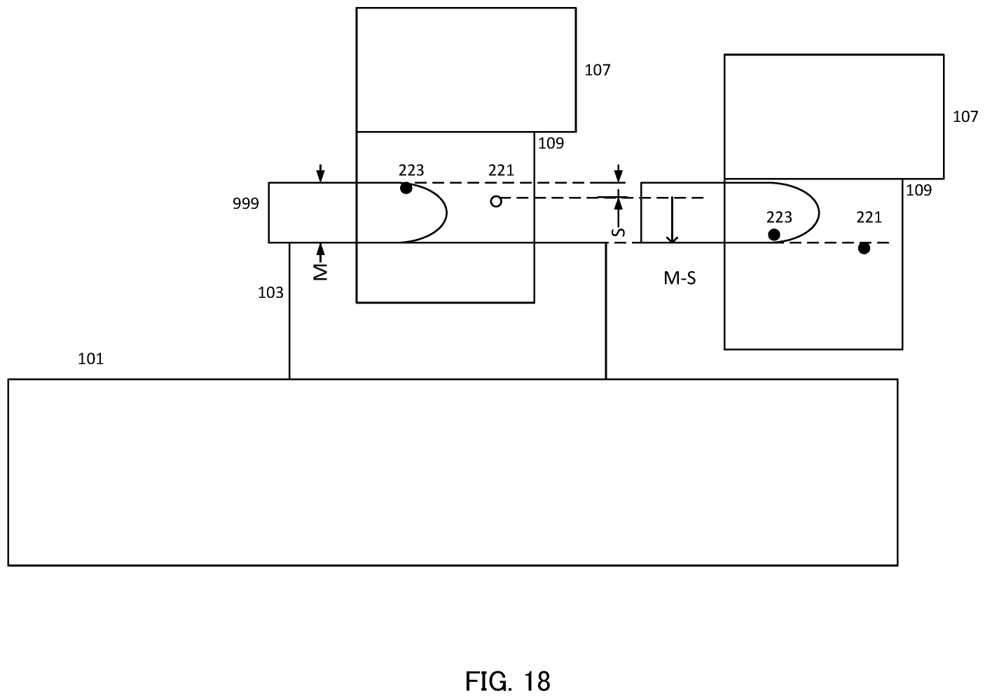

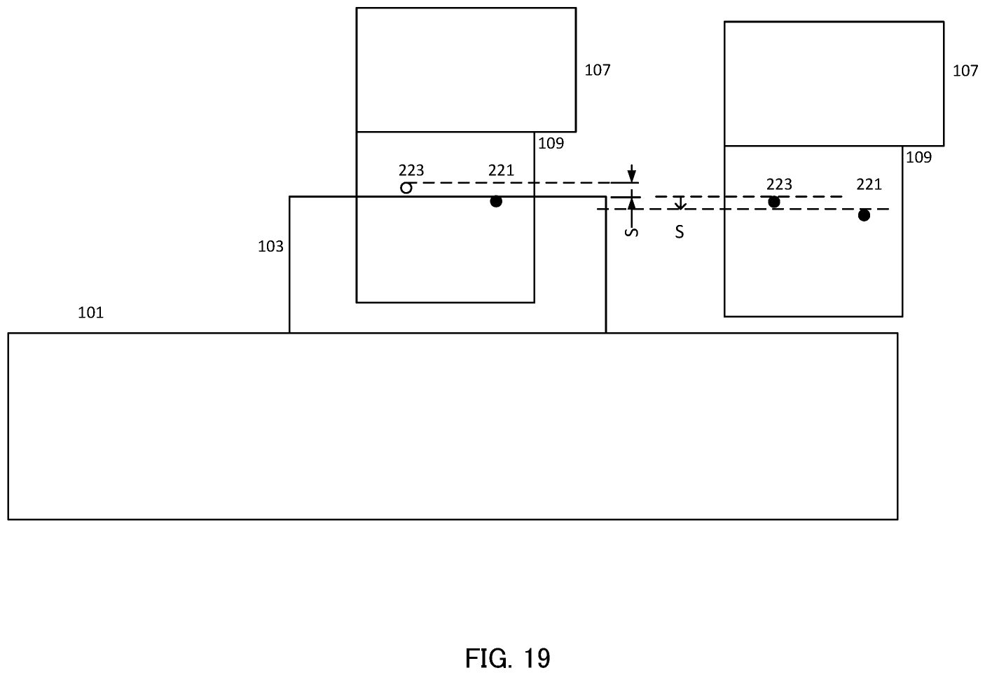

As shown in FIGS. 18 and 19, it is possible to arrange the preceding detection device 221 and the main detection device 223 so that the height difference S between the preceding detection device 221 and the main detection device 223 will be smaller than the thickness of the finger to be detected is M, i.e., S>M.

In such an arrangement, in a case where the finger 999 is placed on the paper stack 103 as shown in FIG. 18, if we observe the height of the clamp gauge 107, the height when the preceding detection device 221 detects the paper stack 103 is lower than the height when the main detection device 223 detects a finger by M−S. In addition, in a case when the finger 999 is not placed on the paper stack 103 as shown in FIG. 14, if we observe the height of the clamp gauge 107, the height when the main detection device 223 detects the paper stack 103 is lower than the height when the preceding detection device 221 detects a finger by S.

Provided that the clamp gauge 107 descents with a predetermined descending velocity, in a cue where the finger 999 is placed on the paper stack 103 as shown in FIG. 18, if we observe the time, the time when the main detection device 223 detects a finger is before the time when the preceding detection device 221 detects the paper stack 103. In addition, in a case where the finger 999 is not placed on the paper stack 103 as shown in FIG. 19, if we observe the time, the time when the preceding detection device 221 detects the paper stack 103 is before the time when the main detection device 223 detects a finger.

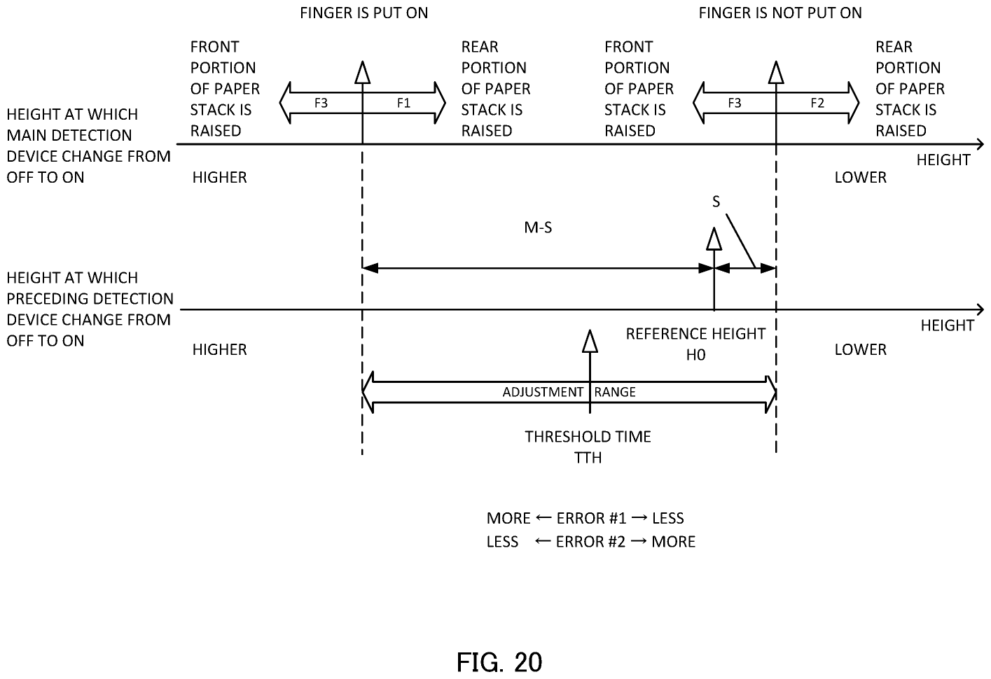

FIG. 20 is a diagram summarizing the height. If we regards the height at which the preceding detection device 221 changes from OFF to ON as a reference height, the height at which the main detection device 223 detects the finger is lower than the reference height by M−S in a case where the finger is placed on the paper stack 103, while the height at which the main detection device 223 detects the paper stack 103 is lower than the reference height by S.

Therefore, it is possible to determine whether or not the finger 999 is put on the paper stack 103 by setting the height at which the preceding detection device 221 changes from OFF to ON as a reference height, setting a height threshold HTH to fall between the height which is higher than the reference height by M−S and the height which is lower than the reference height by S, and comparing the height when the main detection device 223 detects something with the threshold. That is, if the height at which the main detection device detects something is higher than the threshold which is set to fall between the height which is higher than the reference height by M−S and the height which is lower than the reference height by S, then it is determined the finger 999 is put on the paper stack 103, while if the height at which the main detection device detects something is lower than the threshold which is set to fall between the height which is lower than the reference height by M−S and the height which is lower than the reference height by S, then it is determined the finger 999 is not put on the paper stack 103.

Here, in a case where the rear portion of the paper stack 103 is raised as compared with the front portion, the height for detecting the finger placed on the paper stack 103 tends to move closer to the reference height (arrow F1), and the height for detecting the paper stack 103 on which no finger is placed also tends to move apart from the reference height (arrow F2). On the other hand, in a case where the front portion of the paper stack 103 is raised as compared with the rear portion, the height for detecting the finger placed on the paper stack 103 tends to move apart from to the reference height (arrow F3), and the height for detecting the paper stack 103 on which no finger is placed also tends to move closer to the reference height (arrow F4).

If the height at which the main detection device detects a finger placed on the paper stack 103 moves closer to the reference height due to the rear portion of the paper stack 103 being raised as compared with the front portion (arrow F1), there is a higher possibility that such an error (error #1) that the finger on the paper stack 103 cannot be detected. If the height at which the main detection device detects a finger placed on the paper stack 103 moves closer to the reference height due to the front portion of the paper stack 103 being raised as compared with the rear portion (arrow F4), there is a higher possibility that such an error (error #2) that, even though the finger is not placed on the paper stack 103, it is erroneously determined that the finger is place.

By setting the threshold height HTH to be lower, the possibility of occurrence of error #1 can be reduced. By setting the threshold height HTH to be higher, the possibility of occurrence of error #2 can be reduced. Therefore, if importance is placed on the safety of the finger, the threshold height HTH is set lower.

As a first example, provided that S=3 mm and M=15 mm, the possibility that the finger placed on the paper is not detected caused by setting the threshold height HTH to be higher than the reference height by 15/2−3=4.5 mm con be reduce by alternatively setting the threshold height HTH to be higher than the reference height by 15/3−3=2 mm.

As a second example, provided that S=10 mm and M=15 mm, the possibility that the finger placed on the paper is not detected caused by setting the threshold height HTH to be higher than the reference height by 15/2−10=−2.5 mm (i.e., lower than the reference height by 2.5 mm) can be reduce by alternatively setting the threshold height HTH to be higher than the reference height by 15/3−10=−5 mm (i.e., lower than the reference height by 5 mm).

In the first example, the position higher by 4.5 mm higher than the original reference height that is the height at which the preceding detection device detects the paper is a position lower by 7.5 mm (15−3−4.5=7.5) lower than the height at which the main detection device detects the finger which can be defined as another reference height. In the second example, the position higher by 2.5 mm lower than the original reference height that is the height at which the preceding detection device detects the paper is also a position lower by 7.5 mm (15−10+2.5=7.5) lower than the height at which the main detection device detects the finger which can be defined as the reference height.

In the first example, the position higher by 2 mm higher than the original reference height that is the height at which the preceding detection device detects the paper is a position lower by 10 mm (15=3−2=10) lower than the height at which the main detection device detects the finger which can be defined as another reference height. In the second example, the position higher by 5 mm lower than the original reference height that is the height at which the preceding detection device detects the paper is also a position lower by 10 mm (15−10+5=10) lower than the height at which the main detection device detects the finger which can be defined as the reference height.

Therefore, it can be understood that the same margin amount regarding the height can be set in the same manner without depending on the height difference between the main detection device and the preceding detection device. For example, even if the main detection device 223 and the preceding detection device 221 are at the same height, and even if the main detection device is below the preceding detection device, it is possible to determine whether or not a finger is put on the paper stack 103 with a necessary margin by setting an appropriate threshold height. That is, in FIG. 8, the preceding detection device 221 is located at a position lower than the main detection device 223, but these bights may be the same. Furthermore, the preceding detection device 221 may be located at a higher position than the main detection device 223, although the name of the preceding detection device 221 is no longer suitable.

Here, the threshold height HTH is set as follows, for example.

HTH=H0−S+M·(1−α)

here,
H0: Height at which the preceding detection device detects the paper stack
S: Height of the main detection device relative to the preceding detection device
M: Finger height
α: Margin amount when the finger height M is 100%.

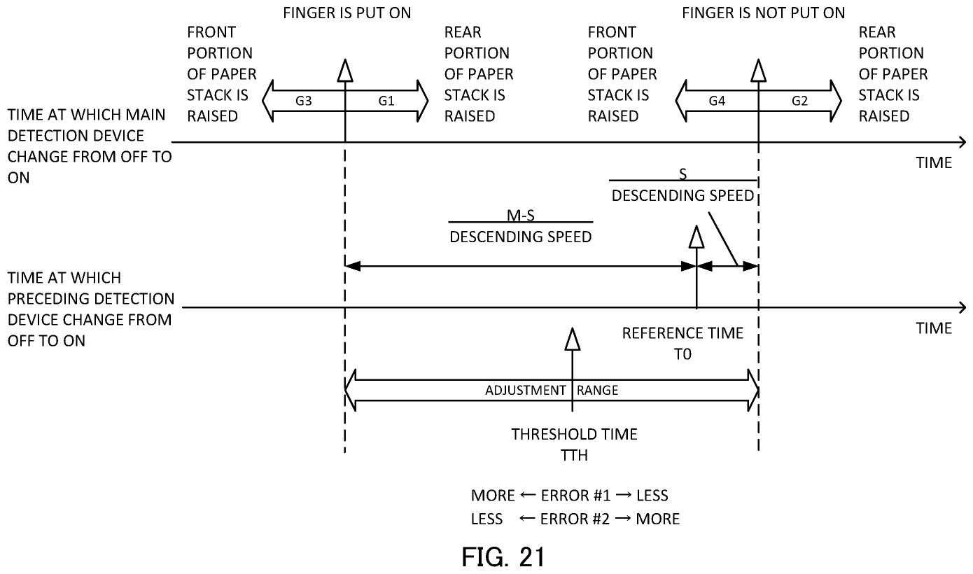

FIG. 21 summarizes events with respect to the time. It is assumed that the clamp gauge 107 descends at a predetermined descending velocity or a velocity close thereto. Provided that the time when the preceding detection device 221 changes from OFF to ON is considered as the reference time, in a case where the finger 999 is placed on the paper stack 103, the time when the main detection device 223 detects the finger is earlier than the reference time by

(M−S)/(descending velocity),

while in a case where the finger is not placed on the paper stack 103, the time when the main detection device 223 detects the paper stack is later than the reference time by

S/(descending velocity).

Therefore, it is possible to determine whether or not the finger 999 is put on the paper stack 103 by setting the time at which the preceding detection device 221 changes from OFF to ON as a reference time, setting a time threshold TTH to fall between the time which is earlier than the reference time by

(M−S)/(descending velocity)

and the time which is later than the reference time by

S/(descending velocity)

and comparing the time when the main detection device detects something with the threshold. That is, if the time at which the main detection device detects something is earlier than the threshold time which is set to fall between the time which is earlier than the reference time by

(M=S)/(descending velocity)

and the time which is later than the reference time by

S/(descending velocity),

then it is determined the finger 999 is put on the paper stack 103, while if the time at which the main detection device detects something is before such a threshold, then it is determined the finger 999 is not put on the paper stack 103.

Here, when the rear portion of the paper stack 103 is raised as compared with the front portion, the time for detecting the finger placed on the paper stack 103 tends to go closer to the reference time (arrow G1), and the time for detecting the paper stack 103 on which no finger is placed tends to go apart from the reference time (arrow G2). On the other hand, when the front portion of the paper stack is raised as compared with the rear portion, the time for detecting the finger placed on the paper stack 103 tends to go apart from the reference time (arrow G3), and the time for detecting the paper stack 103 on which no is placed tends to go close to the reference time (arrow G4).

If the time at which the main detection device detects a finger placed on the paper stack 103 moves closer to the reference time due to the rear portion of the paper stack 103 being raised as compared with the front portion (arrow G1), there is a higher possibility that such an error (error #1) that the finger on the paper stack 103 cannot be detected. If the time at which the main detection device detects a finger placed on the paper stack 103 moves closer to the reference time due to the front portico of the paper stack 103 being raised as compared with the rear portion (arrow G4),
there is a higher possibility that such an error (error #2) that, even though the finger is not placed on the paper stack 103, it is erroneously determined that the finger is place.

By setting the threshold time TTH to a later time, the error #1 can be less likely to occur. By setting the threshold time TTH to an earlier time, the error #2 can be less likely to occur. Therefore, if importance is placed on the safety of the finger, the threshold time TTH is set to a later time.

As a first example, provided that S=3 mm and M=15 mm, the possibility that the finger placed on the paper is not detected caused by setting the threshold time TTH to be earlier than the reference time by

(15 mm/2−3 mm)/(descending velocity)=4.5 mm/(descending velocity)

can be reduce by alternatively setting threshold time TTH to be earlier than the reference time by

(15 mm/3−3 mm)/(descending velocity)=2 mm/(descending velocity).

As a first example, provided that S=10 mm and M=15 mm, the possibility that the finger placed on the paper is not detected caused by setting the threshold time TTH to be earlier than the reference time by

(15 mm/2−10 mm)/(descending velocity)=−4.5 mm/(descending velocity),

i.e., lower than the reference time by

=0.54.5 mm/(descending velocity),

can be reduce by alternatively setting the threshold time TTH to be earlier than the reference time by

(15 mm/3−10 mm)/(descending velocity)=−5 mm/(descending velocity),

lower than the reference time by

=5 mm (descending velocity).

In the first example, the time which is prior to the reference time at which the preceding detection device detects the paper by

4.5 mm/(descending velocity)

is the same u the time which is later than the time at which the main detection device detects the finger by

7.5 mm/(descending velocity).

In the second example, the time which is later than to the reference time at which the preceding detection device detects the paper by

2.5 mm/(descending velocity)

is the same as the time which is later than the time at which the main detection device detects the finger by

7.5 mm/(descending velocity).

In the first example, the time which is prior to the reference time at which the preceding detection device detects the paper by

2.5 mm/(descending velocity)

is the same as the time which is later than the time at which the main detection device detects the finger by

10 mm/(descending velocity).

In the second example, the time which is later than to the reference time at which the preceding detection device detects the paper by

5 mm

is the same as the time which is later than the time at which the main detection device detects the finger by

10 mm/(descending velocity).

Therefore, it can be understood that the same margin amount regarding the height can be set in the same manner without depending on the height difference between the main detection device and the preceding detection device. For example, even if the main detection device and the preceding detection device are at the same height, and even if the main detection device is below the preceding detection device, it is possible to determine whether or not the finger on the paper stack is placed while maintaining the amount of the necessary margin by appropriately setting the threshold height.

Here, the threshold time TTH is set as follows, for example.

TTH=(H0−S+M(1−α)/(descending velocity)

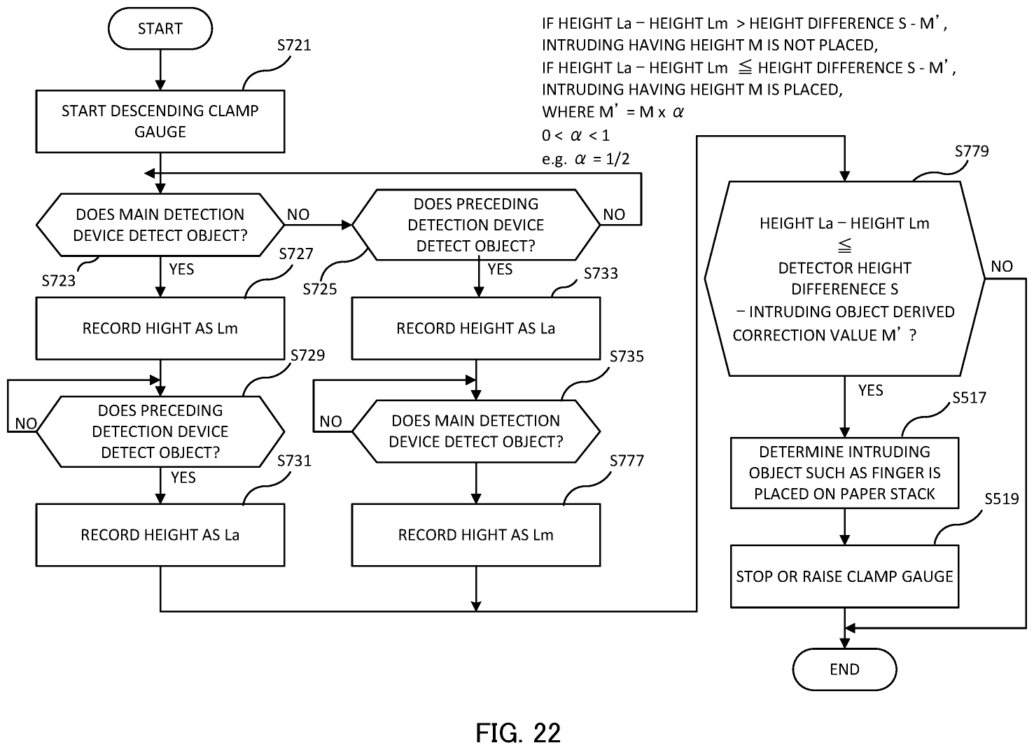

here,
H0: Height at which the preceding detection device detects the paper stack,
S: Height of the main detection device relative to the preceding detection device,
M: Finger height,
α: Margin amount when the finger height M is 100%. Next, an intruding object detection method using the principle of height difference will be described with reference to FIG. 22.

First, the clamp gauge starts to descend (step S721).

Next, stay waiting (NO in step S723, NO in step S725) for that the main detection device 223 detects an object or the preceding detection device 221 detects an object.

If the main detection device 223 detects an object earlier than the preceding detection device 221 in the waiting loop of steps S723 and S725 (YES in step S723), the height at this time is recorded as Lm (step S727).

Next, stay waiting (NO in step S729) for that the preceding detection device 221 detects an object.

Next, if the preceding detection device 221 detects an object (YES in step S729), the height at this time is recorded as La (step S731), and the process proceeds to step S779.

If the preceding detection device 221 detects an object earlier than the main detection device 223 in the waiting loop of steps S723 and S725 (YES in step S725), the height at this time is recorded as La (step S733).

Next, stay waiting (NO in step S735) for that the main detection device 223 detects an object.

Next, if the main detection device 223 detects an object (YES in step S735), the height at this time is recorded as Lm (step S777), and then the process proceeds to step S779.

In step S779, it is determined whether

Height La−Height Lm≤S−M′

is satisfied or not.

If so (YES in step S779), it is determined that an intruding object such as a finger is placed on the paper stack (step S517), and the clamp gauge 107 is stopped or raised as a collision avoidance process. (Step S519).

The method of FIG. 22 can be used regardless of the magnitude relationship between the height difference S between the main detection device 223 and the preceding detection device 221 and the height of the intruding object. Therefore, even if the height of the main detection device 223 and the preceding detection device 221 is changed in practice, the method of FIG. 22 can be used continuously. In this case, however, it is necessary to adjust the height difference S in the threshold value SM′ used in step S779 in accordance with the change in the height difference S. It suffices that the measured value of the height difference S can be substituted to S in SM′.

The method of FIG. 22 can be used regardless of the magnitude relationship between the height difference S and the height M of the intruding object when, for example, the intruding object to be detected is changed to an intruding object having a different height However, in this case, it is necessary to adjust M′ in the threshold value SM′ used in step S779 in accordance with the change in the height M of the intruding object. It is sufficient that the estimated height M of the intruding object can be substituted to M in S−M′=S−αM.

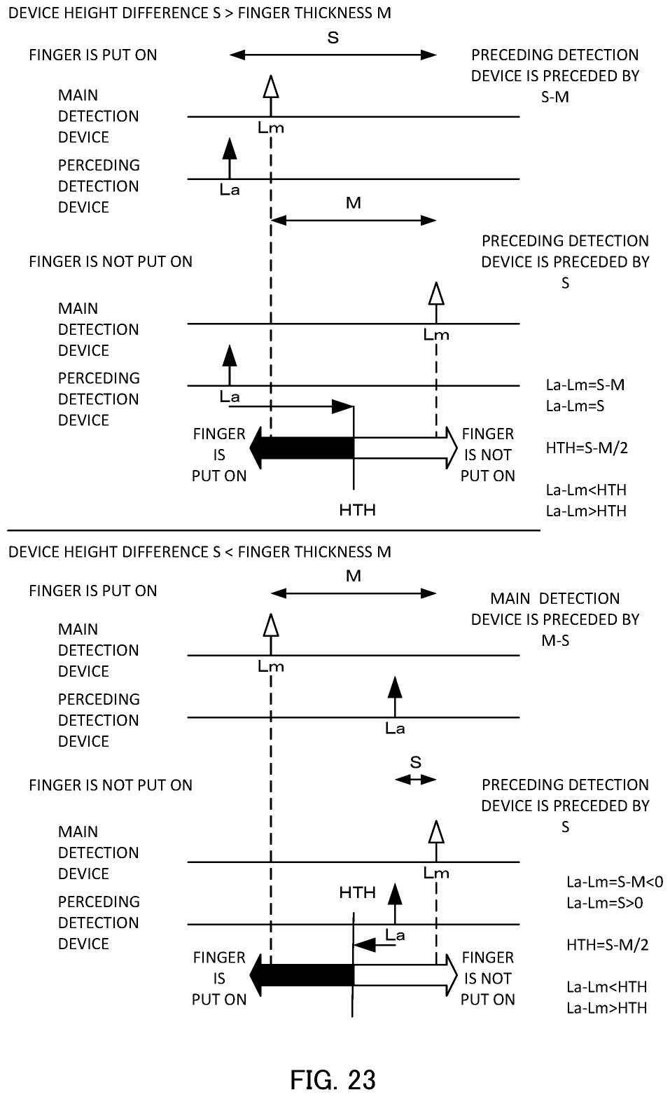

FIG. 23 shows the height relationship in the following four cases.

(1-1) When there is a finger in the setting of height difference S>finger thickness M
(1-2) When there is no finger in the setting of height difference S>finger thickness M
(2-1) When there is a finger in the setting of height difference S<finger thickness M
(2-2) When there is no finger in the setting of the height difference S<finger thickness M
In the case of (1-1), the main detection device detects the finger at the height Lm after the preceding detection device detects the paper at the height La. La−Lm=S−M.

In the case of (1-2), the main detection device detects the paper at the height Lm after the preceding detection device detects the paper at the height La. La−Lm=S.

Therefore, for example, (1-1) and (1-2) can be discriminated by comparing La−Lm with S−M/2.

In the case of (2-1), the main detection device detects the paper at the height Lm, and then the preceding detection device detects the finger at the height La. Lm−La=M−S. Therefore, La−Lm=S−M.

In the case of (2-2), the main detection device detects the paper at the height Lm after the preceding detection device detects the paper at the height La. La−Lm=S.

Therefore, for example, (2-1) and (2-2) can be discriminated by comparing La−Lm with S−M/2.

Therefore, regardless of the magnitude relationship between the height difference S and the finger thickness M, it can be determined that there is a finger if La−Lm>S=M/2, and that there is no finger otherwise.

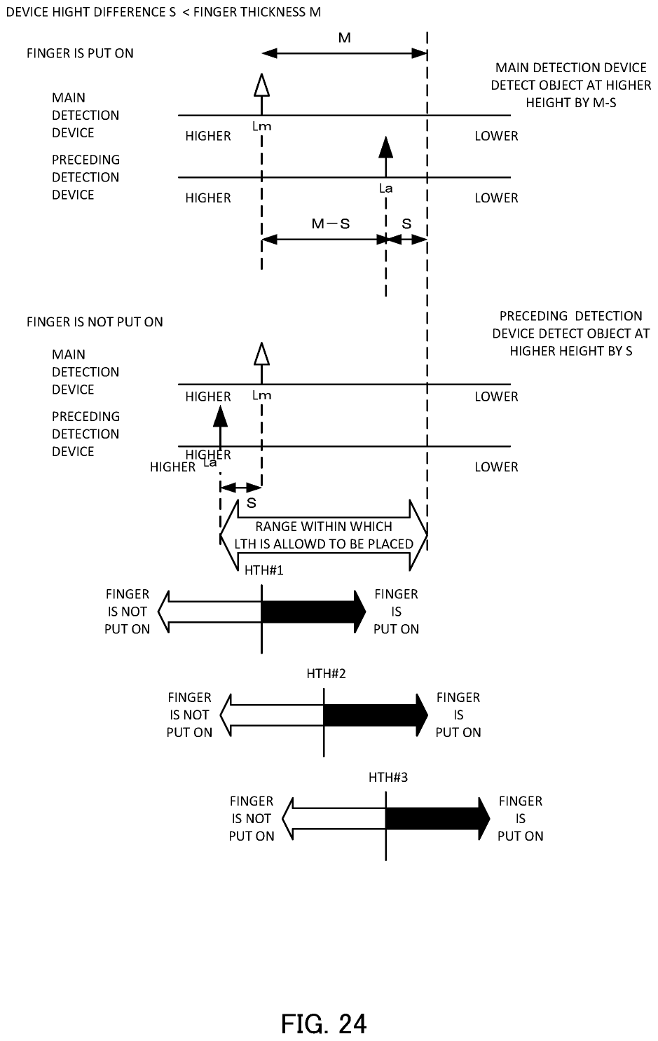

FIG. 23 is a timing diagram drawn based on the height La at which the preceding detection device detects the paper stack when the height difference S of the main detection device is larger than the thickness M of the finger and when the height difference S of the main detection device is smaller than the thickness M of the finger. On the other hand, FIG. 24 shows the timing at which the main detection device is drawn with reference to the height Lm at which the main detection device detects the paper stack or the finger when the height difference S of the main detection device is smaller than the thickness M of the finger.

Referring to FIG. 24, if there is a finger, the preceding detection device detects the paper stack at a position La that is lower by M−S than the height Lm at which the main detection device detects the finger. On the other hand, when there is no finger, the preceding detection device detects the paper stack at a position La that is higher by S than the height Lm at which the main detection device detects the paper stack.

Therefore, the height difference Lm−La is M−S when there is a finger, and S when there is no finger. Here, MS<0, S>0. In the present embodiment, the threshold height HTH can be set to a height between a position higher by S and a position lower by M−S with respect to the height Lm.

The threshold height HTH #1 shown in FIG. 24 is set to the same height as the height Lm of the main detection device. The threshold height HTH #2 is set to the height of the center of the HTH settable range (that is, a height that is −S M/2 below the height Lm). The threshold height HTH #3 is set to a height lower than the threshold height TTH #2 (for example, a height lower than the height Lm by −S+3M/4).

If the rear portion is raised as compared with the front portion of the paper stack, there is a possibility that the finger cannot be detected even though the finger is on the paper stack. This possibility is lower when the threshold height TTH #2 is used than when the threshold height HTH #1 is used. Furthermore, this possibility is lower when threshold height #3 is used than when threshold height TTH #2 is used.

Accordingly, even when the difference in height between the main detection device and the preceding detection device cannot be changed, the possibility that the finger on the paper stack cannot be detected can be reduced by adjusting the threshold height HTH according to the rising state of the paper stack.

If the front portion is raised as compared with the rear portion of the paper stack, there is a possibility that it is determined that the finger is on the paper stack even though no finger is on the paper. This possibility is lower when the threshold height HTH #2 is used than when the threshold height HTH #3 is used. Further, this possibility is lower when the threshold height HTH #1 is used than when the threshold height HTH #2 is used.

Therefore, even when the height difference between the main detection device and the preceding detection device cannot be changed, the threshold height TTH is adjusted according to the rising state of the paper stack, so that the finger is not on the paper stack. You can reduce the possibility of misjudging that you are riding.

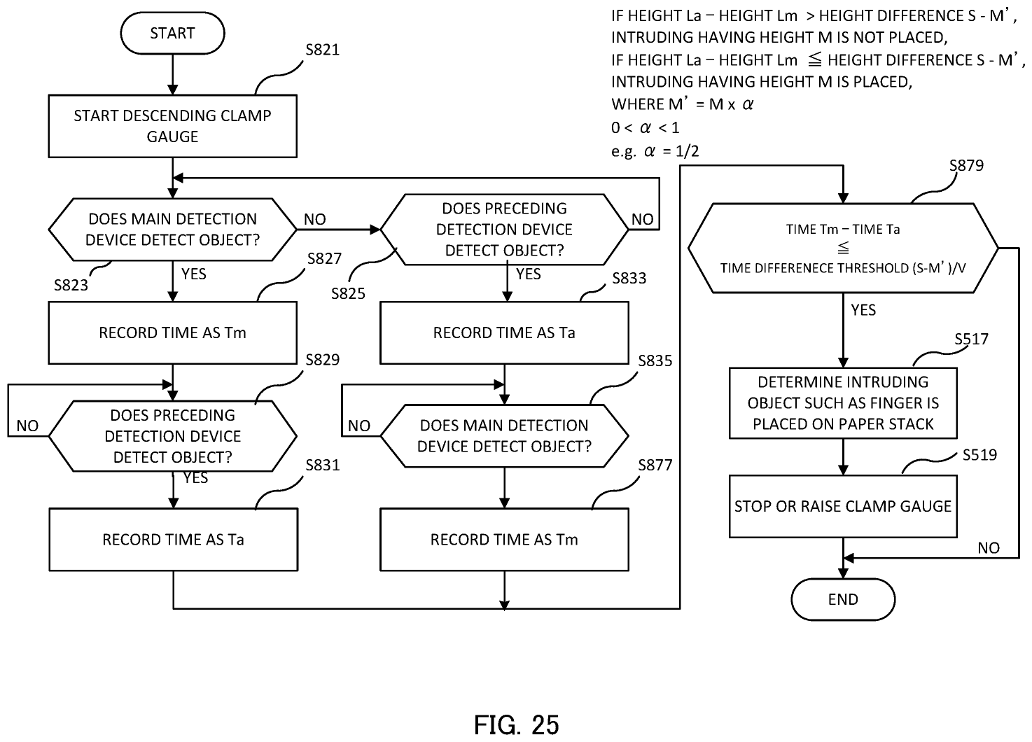

Next, an intruding object detection method using the principle of described with reference to FIG. 25.

First, the lowering of the clamp gauge is started (step S821).

Next, stay waiting (NO in step S823, NO in step S825) for that the main detection device 223 detects an object or the preceding detection device 221 detects an object.

If the main detection device 223 detects an object earlier than the preceding detection device 221 in the waiting loop of steps S823 and S825 (YES in step S823), the time at this time is recorded as Tm (step S827).

Next, stay waiting (NO in step S829) for that the detection device 221 detects an object.

Next, if the preceding detection device 221 detects an object (YES in step S829), the time at this time is recorded as Ta (step S831), and the process proceeds to step S879.

If the preceding detection device 221 detects an object earlier than the main detection device 223 in the waiting loop of steps S823 and S825 (YES in step S825), the time at this time is recorded as Ta (step S833).

Next, stay waiting (NO in seep S835) for that the main detection device 223 detects an object.

Next, if the main detection device 223 detects an object (YES in step S835), the time at this time is recorded as Tm (step S877), and the process proceeds to step S879.

In step S879, it is determined whether

Time Tm−Time Ta≤(S−M′)/V

here,
V is the descending velocity of the clamp gauge
   is satisfied or not

If so (YES in step S879), it is determined that an intruding object such as a finger is placed on the paper stack 103 (step S517), and the clamp gauge 107 is stopped or raised as a collision avoidance process. (Step S519).

The method of FIG. 25 can be used regardless of the magnitude relationship between the height difference S of the main detection device 223 and the preceding detection device 221 and the height of the intruding object. Therefore, even if the height of the main detection device 223 and the preceding detection device 221 is changed in practice, the method of FIG. 25 can be used continuously. However, in this case, it is necessary to adjust the height difference S at the threshold value (S−M′)/V used in step S879 as the actual height difference S is changed. The measured value of the height difference S may be substituted to S at (S−M′)/V.

The method of FIG. 25 can be used regardless of the magnitude relationship between the height difference S and the height M of the intruding object when, for example, the intruding object to be detected is changed to an intruding object having a different height. In this case, however, it is necessary to adjust M at the threshold value (S−M′)/V used in step S879 in accordance with the change in the height M of the intruding object. It is only necessary that the estimated height M of the intruding object can be substituted to M at (S−M′)/V=(S−αM)/V.

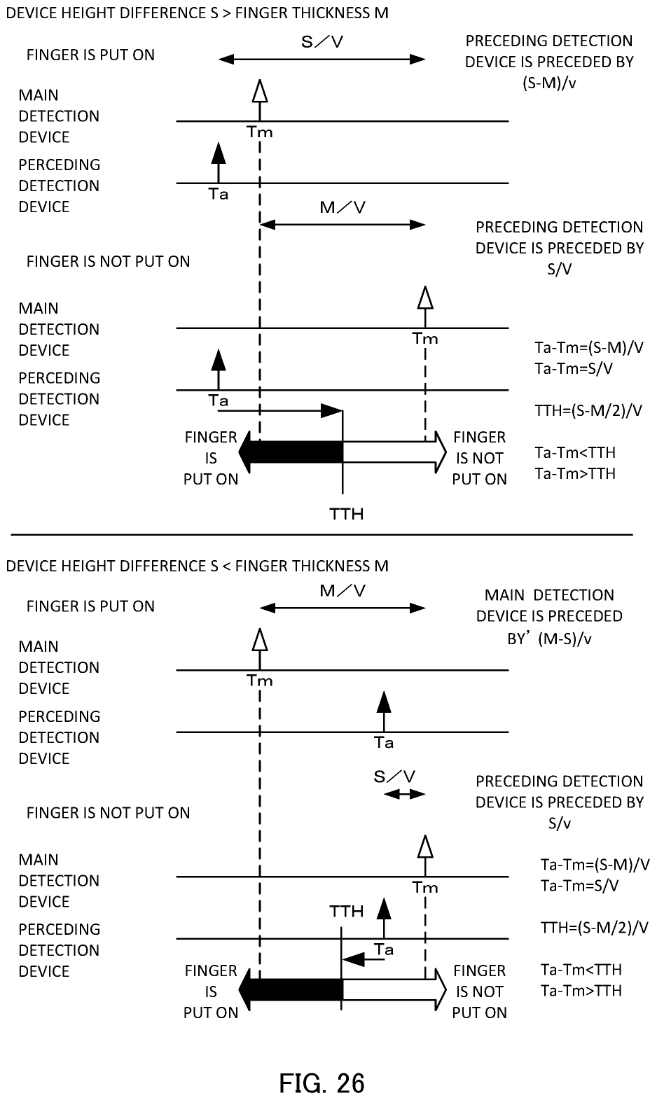

FIG. 26 shows the liming relationship in the following four cases.

(1-1) When there is a finger in the setting of height difference S>finger thickness M
(1-2) When there is no finger in the setting of height difference S>finger thickness M
(2-1) When there is a finger in the setting of height difference S<finger thickness M
(2-2) When there is no finger in the setting of the height difference S<finger thickness M
In the case of (1-1), the main detection device detects the finger at time Tm after the preceding detection device detects the paper at time Ta. Tm−Ta (SM)/V.
In the case of (1-2), the main detection device detects the paper at time Tm after the preceding detection device detects the paper at time Ta. Tm−Ta=S/V.
Therefore, for example, (1-1) and (1-2) can be discriminated by comparing Tm−Ta with (S−M/2)/V.

In the case of (2-1), after the main detection device detects paper at time Tm, the preceding detection device detects a finger at time Ta. Ta−Tm (MS)/V. Therefore. Tm−Ta=(S−M)/V.

In the case of (2-2), after the preceding detection device detects the paper at time Ta, the main detection device detects the paper at time Tm. Tm−Ta=S/V.

Therefore, for example, (2-1) and (2-2) can be discriminated by comparing Tm−Ta with (S−M/2)/V.

Therefore, regardless of the magnitude relationship between the height difference S and the finger thickness M, it can be determined that there is a finger if Tm−Ta≤(S−M/2)/V, and that there is no finger otherwise.

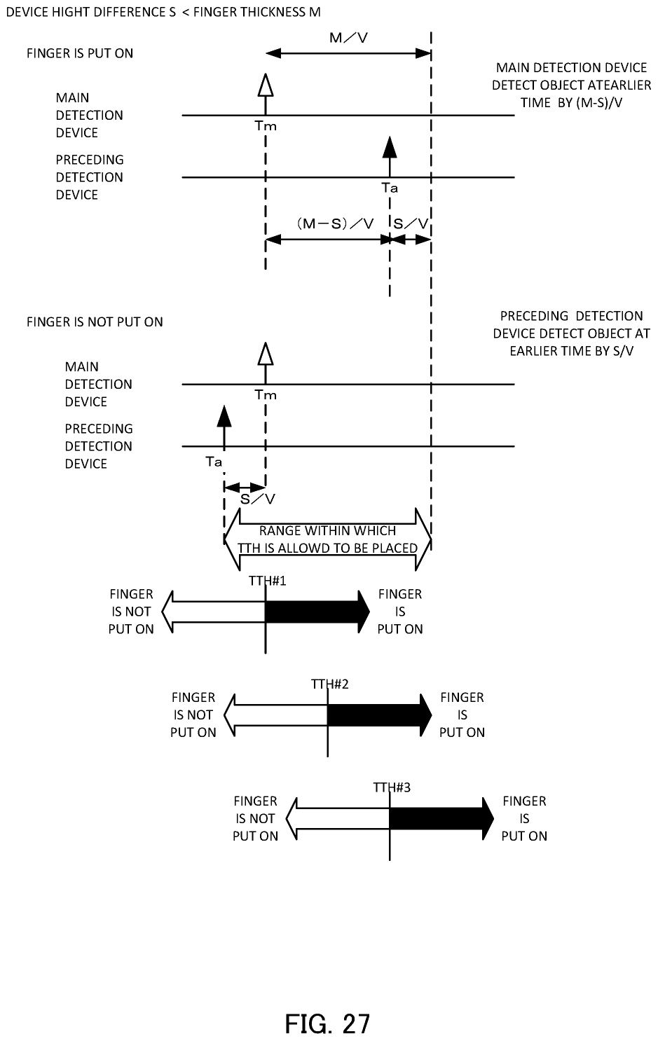

FIG. 26 is a timing diagram drawn on the basis of time Ta when the preceding detection device detects the paper stack when the height difference S between the main detection device and the preceding detection device is larger than the finger thickness M and when the height difference S between the main detection device and the preceding detection device is smaller than the finger thickness M. On the other hand, FIG. 27 is drawn on the basis of the time Tm when the main detection device detects the paper stack or the finger when the height difference S between the main detection device and the preceding detection device is smaller than the thickens M of the finger.

Referring to FIG. 27, when there is a finger, the preceding detection device detects the paper stack at time Ta after (M−S)/V from time Tm when the main detection device detects the finger. On the other hand, when there is no finger, the preceding detection device detects the paper stack at a time Ta that is S/V before the time when the main detection device detects the paper stack.

Therefore, the time difference Ta−Tm is (M−S)/V>0 when there is a finger, and −S/V<0 when there is no finger. In this embodiment, the threshold time TTH can be set to a time between the time before S/V and the time after (M−S)/V with respect to the time Tm.

The threshold time TTH #1 shown in FIG. 27 is set at the same time as the time Tm. The threshold time TTH #2 is set at the center time of the TTH settable range (that is, the time after (−S+M/2)/V from the time Tm). The threshold time TTH #3 is set to a time later than the threshold time TTH #2 (for example, a time later by (−S+3M/4)/V than the time Tm).

If the rear portion is raised as compared with the front portion of the paper stack, there is a possibility that the finger is not detected even though the finger is on the paper stack. This possibility is lower when the threshold time TTH #2 is used than when the threshold time TTH #3 is used. Further, this possibility is lower when the threshold time #1 is used than when the threshold time TTH #2 is used.

Therefore, even if the height difference between the main detection device and the preceding detection device cannot be changed, the possibility that the finger on the paper stack is not detected is reduce by adjusting the threshold time TTH according to the rising state of the paper stack.

If the front portion is raised as compared with the rear portion of the paper stack, there is a possibility that it may be erroneously determined that the finger is on the paper stack even though the finger is not on the paper stack. This possibility is lower when the threshold time TTH #2 is used than when the threshold time TTH #1 is used. Furthermore, this possibility is lower when the threshold time #TTH3 is used than when the threshold time TTH #2 is used.

Therefore, even when the height difference between the main detection device and the preceding detection device cannot be changed, the possibility that it is determined that the finger is on the paper stack even though the finger is not on the paper stack is reduced by adjusting the threshold time TTH according to the rising state of the paper stack.

For example, if the threshold time TTH #2 is used, both errors can be reduced in a balanced manner.

The invention disclosed in the Patent Document 1 is such an invention that only threshold time TTH #1 that is the same time as time Tm can be selected as the threshold time. Therefore, in the invention of the Patent Document 1, an appropriate threshold value cannot be set according to the paper state unless the height difference between the main detection device and the preceeding detection device is adjusted.

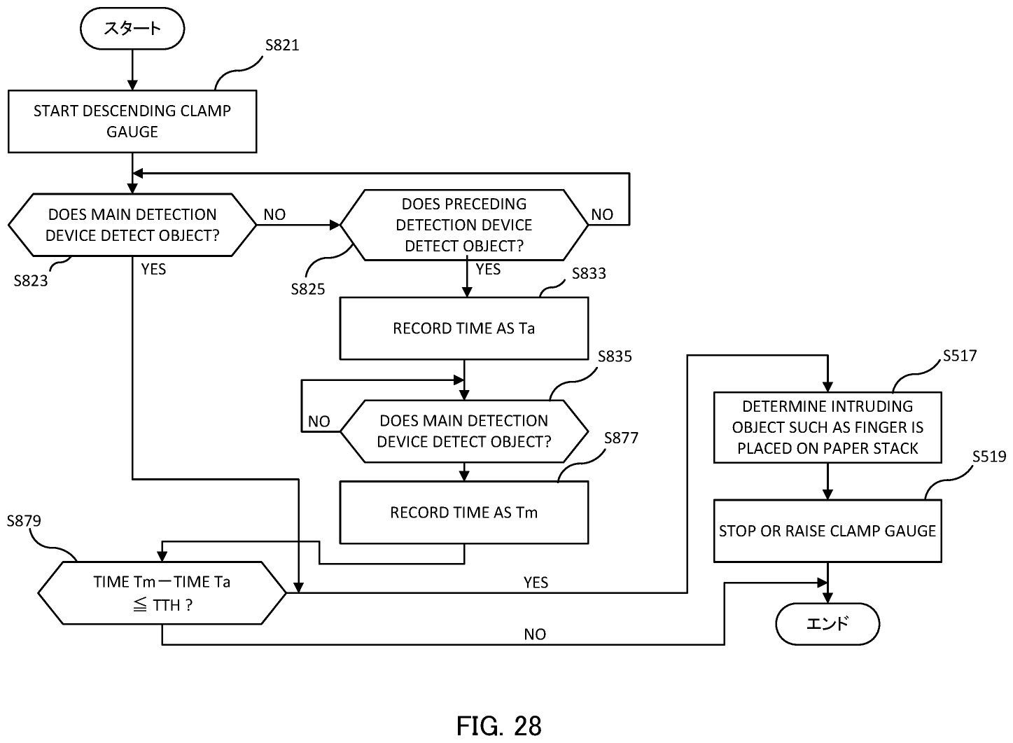

One simplified variation of this embodiment is the method illustrated by the flowchart of FIG. 28. In addition, when the method of the Patent Document 1 is used as a reference, a threshold time after threshold time TTH #1, which is the same time as time Tm, can be set as the threshold time. Therefore, with reference to FIG. 28, in addition to the threshold time TTH #1, the threshold time after the threshold time TTH #1 such as the threshold time TTH #2 and the threshold time TTH #3 can be set. Therefore, for example, a situation that a correct determination that there is the finger can not be made by using the threshold time TTH #1 can be solved by shifting the threshold time TTH #1 to the threshold time TTH #2.

In step S519, setting may be made not only to stop or raise the clamp gauge but also to prevent the knife from descending. Further, if the knife is currently descending, stopping the knife may be as well.

### Fourth Embodiment

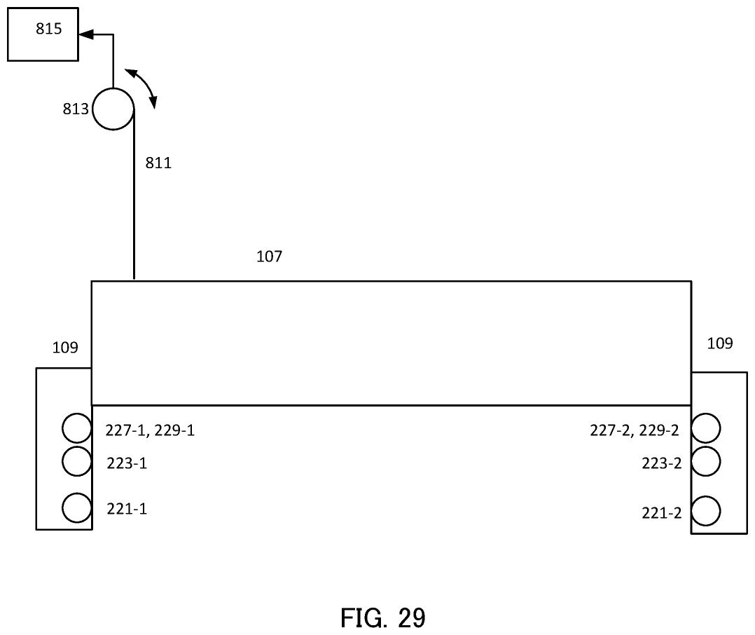

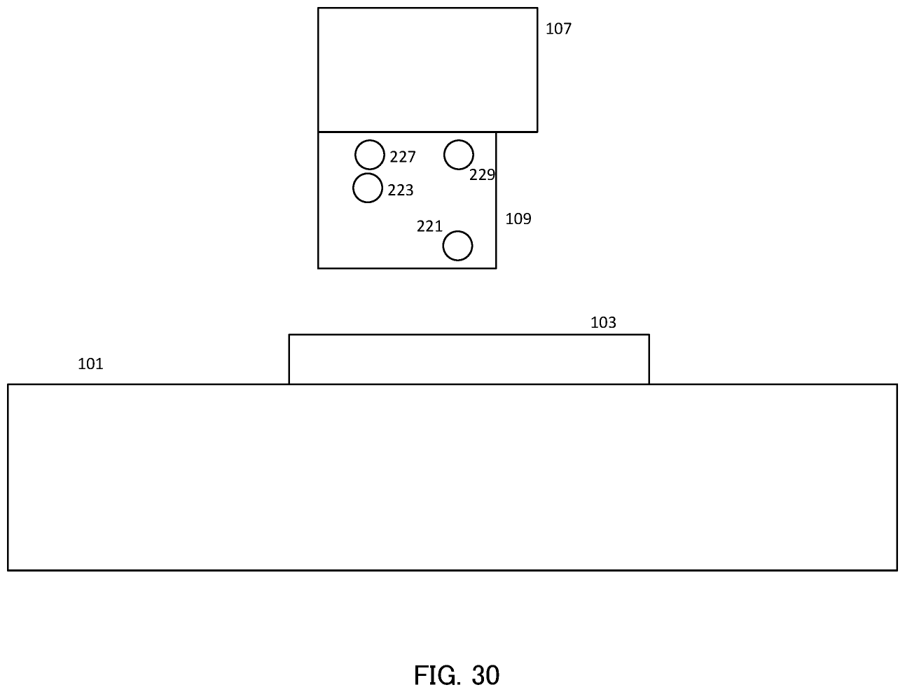

In the fourth embodiment, as shown in FIGS. 29 and 30, as the detection devices, the preceding detection device 221 and the main detection device 223 are arranged as in the first embodiment. The immediately lower front portion detection device 227 and the immediately lower rear portion detection device 229 are arranged.

The immediately lower front portion detection device 227 and immediately lower rear portion detection device 229 are provided in order to detect a finger which is put on the paper stack 103 by the operator while the clamp gauge 107 is moving up and down repeatedly after reaching the paper stack 103, and after the detection, to stop or raise the clamp gauge 107.

Once the clamp gauge 107 reaches the paper stack 103, both the immediately lower front portion detection device 227 and the immediately lower rear portion detection device 229 are in the detection state (ON) However, after the clamp gauge 107 is raised thereafter, if an operator accidentally puts a finger or the like on the paper stack 103, the combination that the immediately lower front portion detection device 227 is in the detection state (ON) and immediately lower rear portion detection device 229 is in the non-detection state (OFF) takes place. When such a combination state takes place, the clamp gauge 107 is stopped or raised.

The same applies when the operator accidentally puts a finger or the like on the paper stack 103 while the clamp gauge 107 is stagnating near the paper stack 103 before the clamp gauge 107 reaches the paper stack 103. This can be detected and the clamp gauge 107 can be stopped or raised by the same principle. In this case, the combination that the immediately lower front portion detection device 227 is in the detection state (ON) and immediately lower rear portion detection device 229 is in the non-detection state (OFF) takes place before both of them enter in the detection state (ON). When such an ON-OFF combination occurs, the clamp gauge 107 is stopped or raised.

These detections are continuously performed after the clamp gauge 107 first starts to descend from the top dead center.

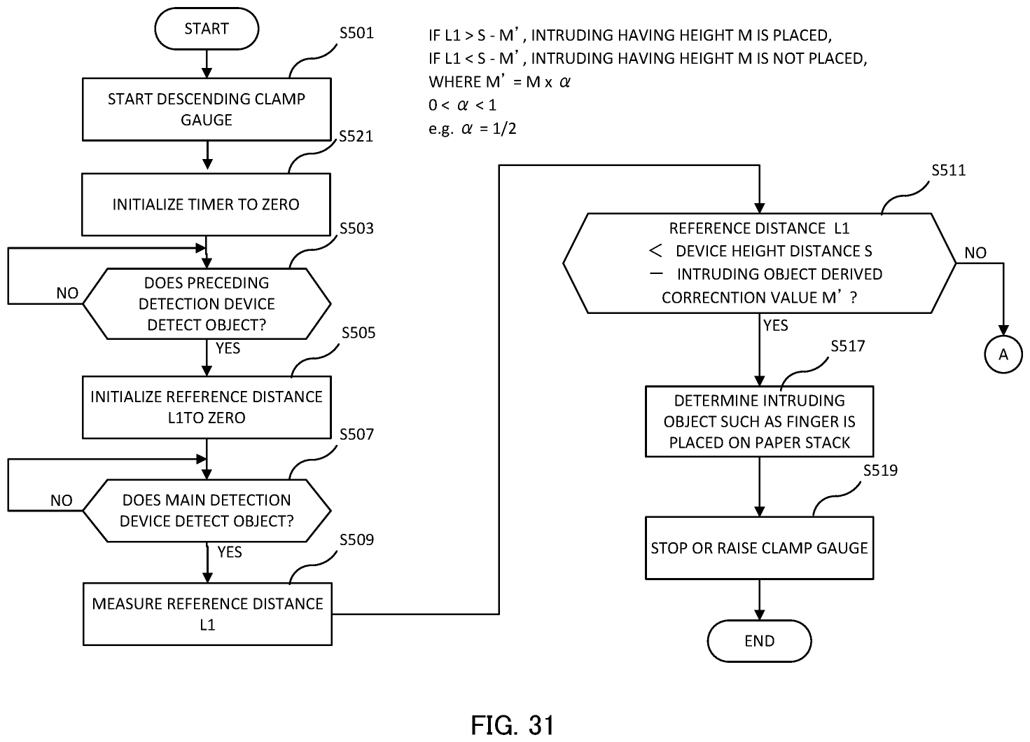

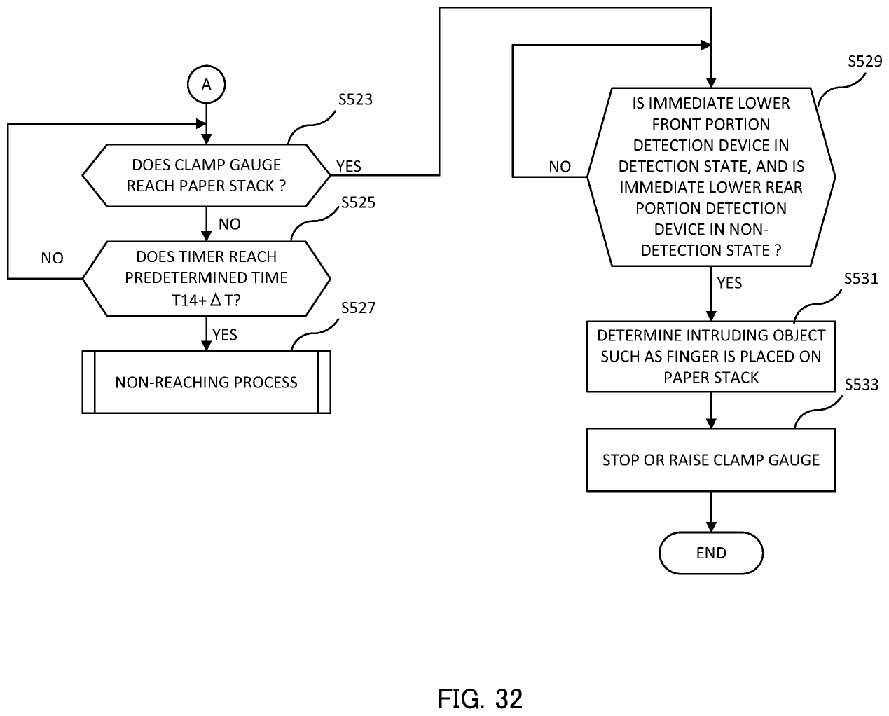

Next, an intruding object detection method using this principle will be described with reference to FIGS. 31, 32 and 33.

First, lowering of the clamp gauge is started (step S501).

If the descent is started, the elapsed timer is initialized to zero (step S521).

Next, the stay waiting (NO in step S503) for that the preceding detection device 221 detects an object.

Next, if the preceding detection device 221 detects an object (YES in step S503), the reference distance L1 is initialized to zero (step S505).

Next, the stay waiting (NO in step S507) for that the main detection device 223 detects an object.

Next, if the main detection device 223 detects an object (YES in step 3507), the reference distance L1 is measured (step S509).

Next, it is determined whether

Reference distance L1<detection device height difference SM′

is satisfied or not (step S511).

If so (YES in step S511), it is determined that an intruding object such as a finger is placed can the paper stack (step 1517), and the clamp gauge 107 is stopped or raised as a collision avoidance process. (Step S519).

If not (NO in step S511), stay waiting for that the clamp gauge 107 reaches the paper stack 103 until the elapsed time reaches T14+ΔT (NO in steps S523 and S525). Here, time T14 is a descent time corresponding to the normal descending velocity of the clamp gauge 107 (time required from top dead center to normal stacking thickness), and ΔT is a predetermined margin time.

If the clamp gauge 107 reaches the paper stack 103 before the elapsed time reaches T14+ΔT (NO in step S525, YES in step S523), stay waiting far that the immediately lower front portion detection device 227 is in the detection state (ON), and the immediately lower rear portion detection device 229 becomes a non-detection state (OFF) (NO in step S529).

When this becomes the case (YES in step 529), it is determined that an intruding object such as a finger is placed an the paper stack 103 (step S531), and the clamp gauge 107 is stopped or raised (step S533).

If the clamp gauge 107 does not reach the paper stack 103 before the elapsed time reaches T14+ΔT (NO in step S523, YES in step S525), non-reaching processing is executed (step 527).

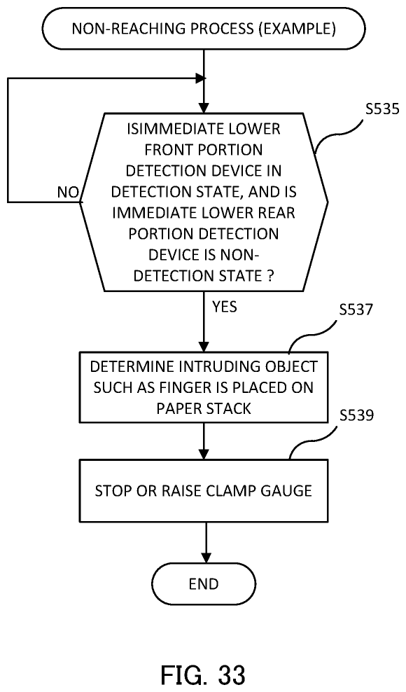

An example of the non-reaching process is shown in FIG. 33. That is, stay waiting for that the immediately lower front portion detection device 227 becomes in the detection state (ON) and the immediately lower rear portion detection device 229 becomes the non-detection state (OFF) (NO in step S535).

If so (YES in step 535), it is determined that an intruding object such as a finger is placed on the paper stack 103 (step S537), and the clamp gauge 107 is stopped or raised (step S539).

Note that the fact that the clamp gauge 107 has reached the paper stack can be detected by, for example, a phenomenon that the clamp gauge does not descend even when the pressure for lowering the clamp gauge is increased by the hydraulic circuit.

Note that the main detection device 223 may also be used as the immediately lower front portion detection device 227. In this case, the immediately lower front portion detection device 227 can be omitted. Further, in this case, the immediately lower rear portion detection device 229 is arranged at the same height as the main detection device 223.

### Fifth Embodiment

As explained in the third embodiment, it is possible to detect the finger placed on the paper stack only by the immediately lower front portion detection device 227 and immediately lower rear portion detection device 229 as shown in FIG. 29 and FIG. 30. That is, by setting appropriately the threshold height or threshold time as described with reference to FIG. 20 to FIG. 27, even with the immediately lower front portion detection device 227 and immediately lower rear portion detection device 229 arranged in the front and rear at the same height, an intruding object such as a finger placed on the paper stack out be detected.

### Sixth Embodiment

The sixth embodiment includes the above-described embodiment in part, but considers a situation in which an intruding object such as a finger is inserted and a general operation of the clamp gauge 107.

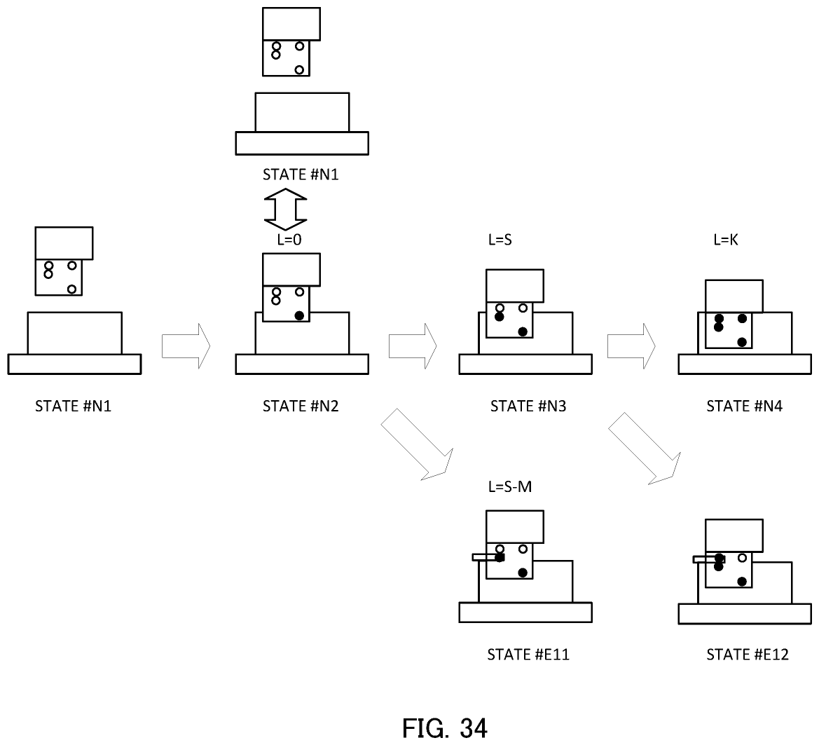

Referring to FIGS. 34 and 33, the state #N1 is a state in where the a clamp gauge 107 is at the top dead center and is about to descend.

First, referring to FIG. 34, the state #N2 is a state in which the clamp gauge 107 has been lowered to a position where the preceding detection device 221 detects the paper stack 103 after the clamp gauge 107 starts to descend.

State #N3 is a state in which the clamp gauge 107 is further lowered and has come down to a position where the preceding detection device 221 and the main detection device 223 detect the paper stack 103.

In state #N4, the clamp gauge 107 has reached the paper stack 103, and the preceding detection device 221, the main detection device 223, the immediately lower front portion detection device 227, and the immediately lower rear portion detection device 229 are detecting the paper stack 103.

Here, if an intruding object such as a finger is placed on the paper stack 103 before proceeding to the state #N3, the state proceeds to the state #E11 without proceeding from the state #N2 to the state #N3. In the state #E11, the preceding detection device 221 detects the paper stack 103, but the main detection device 223 detects an intruding object such as a finger.

In the above embodiment, the reference distance L is reset to zero in the state #N2, and it is determined whether the reference distance L is S or S−M when the main detection device 223 detects some object by compering the reference distance at that time with S−M/2, in order to determine whether the state when that time is the state #3 or the state #E11.

In addition, after proceeding to state #N2, the clamp gauge 107 may rise and return to state #N1. In this case, the reference distance L is negative, but if the state returns to the state #N2, the reference distance L becomes zero again, and the above operation can be continued. The reference distance L may be reset again when tanning to the state #N2.

Further, an intruding object such as a finger may enter in the state #N3 to enter the state #E12. But in this case, the immediately lower front portion detection device 227 becomes in the detection state and the immediately lower rear portion detection device 229 stay in the non-detection state. On the basis of occurrence of this combination of detection state and non-detection state, it is possible to detect that an intruding object such as a finger has entered.

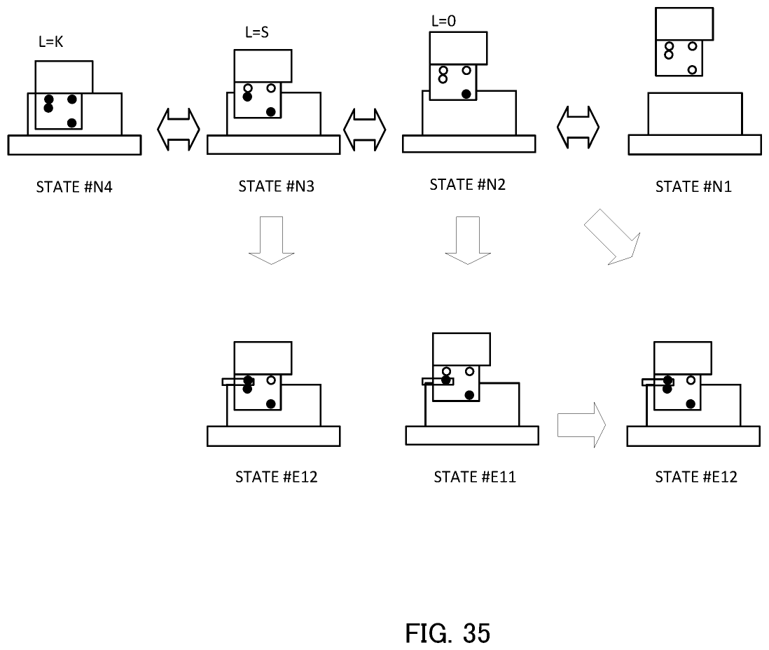

Referring to FIG. 35, even after the clamp gauge 107 reaches the stack paper 103 and enters the state #N4, the clamp gauge 107 may be raised and then enters the state #N3 before the stack paper 103 is cut by the knife. If the clamp gauge further rises, the state moves to state #N2, and if it further rises, the state moves to state #N1.

Also, the clamp gauge 107 that has started to rise may fall again. Therefore,

State #N4←→State #N3←→State #N2′←→State #N1

A state transition in both directions on a single line occurs.

If an intruding object such as a finger is placed on the paper stack 103 in the state #N3, the state proceeds to the state #E12. In the state #E12, the immediately lower front portion detection device 227 is in the detection state (ON), and the immediately lower rear portion detection device 229 is in the non-detection state (OFF). Therefore, if this combination occurs, it is determined that the state has transitioned to state #E12. In this case, a collision avoidance process is executed.

If an intruding object such as a finger is placed on the paper stack 103 in the state #N2, the process proceeds to the state #E11. In the state #E11, the main detection device 223 is in the detection state (ON). Further, the reference distance L which has be reset in the state #N2 is between 0 and S−m. Therefore, when the main detection device 223 becomes in the detection state (ON), it can be determined that the state transitions to the state #E11 based on the reference distance L being smaller than, for example, S−M/2. In this case, a collision avoidance process is executed.

In FIG. 34, four states from state #N4 to state #N1 are depicted discretely, but the height of the clamp gauge 107 changes continuously. In particular, the clamp gauge 107 not only rises and falls between these states, but also rests at an arbitrary height. Notwithstanding as to whether the clamp gauge 107 is currently ascending, descending, or stationary, if the finger enters from the front, the detection state of the immediately lower front portion detection device 227 and the immediately lower rear portion shift from the state #N3 to the state #E11, or the preceding detection device 221 and the main detection device 223 shift from the state #N2 to the state #E11. In such shifts, if the clamp gauge 107 is currently descending, the main detection device 223 and the immediately lower front portion detection device 227 will detect a near upper end portion of the finger. If the clamp gauge 107 is currently ascending or stationary, the main detection device 223 and the immediately lower front portion detection device 227 will detect any height portion of the finger.

If it is sufficient to perform the collision avoidance process when the process proceeds to the state #E12 after the transition to the state #E11, the collision avoidance process may be omitted even if it is known that the state #E11 has been entered. For example, when the descending velocity of the clamp gauge 107 when entering the state #E11 is less than a predetermined value, the collision process may omitted at that time.

However, if the accuracy of detection of state #E11 is higher than the accuracy of detection of state #E12, when state #E11 is detected, collision avoidance processing is executed.

Also, if the collision avoidance process is started for the first time when the process proceeds to the state #E12 via the state #E11, the clamp gauge may descend further to some degree until the clamp gauge stops, and the collision avoidance may not be executed surely. Therefore, when the state #E11 is detected, the descending velocity of the clamp gauge is made lower than the normal descending velocity as a countermeasure. By doing so, even if the collision avoidance process is started when entering the state #E12 from the state #E11, the descending distance before the clamp gauge stops can be shortened.

In addition, when the paper stack is high, it may start from state #N2 without starting from state #N1. In such a case, the descending velocity of the clamp gauge is reduced from the normal level from the beginning. By doing so, it is possible to shorten the distance by which the clamp gauge descends from the start of the state #N2 to the state #E11 until the clamp gauge stops after entering the collision avoidance process.

Further, if the descending velocity of the clamp gauge is lowered when entering the state #N2, the following effects can be obtained. That is, if the main detection device 223 enters the detection state after entering the state #N2, there is a possibility that the state has shifted to the state #E11, but the necessity of performing the collision avoidance process at this time is eliminated. Then, the collision avoidance process only needs to be performed when the state #E11 is advanced to the state #12. By doing so, it is possible to erroneously perform the collision avoidance operation when the main detection device 223 enters the detection state by proceeding from the state #N2 to the state #N2.

Although the description is duplicated, there is a case where the start state is state #N2, then transitions to state #E11, and then transitions to state #E12. Even in such a case, by reducing the descending velocity of the clamp gauge from the start, even if the collision avoidance process is started after the transition to the state #E12, the distance from which the clamp gauge descends is shortened.

In addition, although the description is duplicated, there is a case where the state at the start is state #N2, theft transitions to state #N3, and then transitions to state #E12. Even in such a case, by reducing the descending velocity of the clamp gauge from the start, even if the following process is started after the transition to the state #E12, the distance that the clamp gauge descend is shortened. Can do.

In addition, the clamp gauge is lowered from the state #N1 at a normal velocity, and the velocity is maintained even when the state #N2 is shifted to. Then, when the main detection device 223 enters the detection state. If it is not possible to determine whether the transition is to state #N3 or the transition to state #E11, the velocity of the clamp gauge may be reduced. By doing so, when it is detected that the state #E12 has been subsequently entered and the collision avoidance process is started, the distance by which the clamp gauge descends before the clamp gauge stops can be shortened. Therefore, when the main detection device 223 enters the detection state, it may not be necessary to determine whether it has transitioned to state #N3 or state #E11.

When the main detection device 223 enters in the detection state, there is a case where it is not possible to determine whether this is because of entering to the state #N3 or to the state #E11 and therefore, the clamp gauge is left unstopped, However, if the descending velocity of the clamp gauge is lowered from the state #N2, the distance that the clamp gauge descends after the collision avoidance process is started when the state #E12 is entered and before the clamp gauge stops can be shortened. Therefore, when the main detection device 223 enters the detection state, it is not necessary to determine whether it has transitioned to state #N3 at state #E11.

If an intruding object such as a finger is placed on the paper stack 103 in the state #N2, the state may move to the state #E12 without going through the state #E11. In the state #E12, the immediately lower front portion detection device 227 is in the detection state (ON), and the immediately lower rear portion detection device 229 is in the non-detection state (OFF). Therefore, it is determined that the state has transitioned to state #E12 due to the occurrence of this combination. In this case, a collision avoidance process is executed.

### Seventh Embodiment

The seventh embodiment includes the above-described embodiment in part, but considers total operation of the clamp gauge 107 and a situation in which an intruding object such as a finger and other movements are inserted.

Since the operation described with reference to FIG. 34 in the sixth embodiment is the sane in the seventh embodiment, the redundant description is omitted.

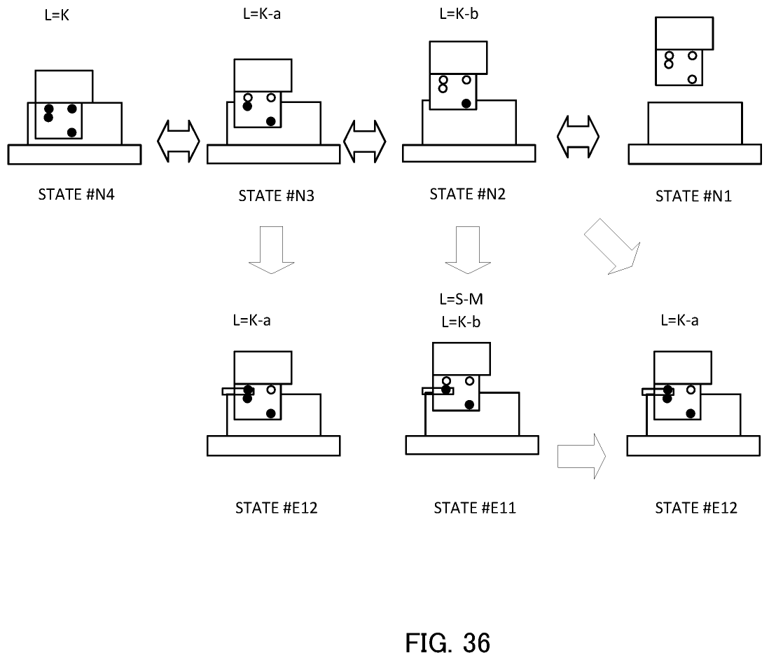

Referring to FIG. 36, when the clamp gauge 107 reaches the paper stack 103, the state #N4 is entered. The reference distance L at this time is measured as the bottom dead center reference distance K.

Even after the clamp gauge 107 reaches the paper stack 103 and enters the state #N4, the clamp gauge 107 may be raised and then enters the state #N3 before the paper stack 103 is cut by the knife. If the clamp gauge further rises, the state moves to state #N2, and if it further rises, the state moves to state #N1.

Also, the clamp gauge 107 that has started to rise may fall again. Therefore,

State #N4←→State #N3←→State #N2←→State #N1

A state transition in both directions at a single line occurs.

If an intruding object such as a finger is placed on the paper stack 103 in the state #N3, the process proceeds to the state #E12. The entry into the state #E12 can be detected based on the reference distance L when the immediately lower front portion detection device 227 detects some object. That is, the difference between the reference distance L and the bottom dead center reference distance K when the immediately lower front portion detection device 227 detects some object is larger than a threshold (for example, a value obtained by multiplying the height M of an intruding object with a predetermined coefficient such as ½), it is determined that the object detected by the immediately lower front portion detection device 227 is an intruding object such as a finger and has entered the state #E12. In this case, a collision avoidance process is executed.

If an intruding object such as a finger is placed on the paper stack 103 in the state #142, the process proceeds to the state #E11. In the state #E11, the main detection device 223 is in the detection state (ON). Further, the reference distance L which has been reset in the state #N2 is between 0 and S−M. Therefore, if the reference distance L is smaller than, for example, S−M/2 when the main detection device 223 is in the detection state (ON), it is determined that the state transitions to the state #E11. Further, if the difference between the reference distance L and the bottom dead center reference distance K when the main detection device 223 detects an object is greater than a threshold (for example, a value obtained by multiplying the height of the intruding object with a predetermined coefficient (for example, ½)), the object detected by the main detection device 223 may be an intruding object such as a finger and may be determined to have entered the state #E11. We may combine these judgments. For example, if it is determined that the state #E11 has been entered using only one method, it may be determined that the state #E11 has been entered as a whole. If it is determined that the state #E11 has been entered, a collision avoidance process is executed. However, the collision avoidance process in state #E11 may be omitted if the collision avoidance process when the process proceeds to state #E12 is sufficient. For example, if the descending velocity of the clamp gauge 107 when entering the state #E11 is detected to be less than a predetermined value, the collision process may be omitted at state #E11.

### Eighth Embodiment

In the sixth embodiment, during the descending period of the clamp gauge 107, if descending velocities V1, V2 and V3 are defined such that the descending velocity until the preceding detector 221 detects an object is V1, the descending velocity until the main detector 223 detects the object is V2, and the descending velocity until the clamp gauge 107 reaches the paper stack 103 is V3, descending velocities V1, V2 and V3 are adjusted to satisfy the following equations:

V1>V2

V25≤V3

When the object detected by the main detection device 223 is the paper stack 103, the descending velocity changes in a sequence of V1→V2→V3. When the object detected by the main detection device 223 is an intruding object such as a finger, the clamp gauge stops or rises before the velocity becomes V3, so the descending velocity changes in a sequence of V1→V2.

The descending velocity V2 may be the same as the descending velocity in the case of a normal soft clamp.

By making V1 faster than the conventional clamp descending velocity, the overall required time can be shortened.

In the present embodiment, even if the clamp gauge 107 collides with an intruding object such as a finger, the collision speed V2 is the same as or less than the descending speed of a normal soft clamp, and it is possible to perform shorten an entire descent period. Further, if the descending velocity V2 is further reduced, the impact at the time of the collision is further reduced, and it becomes easy that the user who has witnessed that the finger or the like is about to be pinched takes time to avoid it.

### Ninth Embodiment

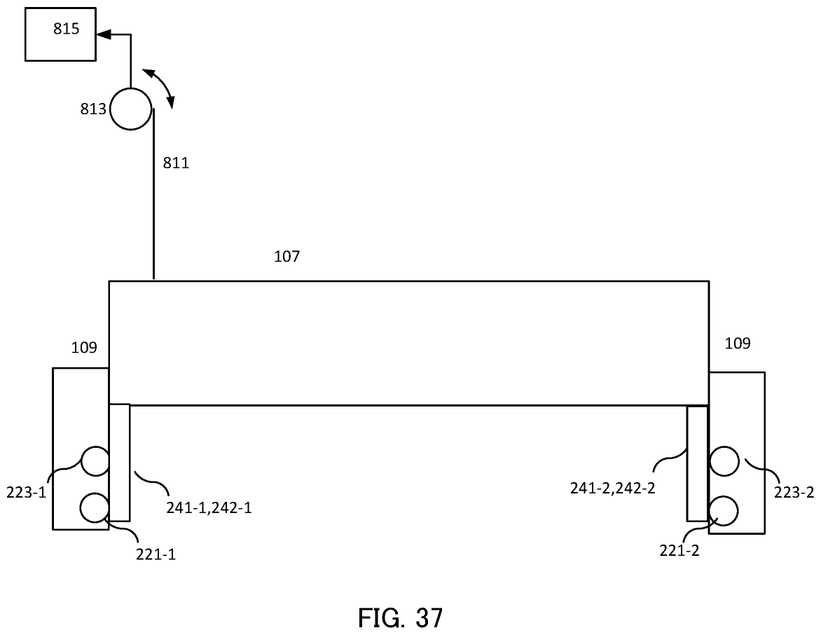

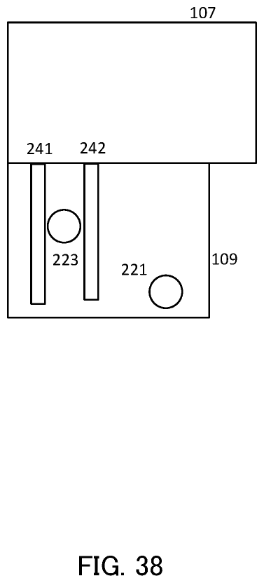

In the ninth embodiment, as shown in FIGS. 37 and 38, in addition to the preceding detection device 221 and the main detection device 223, the line-type immediately below front portion detection device 241 and the line-type direct lower rear portion detection device 242 are used.

The range of the detection range of both of the line-type immediately below front portion detection device 241 and the line-type direct lower rear portion detection device 242 starts from a position directly below the clamp gauge 107 in the height direction and ends at a position that is a predetermined distance downward therefrom.

Further, in the depth direction, the line-type immediately below front portion detection device 241 is disposed on the front portion of the line-type direct lower rear portion detection device 242.

In order to protect a finger or the like that has just reached the front edge of the clamp gauge 107, the line-type immediately below front portion detection device 241 is disposed as close as possible to the front edge of the clamp gauge 107 in the depth direction. If a finger or the like that is about to enter under the clamp gauge 107 is to be detected before reaching the front edge of the clamp gauge 107, for example, in the depth direction closer to the front portion than the front edge of the clamp gauge 107, it is preferable to arrange the line-type immediately lower front portion detection device 241 so that the detection range of the line-type immediately lower front portion detection device 241 includes the front side portion of the front edge of the clamp gauge 107.

In addition, as the position in the depth direction of the line-type direct lower rear portion detection device 242, it is preferable to select a position as far back as possible so that the detection range is an area where the operator's finger is less likely to enter.

By using the line-type immediately lower front portion detection device 241 and the line-type direct lower rear portion detection device 242, the finger 291 or the like that has entered between the paper stack 103 and the clamp gauge 107 can be detected regardless of the distance from the upper end of the paper stack 103 to the lower end of the clamp gauge 107.

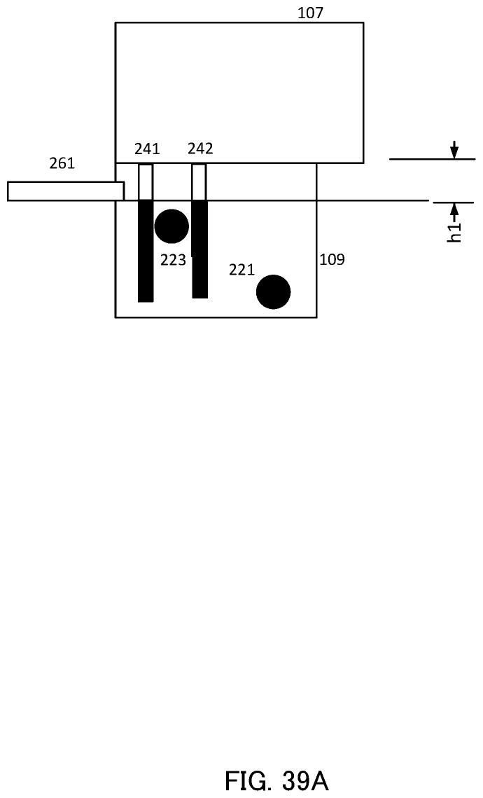

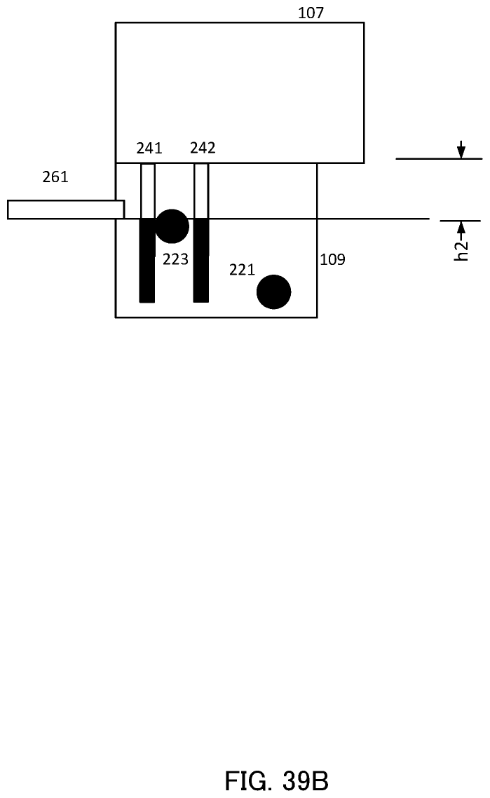

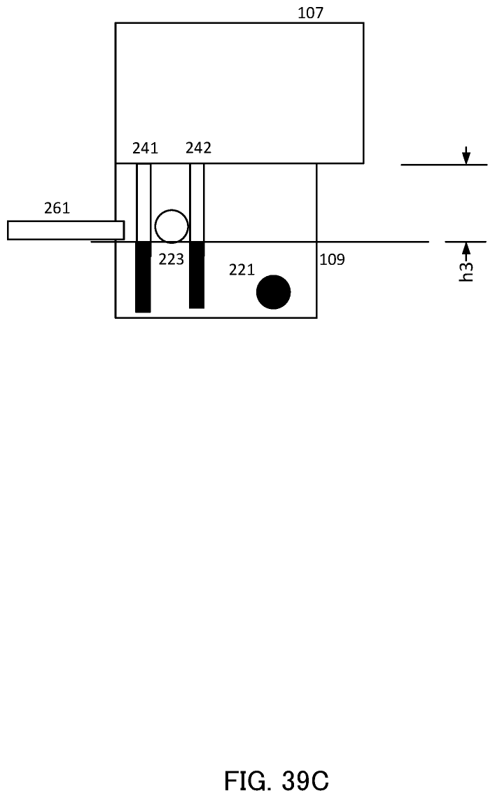

FIG. 39A to FIG. 39C show the detection status of the line detection device for each of the three distance, h1, h2, and h3 between the paper stack and the clamp gauge.

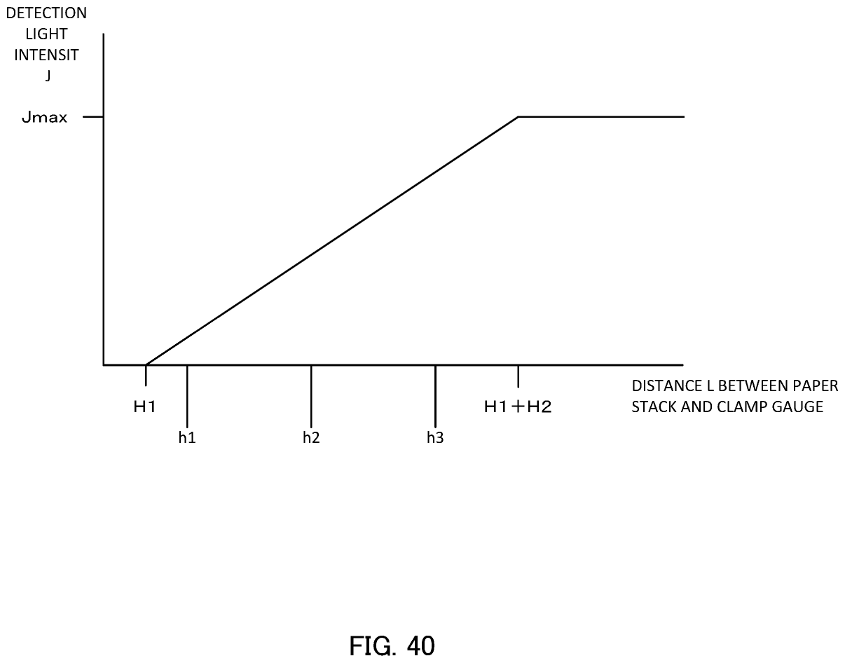

FIG. 40 is a graph showing the relationship between the distance h between the paper stack and the clamp gauge and the detected light intensity J. However, in the configuration shown in FIG. 39, H1=0. H2 is a detection range of the line-type immediately lower front portion detection device 241 and the line type direct lower rear portion detection device 242. When the distance h is in the range of H1 to H1+H2, the detected light intensity J changes linearly.

If the paper stack 103 is flat and nothing is placed on the paper stack 103, the detected light intensity P of the line-type immediately lower front portion detection device 241 is the same as the detected light intensity Q of the line-type direct lower rear portion detection device 242. Therefore, even if the clamp gauge 107 is at any height, the difference R(=Q−P) is zero.

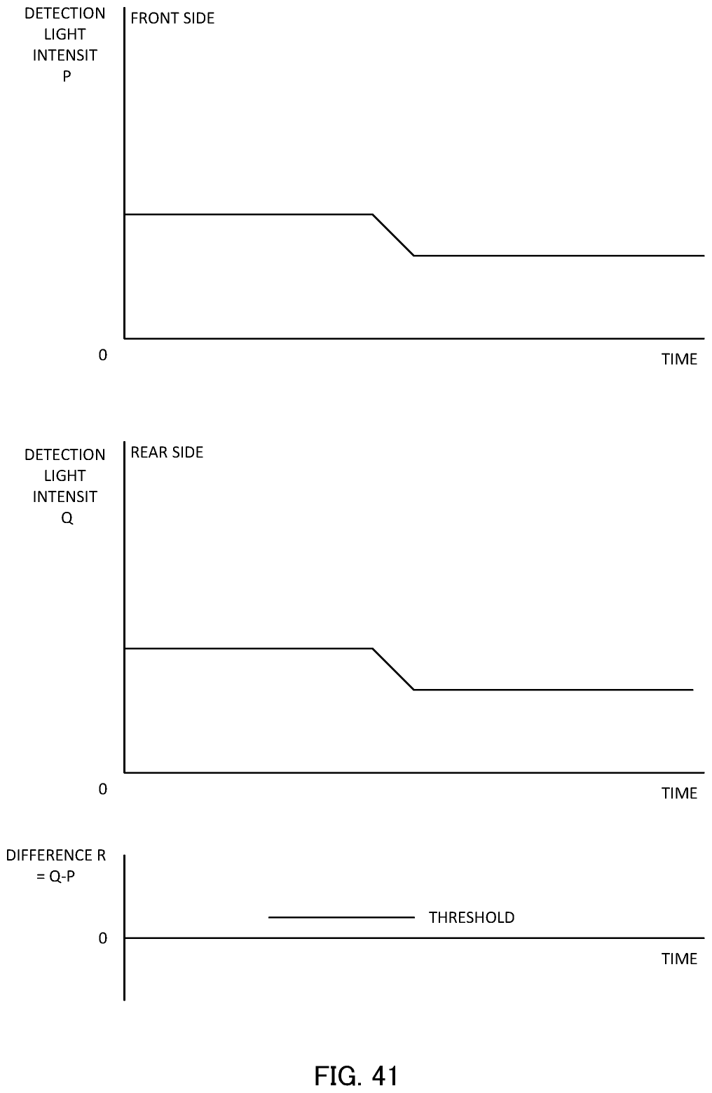

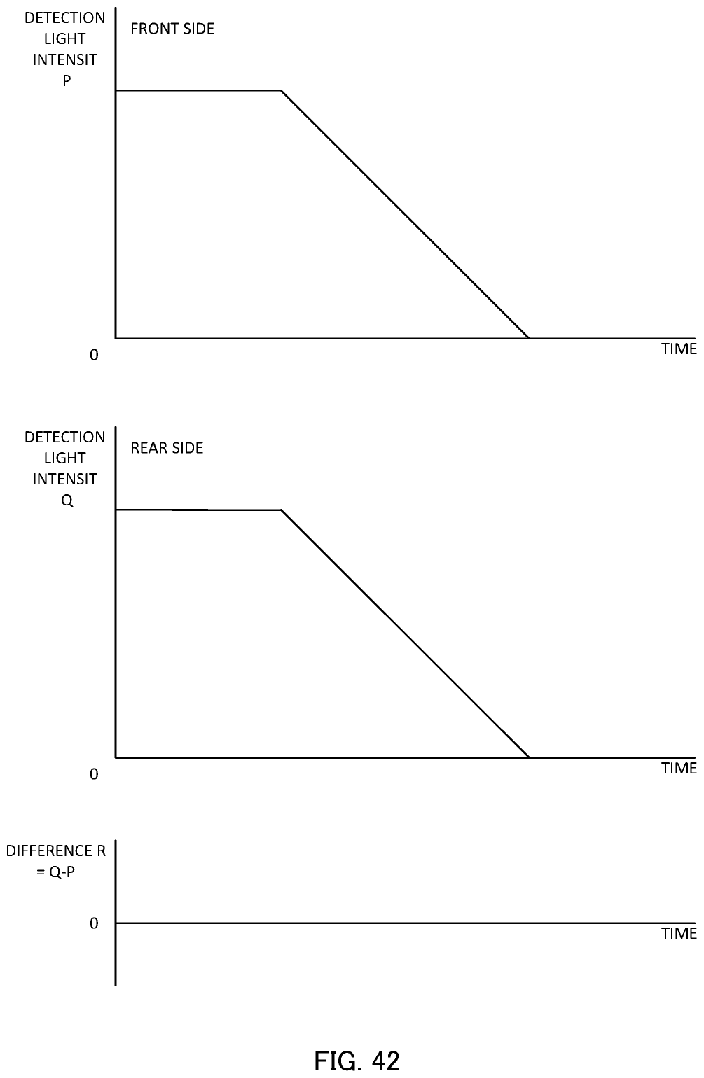

For example, if the clamp gauge 107 descends at a constant velocity, the detected light intensity P, the detected light intensity Q, and the difference R are as shown in FIG. 41 and FIG. 42. The difference between FIG. 41 and FIG. 42 is caused by the difference between the numerical values of H1 and H2.

Further, if the paper stack 103 is flat and an intruding object such as a finger is placed on the paper stack 103, the difference R(=Q−P) between the detected light intensity P of the line-type immediately lower front portion detection device 241 and the detected light intensity Q of the line-type direct lower rear portion detection device 242 the difference R(−Q−P) corresponds to the height of the intruding object, regardless of the height of the clamp gauge 107.

As shown in the graph of FIG. 40, the detected light intensity per unit dimension height is

J max/H2

Therefore, if the height of the intruding object M, the difference R is expressed as

R=J max×M/H2

Therefore, we can introduce, for example, a threshold value THS expressed as

THS=J max×(M/2)/H2,

and compare the difference R with THS. It is possible to determine whether or not an intruding object is placed on the paper stack 103. That means if

R>THS

then, it can be determined that an intruding object is placed on the paper stack 103.

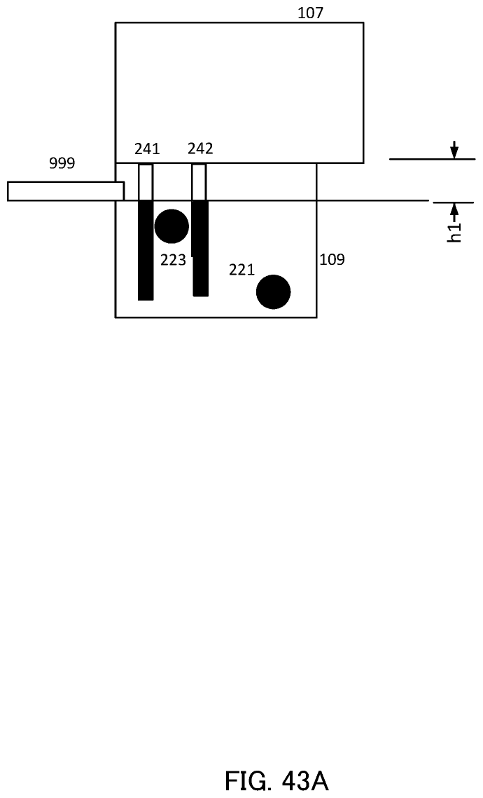

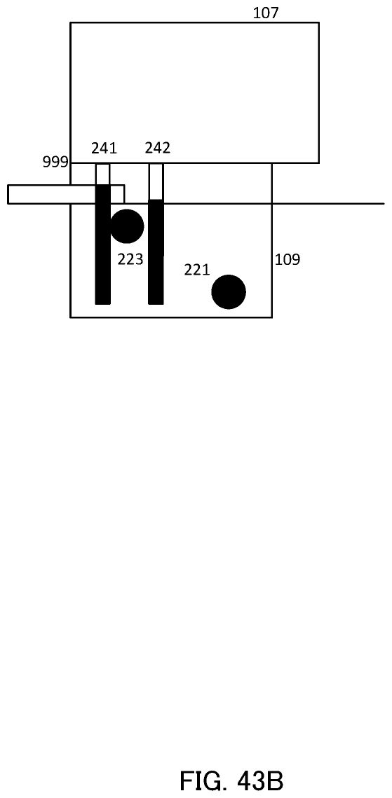

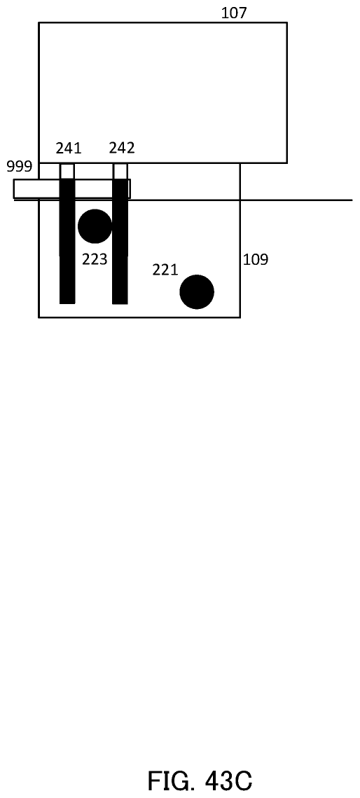

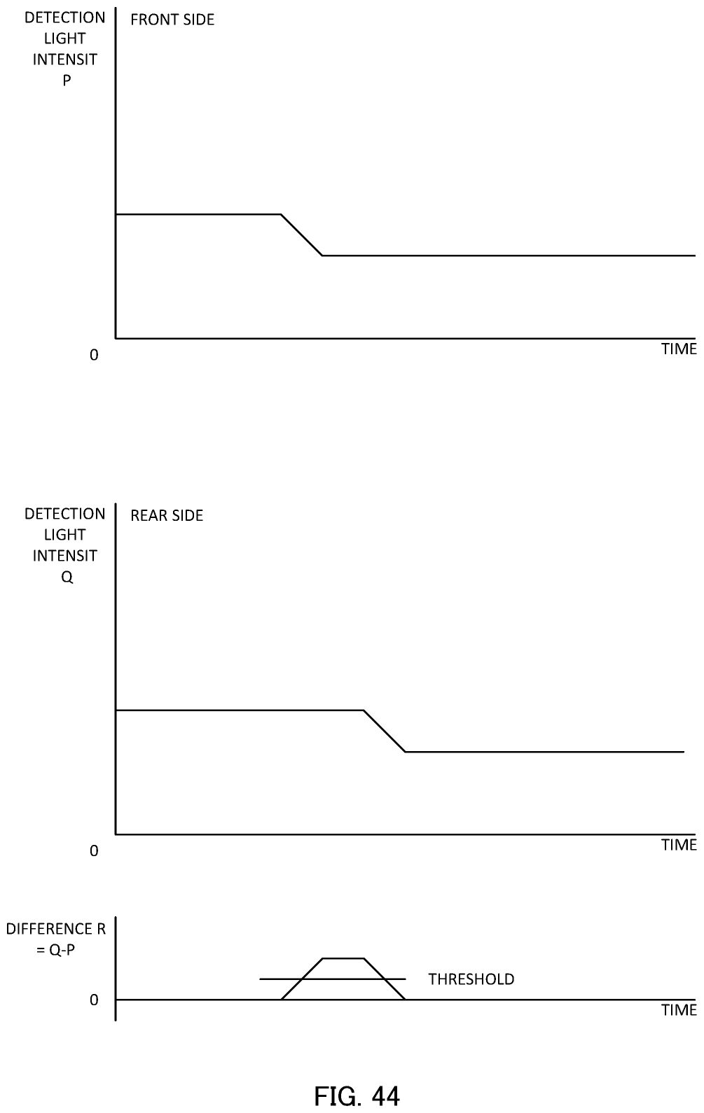

As shown in FIGS. 43A to 43C, when an intruding object such as a finger 191 enters during a period in which the distance h is maintained at a constant distance h1, the detected light intensity P of the line-type immediately lower front portion detection device 241, the detected light intensity Q of the line-type direct lower rear portion detection device 242, and the difference R(=Q−P) thereof varies as the time elapses as shown in FIG. 44.

On the other hand, when an intruding object such as a finger does not enter during a period in which the distance h is maintained at the constant distance h1, the detected light intensity P of the line-type immediately lower front portion detection device 241 and the detected light intensity Q of the line-type immediately below rear portion detection device 242 maintain a common constant level, and the difference R(=Q−P) maintains zero level.

In other words, when an intruding object such as the finger 291 does not enter during a period in which the distance h is maintained at the constant distance h1, the difference R is always zero, but if the intruding object enters, a period in which the difference R becomes positive occurs. More specifically, the difference R gradually increases when intrusion starts, and gradually decreases to zero after maintaining a predetermined peak value for a while.

Accordingly, a threshold value is provided between zero and the peak value, and it can be determined that an intruding object such as a finger has entered when the difference R exceeds the threshold value at the same time.

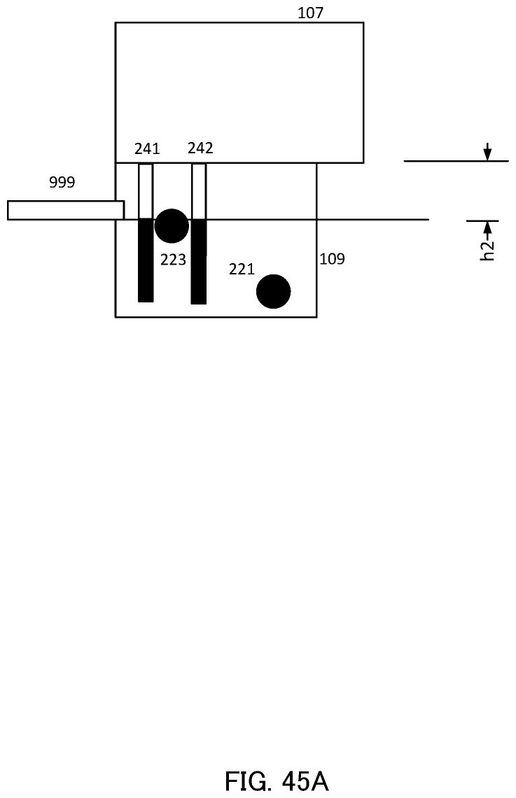

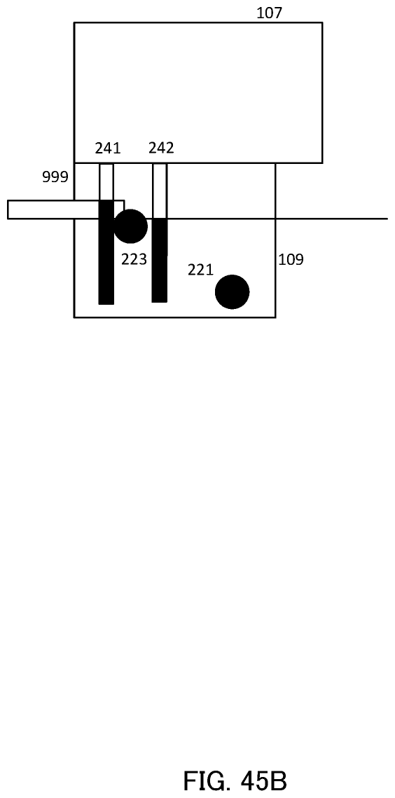

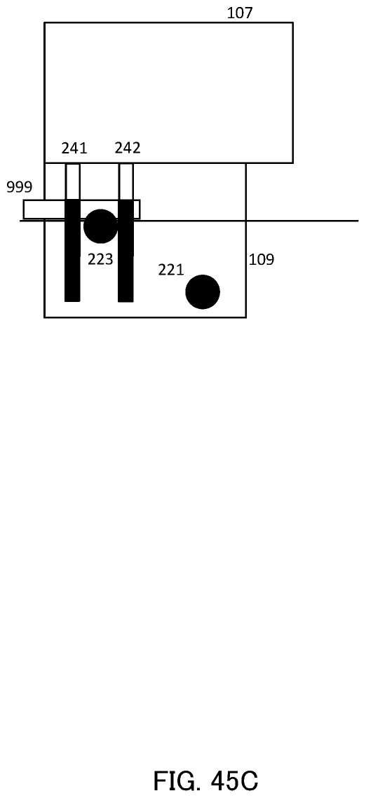

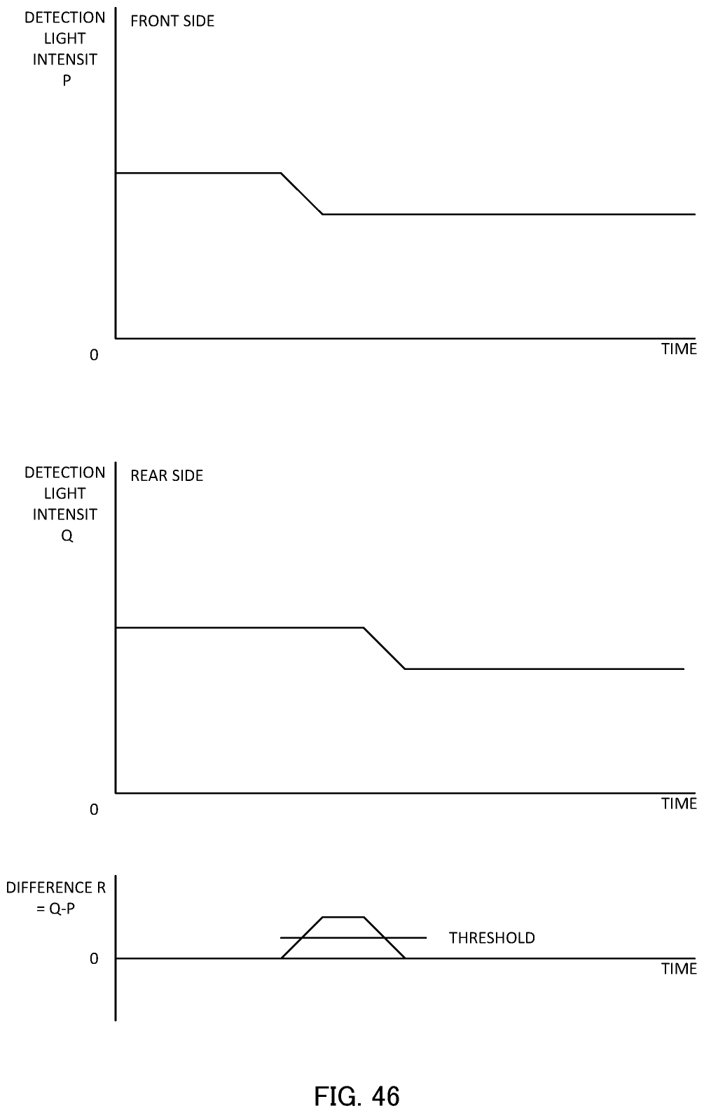

As shown in FIGS. 45A to 45C, when an intruding object such as a finger 291 enters during a period in which the distance h is maintained at a constant distance h2, the detected light intensity P of the line-type immediately lower front portion detection device 241, the detected light intensity Q of the line-type direct lower rear portion detection device 242, and the difference R(=Q−P) thereof varies as the time elapses as shown in FIG. 46.

On the other hand, when an intruding object such as a finger does not enter during a period in which the distance h is maintained at the constant distance h2, the detected light intensity P of the line-type immediately lower front portion detection device 241 and the detected light intensity Q of the line-type immediately below rear portion detection device 242 maintain a common constant level, and the difference R(=Q−P) maintains zero level.

In other words, when an intruding object such as the finger 291 does not enter during a period in which the distance h is maintained at the constant distance h1, difference R is always zero, but if the intruding object enters, a period in which the difference R becomes positive occurs. More specifically, the difference R gradually increases when intrusion struts, and gradually decreases to zero after maintaining a predetermined peak value for a while.

Accordingly, a threshold value is provided between zero and the peak value, and it can be determined that an intruding object such as a finger has entered when the difference R exceeds the threshold value at the same time.

Fran the above two cases, it can be seen that an intruding object such as a finger 291 that has entered between them can be detected by comparing the difference R with a threshold value regardless of the length of the distance h.

Further, even when an intruding object such as a finger enters while the clamp gauge 107 is moving up and down by an operation by an operator, it is possible to detect an intruding object such as a finger 291 that has entered between the paper stack 103 and the clamp gauge 107 by using the same detection method, that is, the detection method using the difference T and the threshold. In particular, it is not necessary to charge the threshold according to the distance.

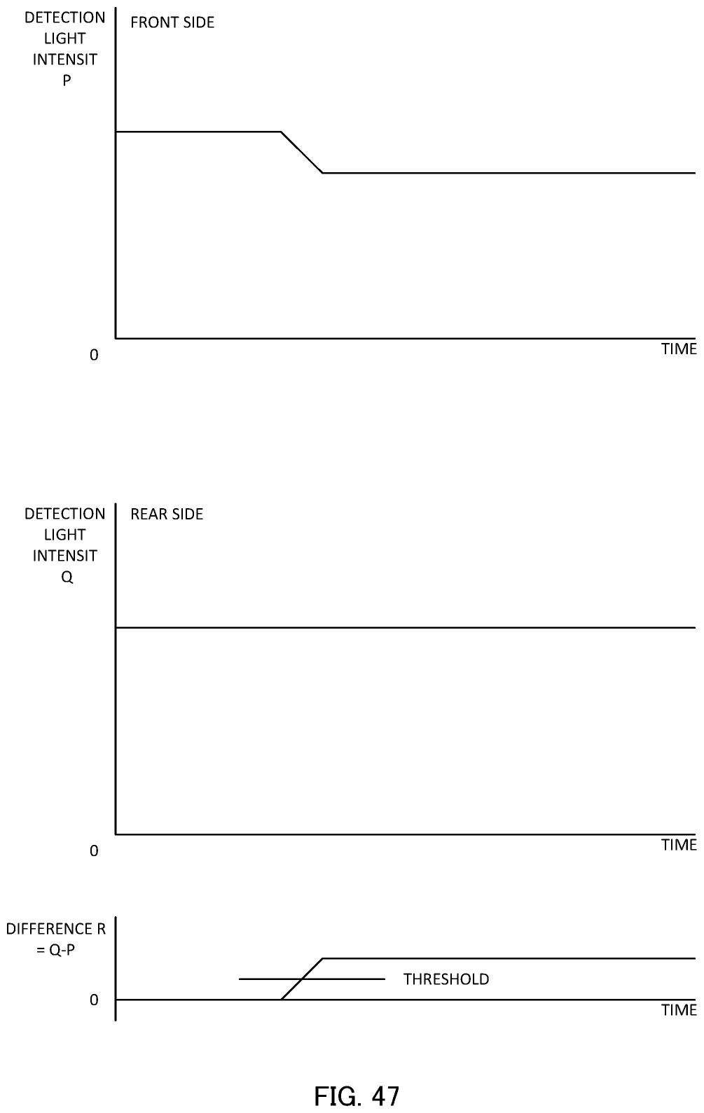

As shown in FIG. 47, when the finger has entered shallowly, the detected light intensity of the line-type direct lower side detection device 241 decreases, but the detected light intensity of the line-type immediately below rear portion detection device 242 does not decrease. Even in such a case, when the difference R becomes higher than the threshold value, it is determined that an intruding object such as a finger is placed on the paper stack and the clamp gauge is stopped or raised.

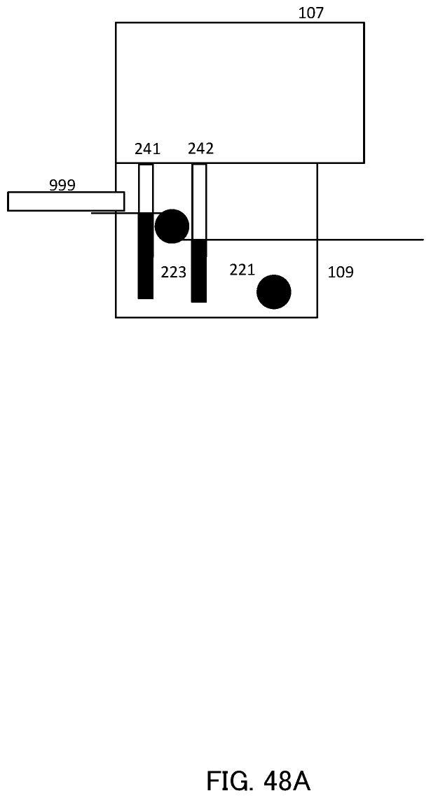

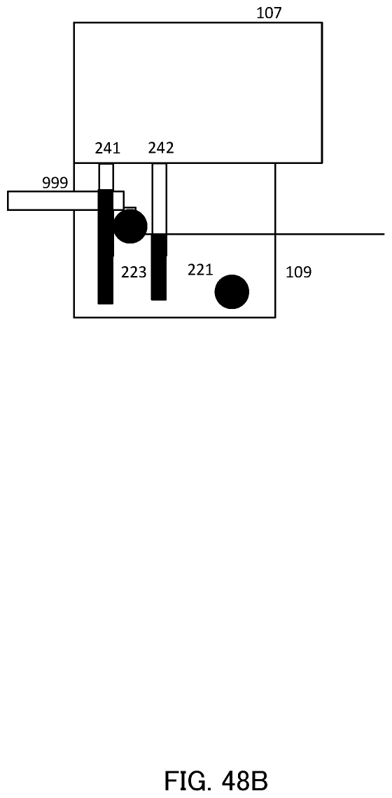

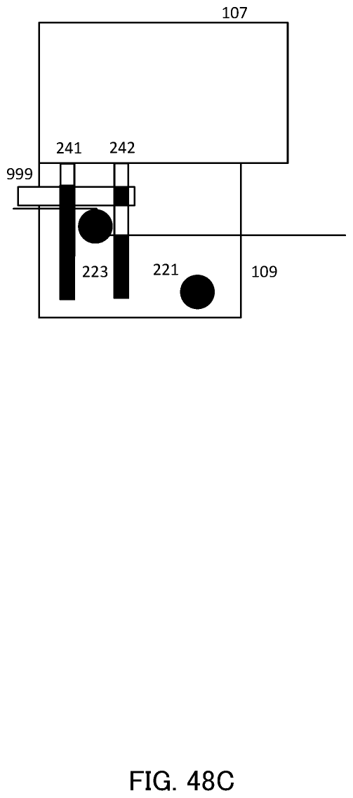

As shown in FIG. 48, a finger or the like may enter after a difference in front and back occurs in the height of the paper stack. In order to detect this, the following processing is performed.

That is, if it is determined that there is a height difference between the front and the back of the paper stack, the difference R is adjusted by the amount A responding to the height difference. That means

Difference R=Q−P−A.

In addition, a finger or the like that has entered between the paper stack having a height difference between the front and rear and the clamp gauge can be detected as follows:

In other words, the difference R between the detected light intensity P of the line-type direct lower side detection device 241 and the detected light intensity R of the line-type immediately below rear portion detection device 242, the delayed difference R′ obtained by delaying the difference R, and the secondary difference RR which is a difference between the difference R and the delayed difference R′ are calculated as follows:

Difference R(t)=Q(t)−P(t)

Difference R(t)=Q (t)−P′(t)=Q(t−ΔT)−P(t−ΔT)

Secondary difference RR(t)=R′(t)−R(t)

Here, ΔT is a predetermined delay time.

If the secondary difference RR(t) exceeds the threshold value TH, it is determined that the finger has entered. Here, the threshold value TH, for example, a value obtained by multiplying the finger thickness by a predetermined coefficient (exceeding zero and less than 1, for example, 0.5).

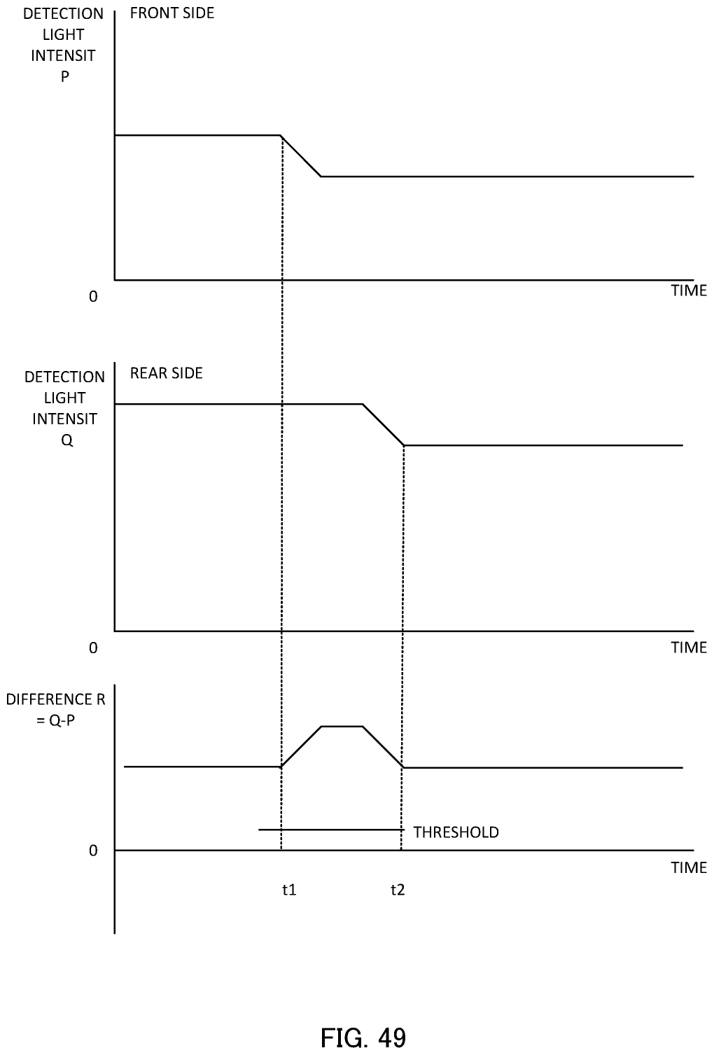

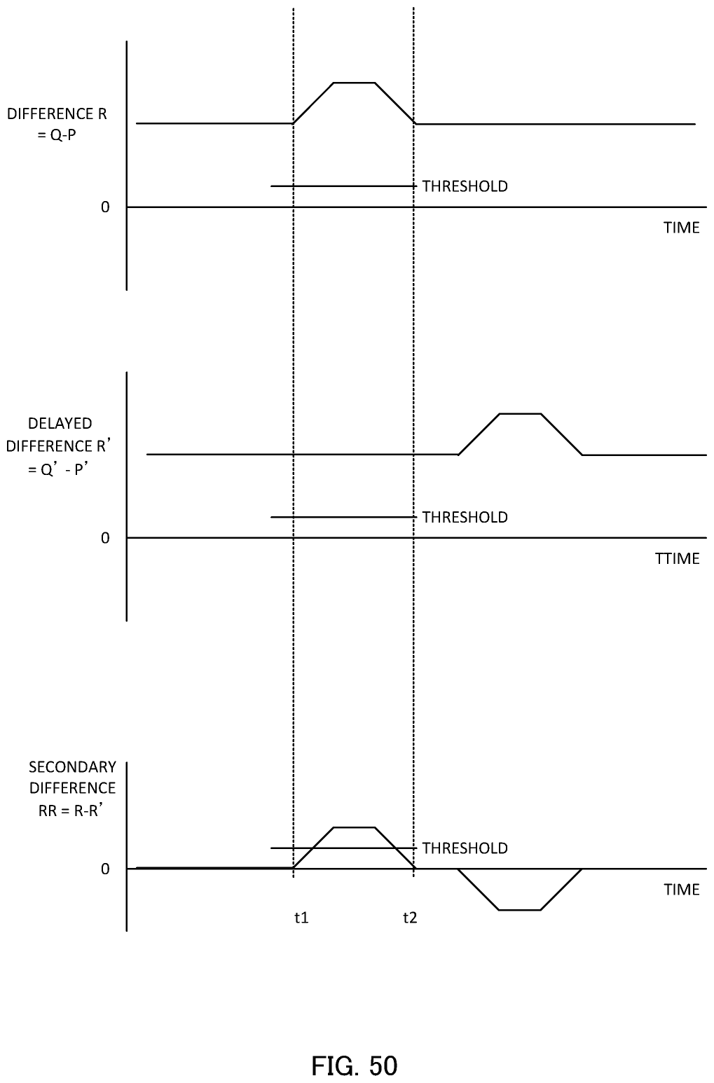

This will be described with reference to FIGS. 49 and 50.

FIG. 49 shows the detected light intensity P of the line-type direct lower side detection device 241, the detected light intensity Q of the line-type direct rear portion detection device 242, and the difference R thereof. Although the difference R exceeds the threshold value, it is avoided to determine that there is an intruding object.

Next, the difference R, the delay difference R′ obtained by delaying the difference R, and the secondary difference RR that is the difference between the difference R and the delay difference R′ are as shown in FIG. 49. Therefore, it can be seen that the finger intrusion can be detected by comparing the secondary difference RR with the threshold value.

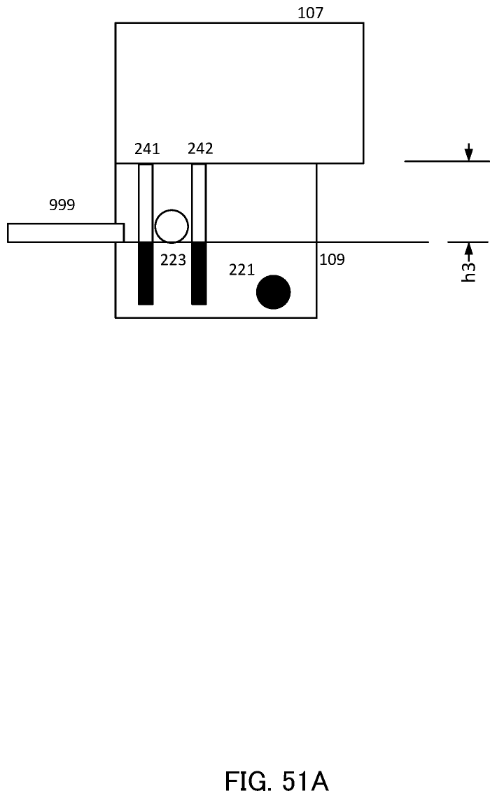

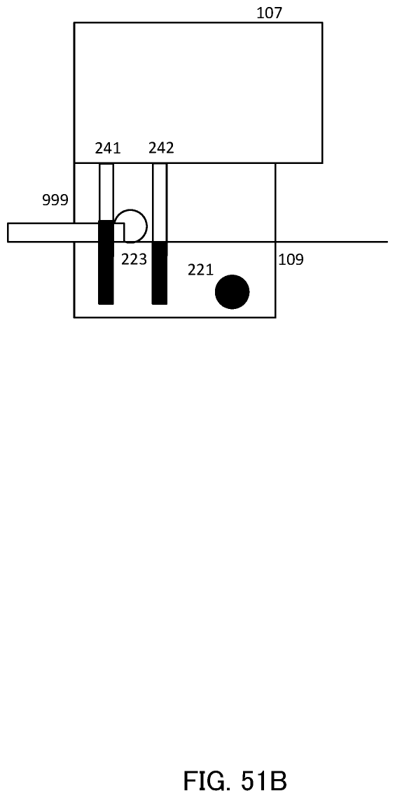

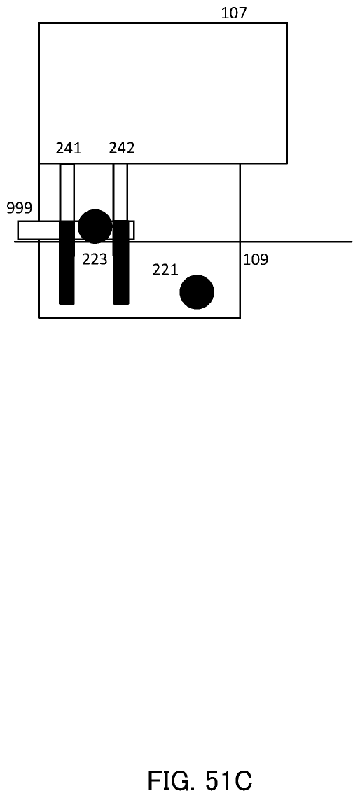

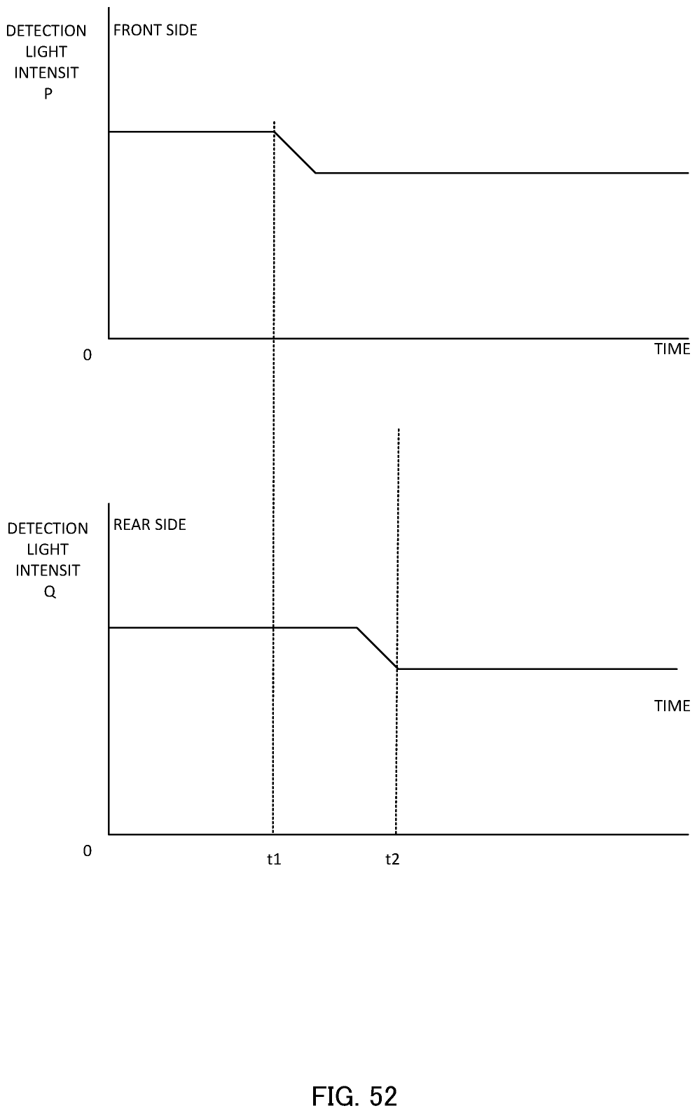

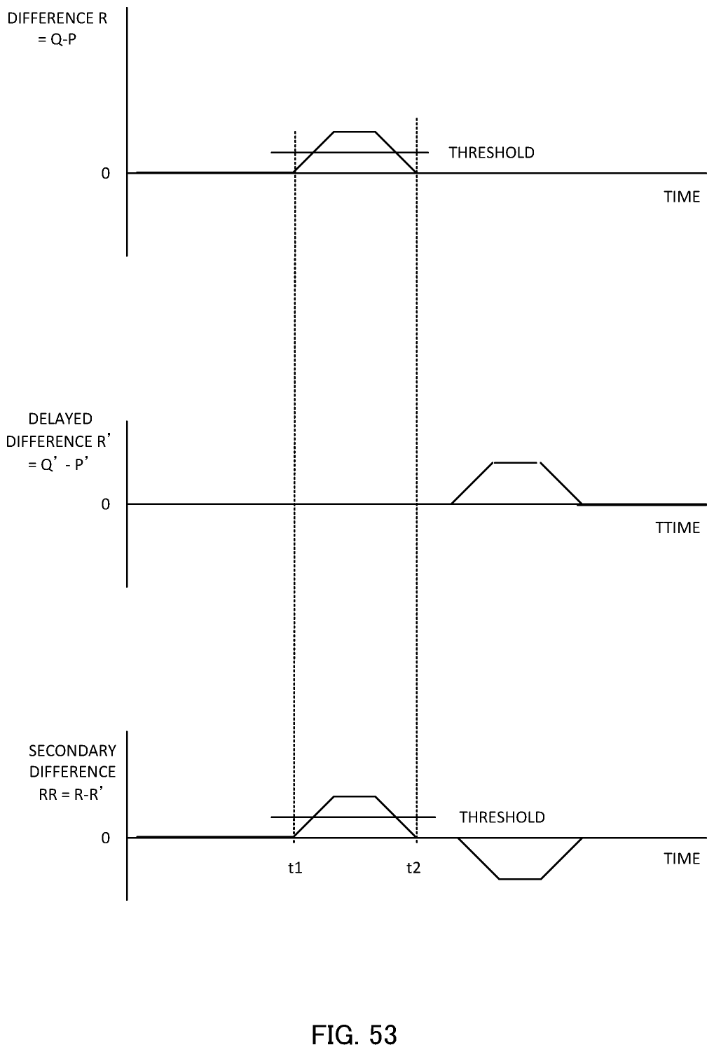

As shown in FIGS. 52 and 53, when a finger enters between the paper stack and a paper stack that is separated from the paper stack by a certain distance and has a flat upper surface (the case of FIG. 43, FIG. 45, or FIG. 51), intrusion of a finger can be detected by comparing the secondary difference RR with a threshold value.

That is, the finger has not intruded before the time t1, and the finger has intruded from the time t1 to the time t2. The secondary difference RR exceeds the threshold from the time t1 to the time t2. Thus, it can be seen that the secondary difference RR has a level that accurately represents the intrusion/non-intrusion of the finger. Therefore, by comparing the secondary difference RR with a threshold value, it is possible to discriminate finger intrusion/non-intrusion.

Therefore, if the secondary difference RR is always compared with the threshold value, it can be detected at the moment when the finger enters.

In other words, according to the ninth embodiment, if the upper surface of the paper stack 103 is flat, the detected light intensity of the line-type direct lower side detection device 241 and the detected light intensity of the line-type direct rear portion detection device 242 are obtained. Based on the difference in the detected light intensity, it is possible to detect whether a finger has entered between the paper stack and the clamp gauge regardless of the distance between the paper stack 103 and the clamp gauge 107. Further, when the intruding finger is detected by the line-type direct lower side detection device 241, the intruding finger is detected regardless of whether the intruding finger is detected by the line-type direct rear portion detection device 242 thereafter. Furthermore, if the inserted object has a height lower than that of the finger, it can be avoided that it is erroneously determined to be the finger.

In addition, according to the ninth embodiment, the detected light intensity of the line-type immediately below front portion detection device 241 and the detected light intensity of the line-type direct rear portion detection device 242 are obtained. Based on the secondary difference in light intensity (the primary difference between the two at the same time instance and the temporal primary difference), it is possible to detect the intruding finger between the paper stack 103 and the clamp gauge 107, regardless of whether the top surface of the paper stack 103 is flat or not, and regardless of the distance between the paper stack 103 and the clamp gauge 107. Further, after the intruding finger is detected by the line-type immediately below front portion detection device 241, the intruding finger can be detected regardless of whether it is detected by the line-type direct rear portion detection device 242. Furthermore, if the inserted object has a height lower than that of the finger, it can be avoided that it is erroneously determined to be the finger. Further, the detection is not affected even if there is a difference in the height of the paper stack 103, i.e., even if the paper stack 103 is wavy or wrinkled. Therefore, it is possible to avoid erroneously determining the paper stack 103 that is wavy or wrinkled as a finger.

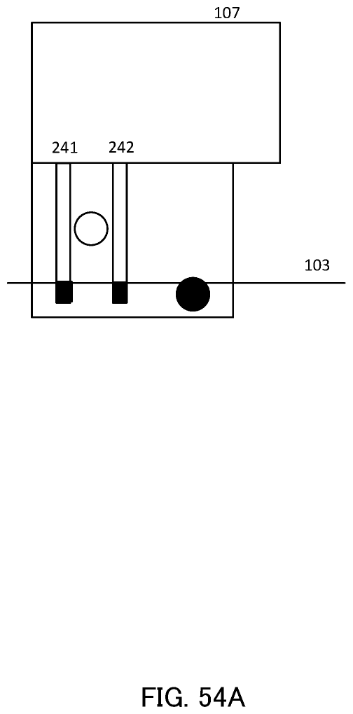

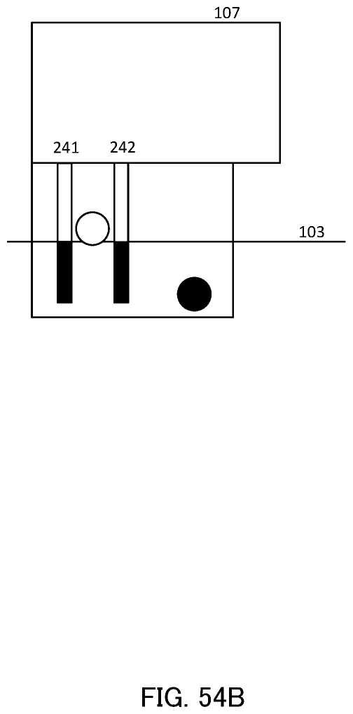

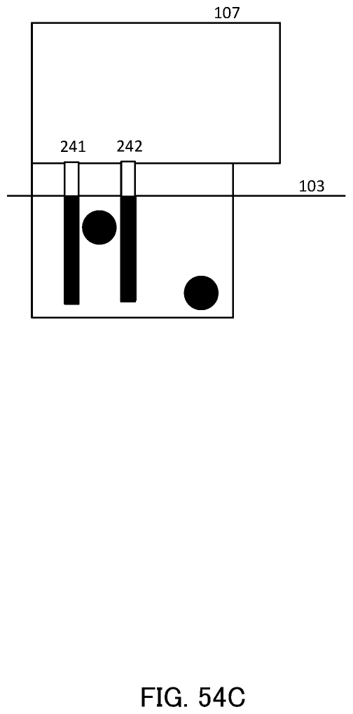

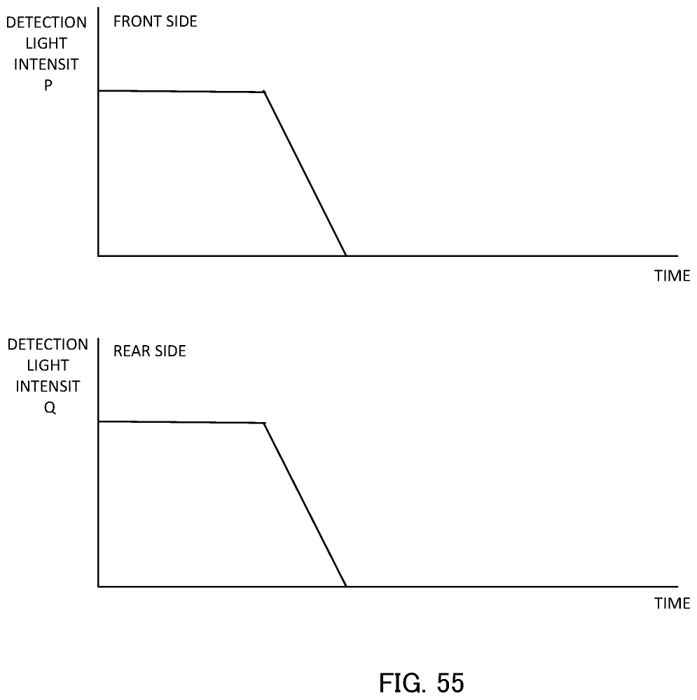

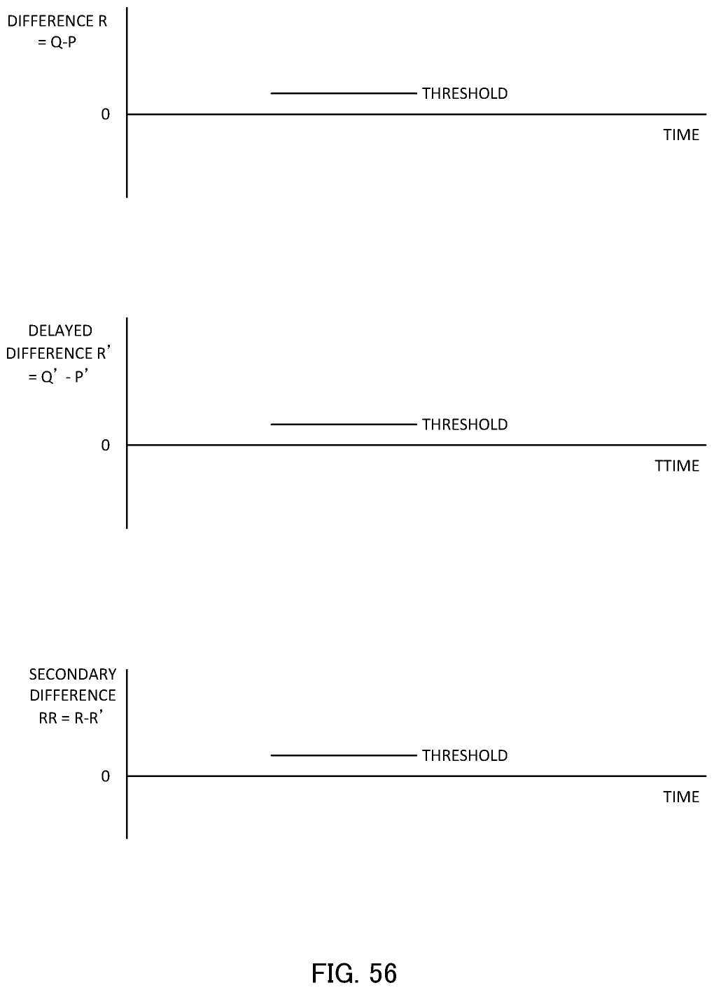

FIG. 54 shows a state in which the clamp gauge 107 is lowered toward the paper stack 103 having a flat upper surface. As shown in FIG. 55, the detected light intensity P of the line-type immediately below front portion detection device 241 and the detected light intensity Q of the line-type direct rear portion detection device 242 change in the same manner. As a result, as shown in FIG. 56, the difference R(=Q−P) between the detected light intensity P and the detected light intensity Q is always zero, so the delay difference R(=Q−P) and the secondary difference RR are also always zero.

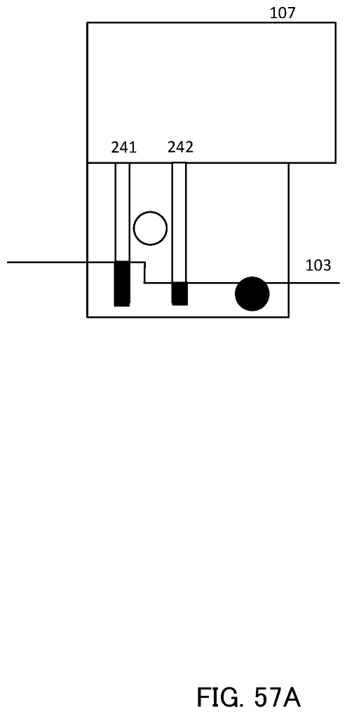

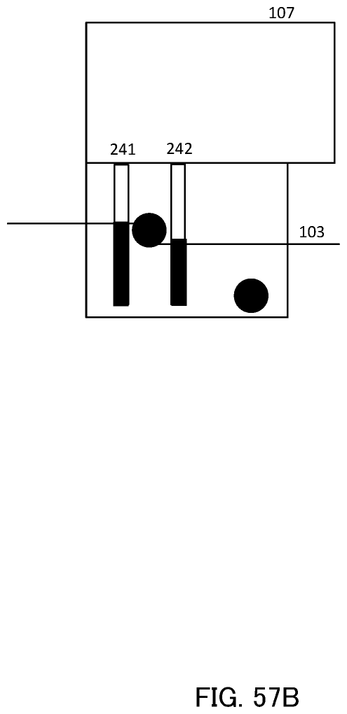

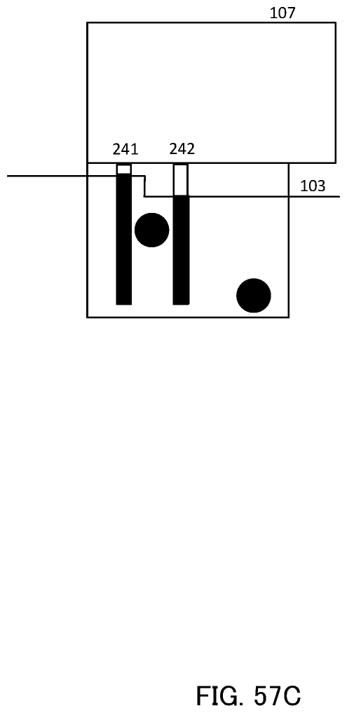

FIG. 57 shows a state in which the clamp gauge 107 descends toward the paper stack 103 where the upper gauge on the front portion is higher than the upper surface on the rear portion.

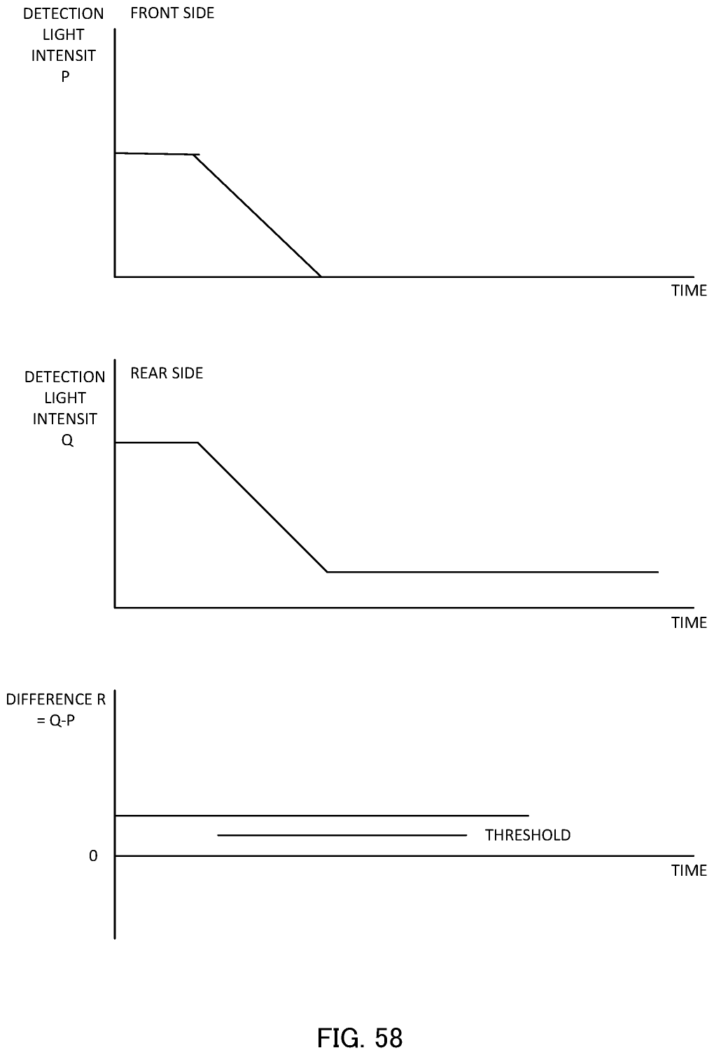

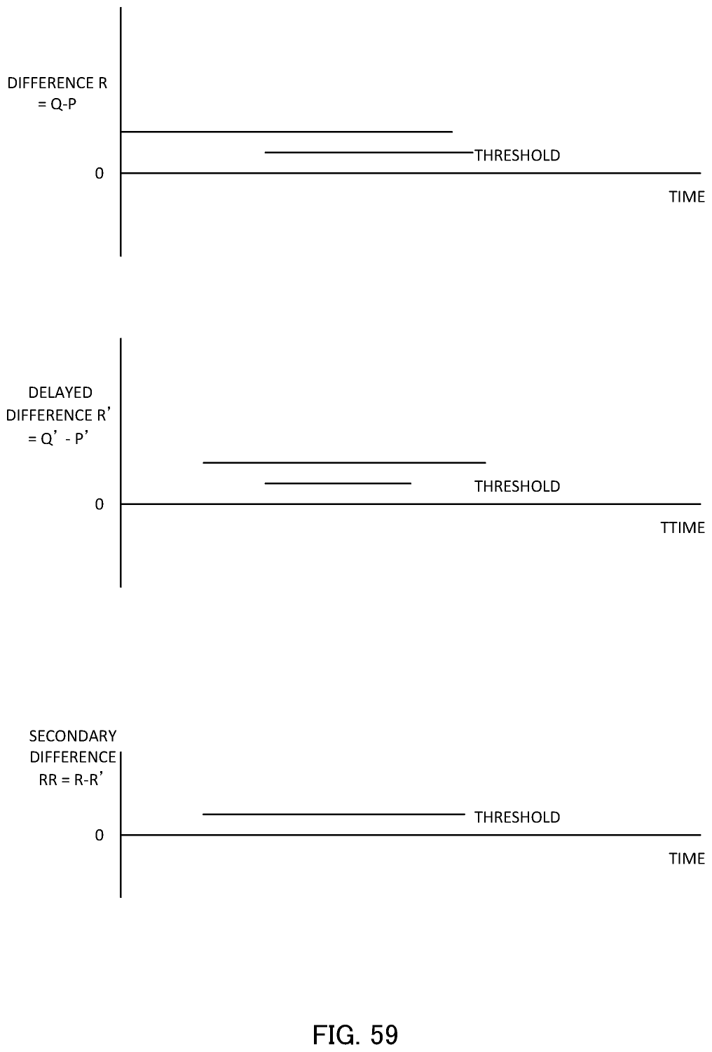

As shown in FIG. 58, in the initial stage, there is a difference between the output level of the line-type immediately below front portion detection device 241 and the output level of the line-type immediately below rear portion detection device 242 depending on the height difference between the flat and rear of the paper stack 103. Thereafter, when the clamp gauge 107 is lowered, the output levels of the line-type immediately below front portion detection device 241 and the line-type immediately below rear portion detection device 242 are lowered while maintaining the difference. Therefore, as shown in FIG. 59, the secondary difference is continuously zero.

Therefore, if it is determined that an intruding object such as a finger has entered in a case where the secondary difference exceeds the threshold value, even if there is a height difference due to undulations between the front and back of the paper stack 103 as shown in FIG. 57, it is possible to avoid mistakenly determining that the height difference is the entry of an intruding object.

Even if a finger remains on a paper stack with a flat upper surface, the detected light intensity P of the line-type immediately below front portion detection device 241, the detected light intensity Q of the line-type direct rear portion detection device 242, the difference R thereof, the delay difference R′ and the secondary difference RR change similarly to the above.

Therefore, if it is determined that an intruding object such as a finger has entered only in a case the secondary difference RR exceeds the threshold value, the finger remaining on paper stack can not be detected. However, there is a history that the finger has intruded from the front to the back before the finger remains on the paper stack, and collision avoidance processing can be performed at that historical time. Therefore, the possibility that the finger cannot be detected can be prevented

Also, if collision avoidance occurs not only when the secondary difference RR exceeds a threshold prepared for comparison with the secondary difference RR but also when the difference R exceeds a threshold prepared for comparison with the difference Rm, then the finger is detected not only when the finger enters the upper surface of the paper stack from the front to the back, but also during the period when the finger is continuously placed on the upper surface of the paper stack.

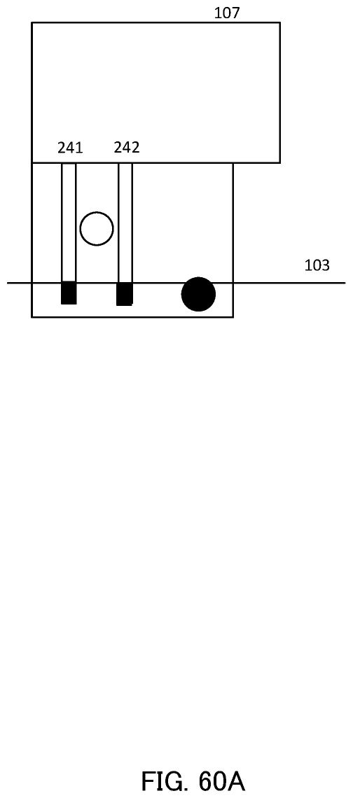

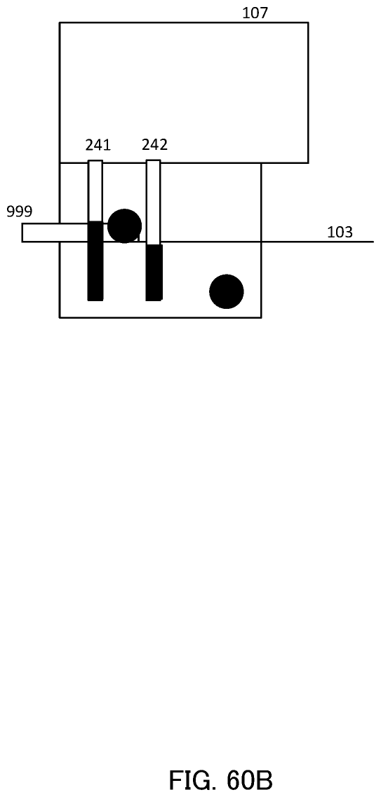

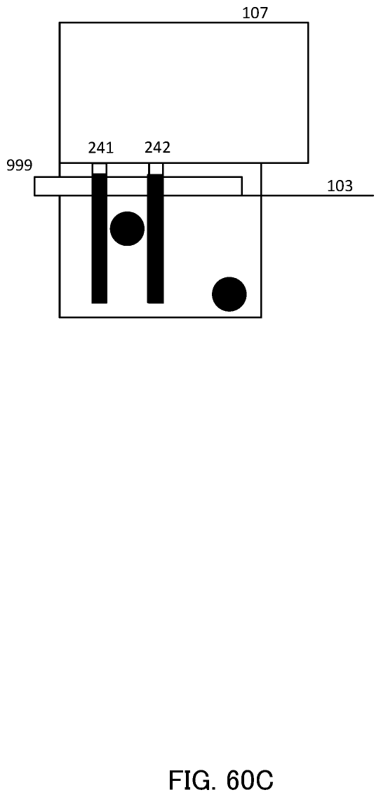

FIG. 60 is a diagram for explaining an operation example when the finger enters between the clamp gauge 107 and the flat paper stack 103 when the clamp gauge 107 is lowered to the flat paper stack 103.

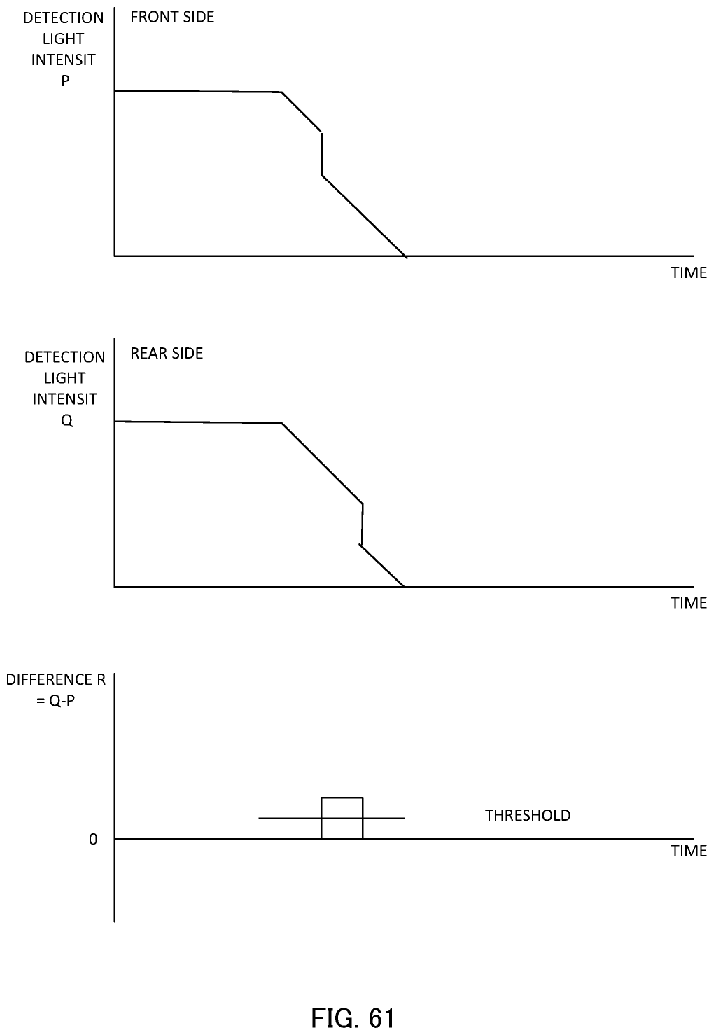

In this case, as shown in FIG. 61, first, the detected light intensity of the line-type immediately below front portion detection device 241 and the detected light intensity of the line-type direct rear portion detection device 242 begin to decrease simultaneously. Than, when a finger enters, first, the detected light intensity of the line-type immediately below front portion detection device 241 decreases stepwise, and after a while, the detected light intensity of the line-type immediately below rear portion detection device 242 decreases stepwise. After the two light intensities decrease stepwise, they decrease at the same decrease rate as before.

Therefore, the difference R between the detected light intensity P of the line-type immediately below front portion detection device 241 and the detected light intensity Q of the line-type immediately below rear portion detection device 242 has a level corresponding to the thickness of the finger in the period sandwiched between the time instances of these stepwise changes.

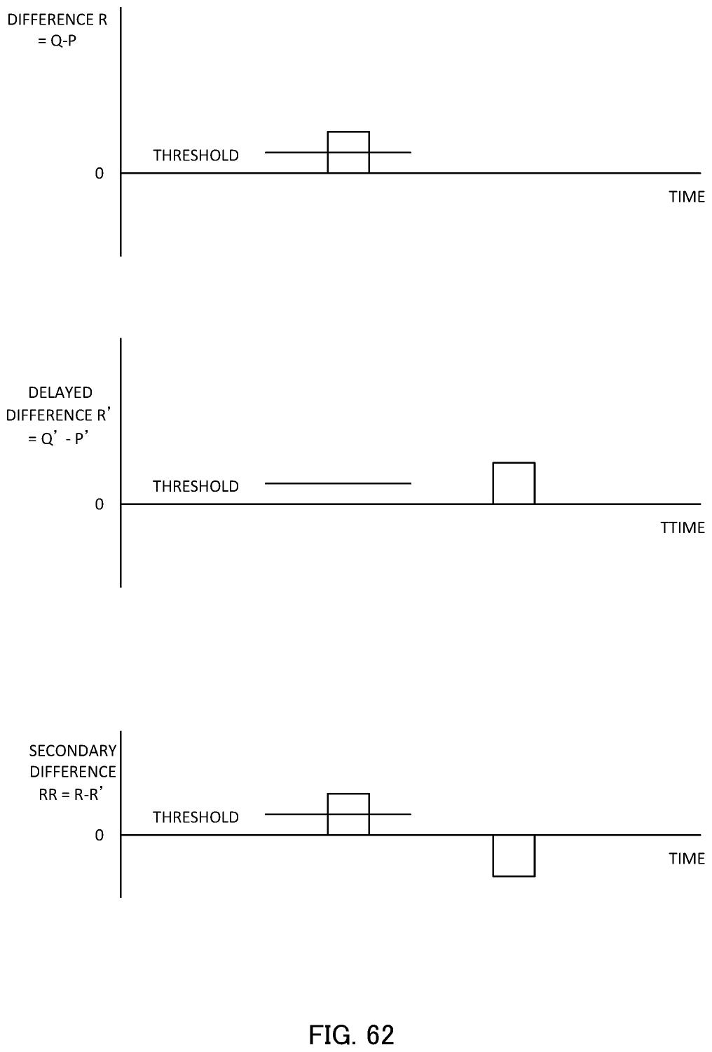

Further, the difference R, the delay difference R and the secondary difference RR are as shown in FIG. 62. As shown in FIG. 62, the secondary difference RR has a level corresponding to the thickness of the finger in a period sandwiched between the times instances of these stepwise changes. Note that the negative level of the secondary difference RR is ignored.

Therefore, in the case shown in FIG. 60, the intrusion of the finger can be detected when the difference R is larger than a threshold value prepared for comparison with the difference R, and when the secondary difference RR is larger than a threshold value prepared for comparison with the secondary difference RR.

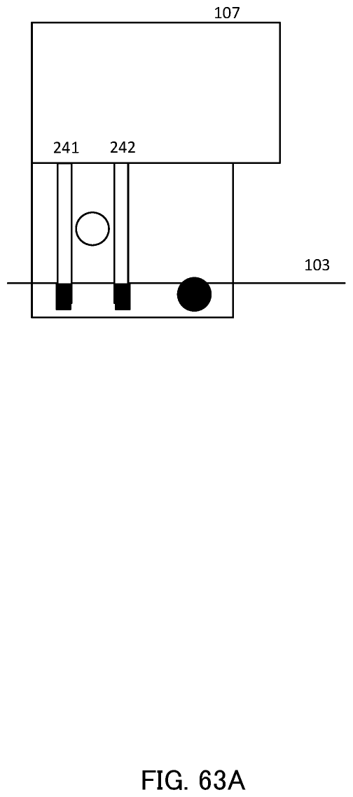

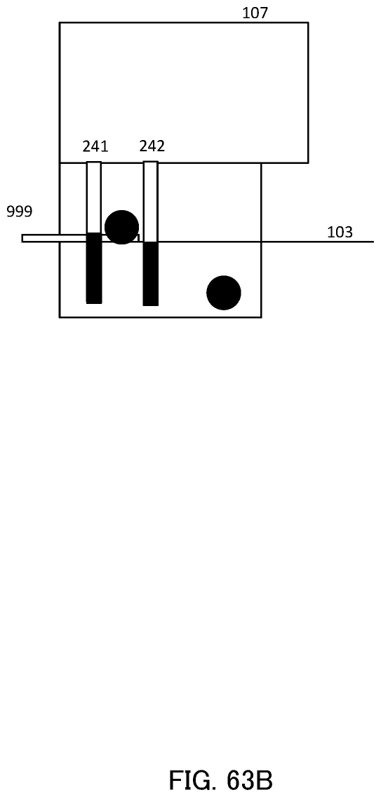

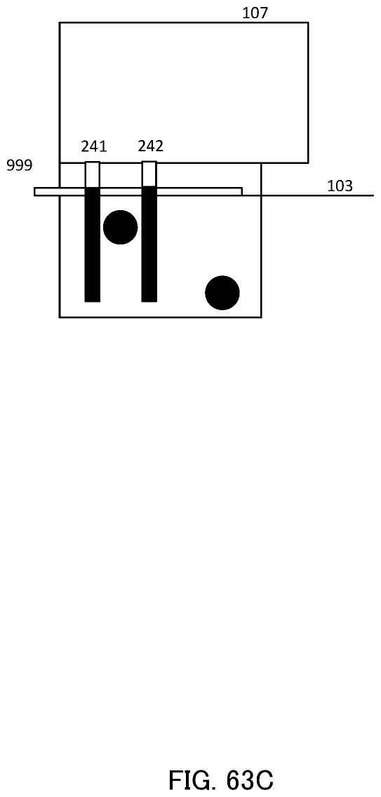

FIG. 63 is a diagram for explaining an operation example when an object having a thickness smaller than that of a finger enters between the clamp gauge 107 and the flat paper stack 103 when the clamp gauge 107 is lowered to the flat paper stack 103.

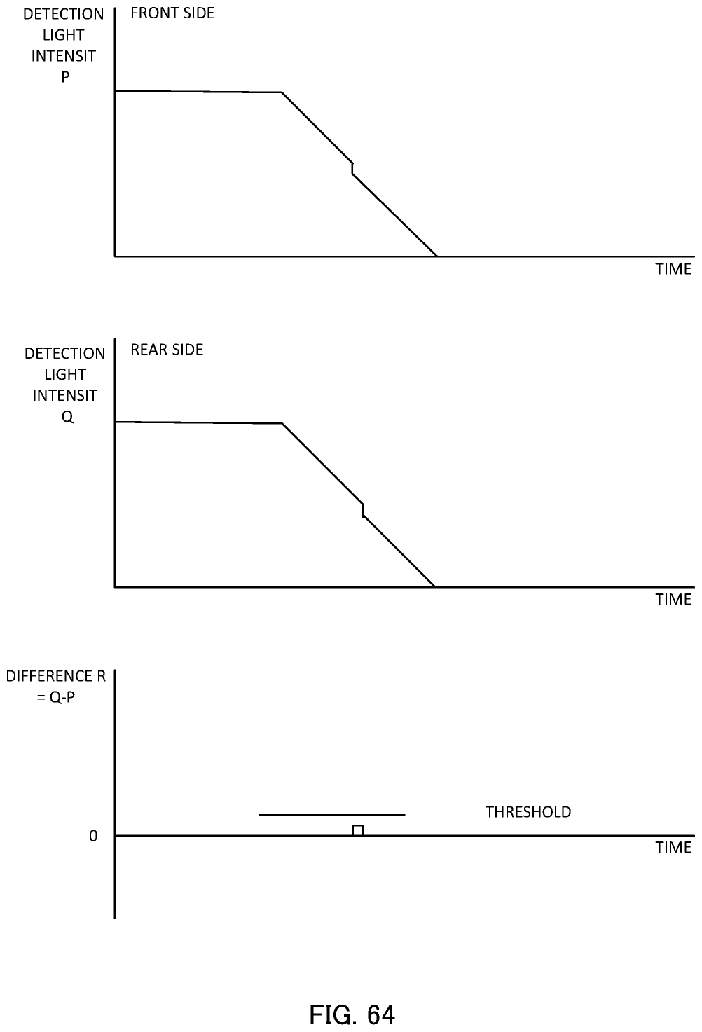

In this case, as shown in FIG. 64, first, the detected light intensity of the line-type immediately below front portion detection device 241 and the detected light intensity of the line-type immediately below rear portion detection device 242 begin to decrease simultaneously. Then, when an object having a thickness smaller than that of the finger enters, first, the detected light intensity of the line-type immediately below front portion detection device 241 decreases stepwise, and after a while, the detected light intensity of the line-type immediately below rear portion detection device 242 decreases stepwise. After the two light intensities decrease stepwise, they decease at the same decrease rate as before.

Therefore, the difference R between the detected light intensity P of the line-type immediately below front portion detection device 241 and the detected light intensity Q of the line-type immediately below rear portion detection device 242 has a level corresponding to the thickness of the object having the thickness smaller than that of the finger in the period sandwiched between the time instances of these stepwise changes.

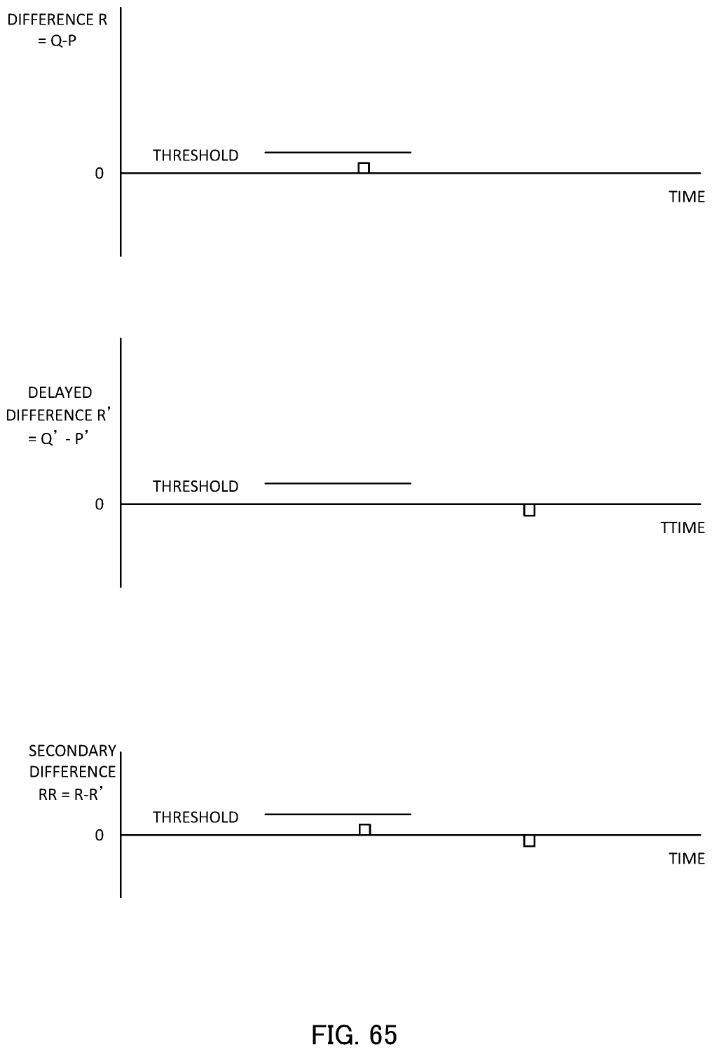

Further, the difference R, the delay difference R′, and the secondary difference RR are as shown in FIG. 65. As shown in FIG. 65, the secondary difference RR has a level corresponding to the thickness of the finger in a period sandwiched between the times instances of these stepwise changes.

Therefore, a threshold value that is a half the thickness of the finger is provided, and if it is determined that there is a finger on the paper stack in a case where the difference R is equal to or greater than the threshold value, and it is determined that there is not a finger an the paper stack otherwise, it is possible to avoid erroneously determining that an object other than the finger is the finger.

Therefore, a threshold value that is a half the thickness of the finger is provided, and if it is determined that there is a finger on the paper stack in a case where the secondary difference RR is equal to or greater than the threshold value, and it is determined that there is not a finger on the paper stack otherwise, it is possible to avoid erroneously determining that an object other than the finger is the finger.

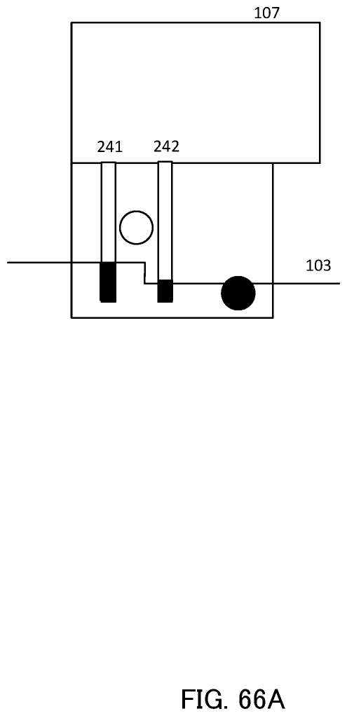

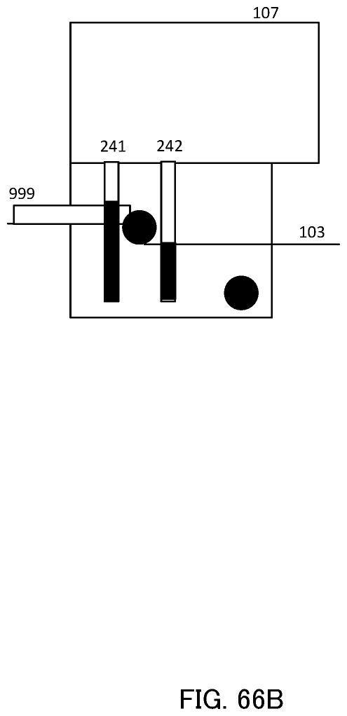

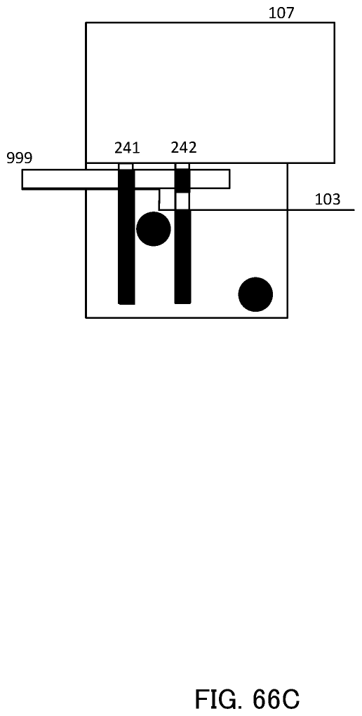

FIG. 66 is a diagram for explaining an operation example when the finger enters between the clamp gauge 107 and the paper stack 103 having a step when the clamp gauge 107 is lowered to the paper stack 103.

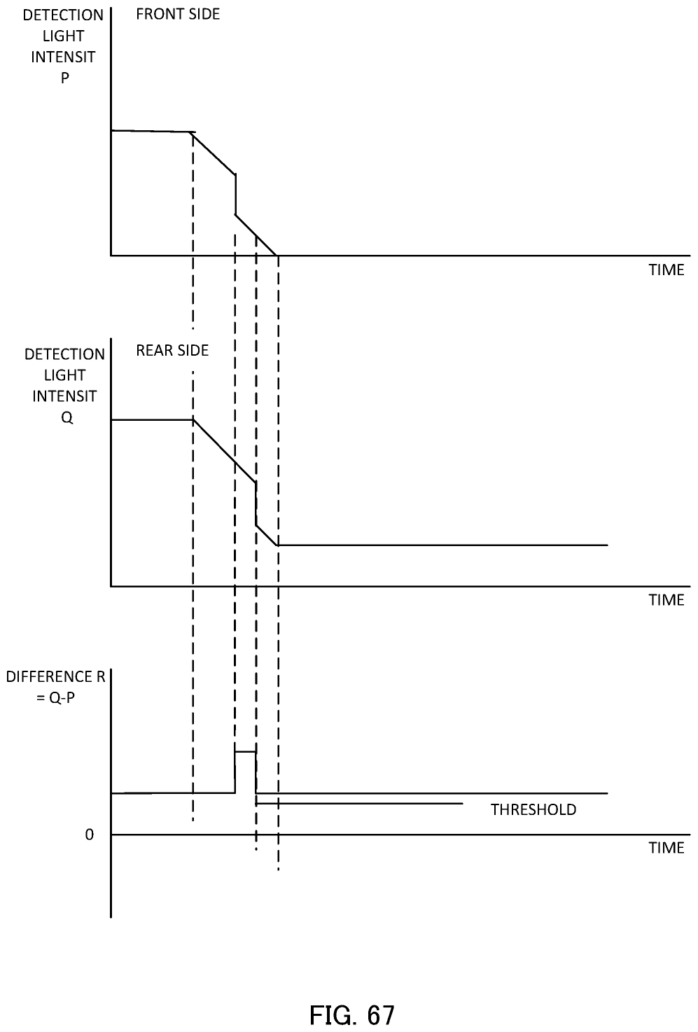

As shown in FIG. 67, in the initial stage, that is a difference between the output level of the line-type immediately below front portion detection device 241 and the output level of the line-type immediately below rear portion detection device 242 according to the height difference between the front and rear of the paper stack 103. Thereafter, when the lowering of the clamp gauge 107 starts, the output level of both the detection devices 241 and 242 starts to decrease while maintaining the difference.

After that, the detected light intensity of the line-type immediately below front portion detection device 241 decreases stepwise by the invading finger, and then the detected light intensity of the line-type immediately below rear portion detection device 242 also decreases stepwise.

The baseline of the difference R is the level corresponding to the difference in height between front and rear of the paper stack 103. In a period sandwiched between the time instances of two stepwise changes, a level corresponding to the thickness of the finger is added to the baseline.

Therefore, if the level of the difference R corresponding to the difference in height between the front and rear of the paper stack 103 is higher than the threshold, the paper stack 103 is erroneously detected as a finger.

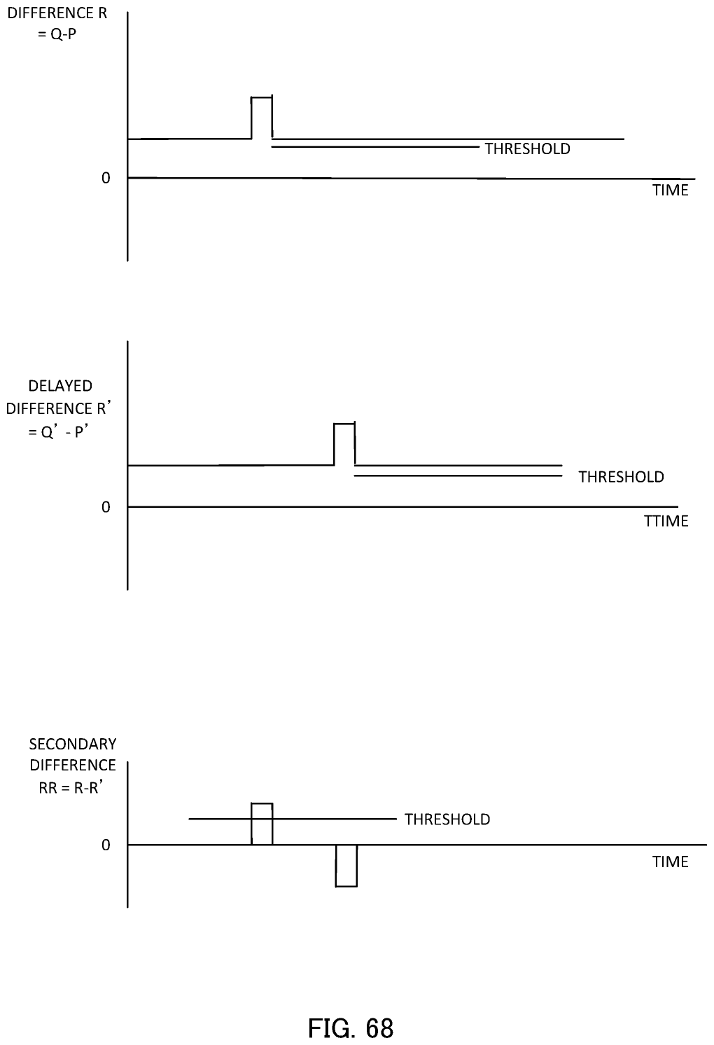

However, since the secondary difference RR is as shown in FIG. 68, the paper stack 103 is not erroneously detected as a finger. Only a finger is corrected as a finger. That is, the baseline of the secondary difference RR is the level of zero. In a period sandwiched between the time instances of two stepwise changes, the secondary difference RR has a level corresponding to only the thickness of the finger. Therefore, only a finger is detected as a finger.

Therefore, in setting the threshold value, it is not necessary to consider the trade-off between the finger thickness and the paper undulation, and the threshold value can be set considering only the finger thickness.

Moreover, even if the height difference of the undulation of the paper is larger than the thickness of the finger, only the finger can be detected.

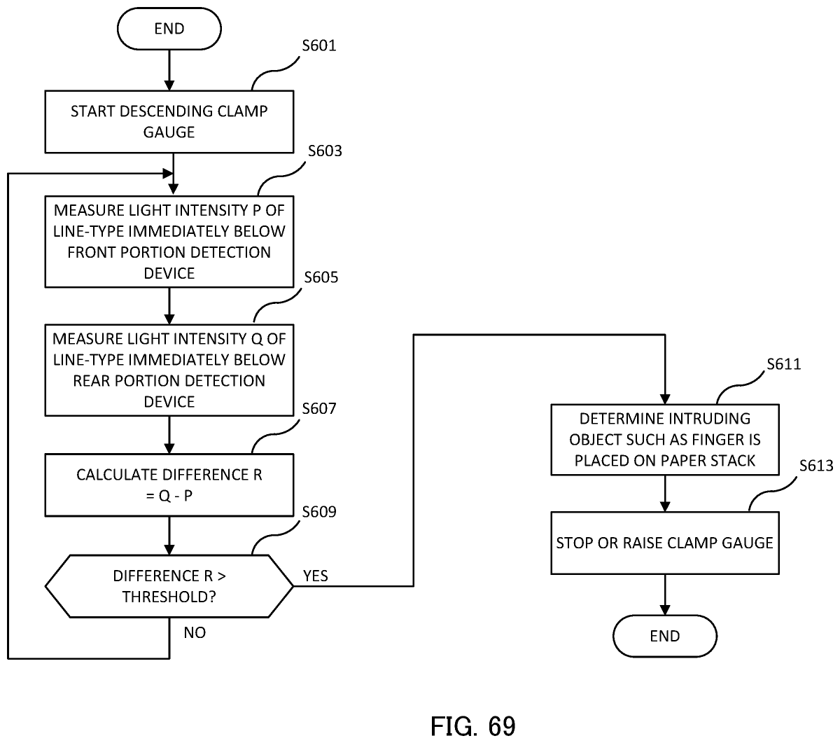

Next, the operation of the clamp gauge control device according to the present embodiment will be described with reference to FIG. 69.

First, the clamp gauge 107 starts to descend (step S601).

Next, the detected light intensity P of the line-type immediately below front portion detection device 241 is measured (step S603).

Next, the detected light intensity Q of the line-type immediately below rear portion detection device 242 is measured (step S605).

Next, the difference R=Q−P is calculated (step S607).

Next, if the difference R is larger than the threshold value (YES in step S609), it is determined that an intruding object such as a finger is placed on the paper stack 103 (step S611), and a clamp gauge 107 is stopped or raised as a collision avoidance process (step S613).

If the difference R is lees than the threshold value (NO in step S609), the process returns to step S603.

If it is intended that an intruding object such as a finger is detected from the secondary difference RR, in step S609, the secondary difference RR is compared with the threshold instead of comparing the difference R with the threshold. The secondary difference RR is calculated based on the difference R in the current loop and the difference R′ in the previous loop.

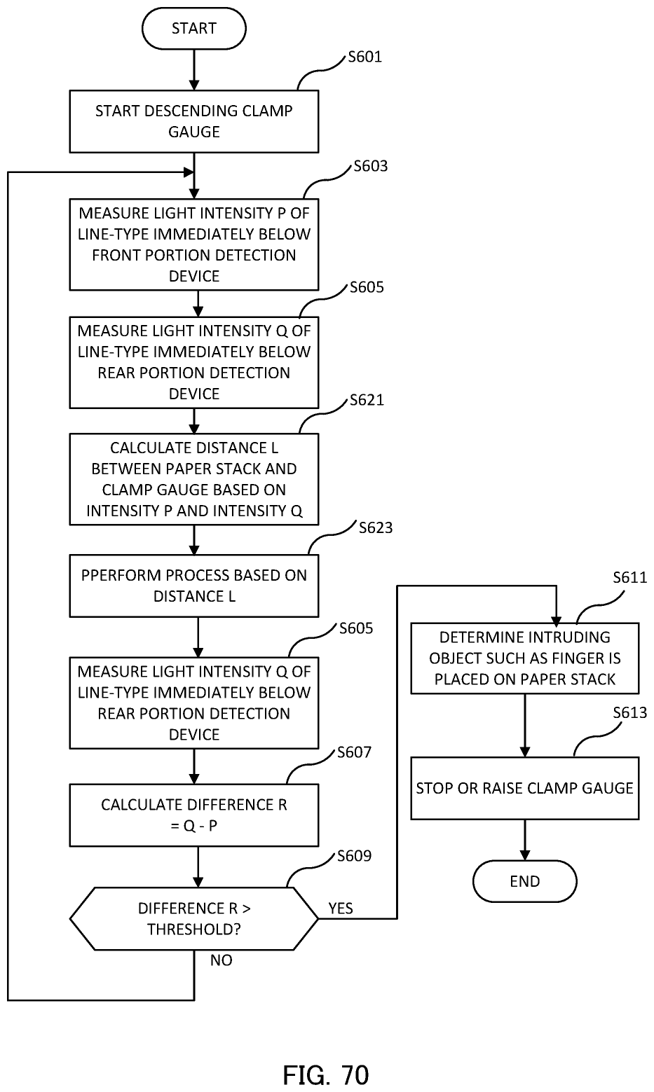

Next, the operation of the clamp gauge control device according to the present embodiment will be described with reference to FIG. 70.

First, the clamp gauge 107 starts to descend (step S601).

Next, the detected light intensity P of the line-type immediately below front portion detection device 241 is measured (step S603).

Next, the detected light intensity Q of the line-type below rear portion detection device 242 is measured (step S605).

Next, a distance L between the paper stack 103 and the clamp gauge 107 is calculated based on either one or both of the detected light intensity P and the detected light intensity Q (S621).

Next, processing based on the distance L is executed (S621).

Next, the difference R=Q−P is calculated (step S607).

Next, if the difference R is larger than the threshold value (YES in step S609), it is determined that an intruding object such as a finger is placed on the paper stack 103 (step S611), and a clamp gauge 107 is stopped or raised as a collision avoidance process (step S613).

If the difference R is less than the threshold value (NO in step S609), the process returns to step S603.

If it is intended that an intruding object such as a finger is detected from the secondary difference RR, in step S609, the secondary difference RR is compared with the threshold instead of comparing the difference R with the threshold. The secondary difference RR is calculated based on the difference R in the current loop and the difference R′ in the pervious loop.

Here, step S621 described above will be described.

It is assumed that the distance from the clamp gauge 107 to the line-type immediately below front portion detection device 241 is H1, the height of the line-type immediately below front portion detection device 241 is H2, the maximum received light intensity of the front portion detection device 241 is Jmax, and the current received light intensity of the line-type immediately below front portion detection device 241 immediately below the mold is J. The distance L between the paper stack 103 and the clamp gauge 107 is as shown in FIG. 40 and expressed as follows:

### (A) If J=Jmax,

L≥H1+H2

### (B) If 0<J<Jmax,

L=H1+H2×J/J max

### (C) If J=0,

0≤L≤H1.

The same applies to the line-type immediately below rear portion detection device 242.

Accordingly, it is possible to calculate the distance between the paper stack and the clamp gauge based only on the detected light intensity of the line-type immediately below front portion detection device 241, only on the detected light in of the line-type immediately below rear portion detection device 242, or on both of them. Any calculation values (for example, average, minimum value, maximum value) based on both calculation results may be used as the final distance.

Next, step S623 in the above will be described.

For example, the distance Hs and the distance He

H1+H2>Hs>He>H1

If the distance L is within the range from the distance Hs to the distance He, the descending velocity of the clamp gauge 107 may be lower than the descending velocity when it is in other ranges. If the distance L is in the range from the distance Hs to zero, the descending velocity of the clamp gauge may be lower than the descending velocity when it is in other ranges.

Also, a specific process may be executed when the distance L is a specific value. A specific process may be executed when the distance L is in a specific range. A specific process may be executed based on the distance L acquired in time series.

The method shown in FIGS. 69 and 70 is not executed only in the period in which the clamp gauge is lowered for the first time. For example, the method continues to be executed even during a period in which the clamp gauge is moved up and down by an operation by the user before reaching the paper stack or during a period in which the clamp gauge is temporarily stopped by an operation by the user before reaching. Therefore, even if a finger or the like enters between the paper stack 103 and the clamp gauge 107 during such a period, the process can proceed to step S613 to stop or raise the clamp gauge.

According to the configuration according to the ninth embodiment, the following can be performed by using the line-type immediately below front portion detection device 241 and the line-type immediately below rear portion detection device 242.

By using the difference between the output level of the line-type immediately below front portion detection device 241 and the output level of the line-type immediately below rear portion detection device 242,
the finger inserted between the paper stack 103 and the clamp gauge 107 can be detected regardless of the height of the clamp gauge 107,
even if there is a height difference between the front and rear of the paper stack 103, the finger inserted between the paper stack 103 and the clamp gauge 107 can be detected, and
even if the clamp gauge 107 is stationary, rising or falling (that is, even if the height of the clamp gauge 107 fluctuates), a finger inserted between the paper stack 103 and the clamp gauge 107 can be detected.

In addition, by using the temporal change in the difference between the output level of the line-type immediately below front portion detection device 241 and the output level of the line-type immediately below rear portion detection device 242,
a finger entering between the paper stack 103 and the clamp gauge 107 can be detected regardless of the height of the clamp gauge 107,
even if there is a difference in height between the front and rear of the paper stack 103, it is possible to detect a finger entering between the paper stack 103 and the clamp gauge 107,
even if the clamp gauge 107 is stationary, rising or falling (that is, even if the height of the clamp gauge 107 fluctuates), a finger entering between 103 and the clamp gauge 107 can be detected, and
it is possible to avoid erroneously detecting the paper stack 103 having a height difference as a finger.

Note that the secondary difference is based on the detected light intensity P(t) of the line-type immediately below front portion detection device 241 and the detected light intensity R(t) of the line-type immediately below rear portion detection device 242. That is,

Difference R(t)=Q(t)−P(t)

Difference R(t)=Q′(t)−P′(t)Q(t−ΔT)−P(t−ΔT)

Secondary difference RR(t)=R′(t)−R(t)

here,
ΔT is the predetermined delay time
   However, instead of the detected light intensity Q(t), a numerical value Q2(t)(=α·H(t)) obtained by multiplying the measured value H(t) of the height of the clamp gauge 107 by multiplying the normalization coefficient α may be used. That is,

Difference R(t)=Q2(t)−P(t)

Difference R′(t)=Q2′(t)−P′(t)=Q2(t−ΔT)−P(t−ΔT)

Secondary difference RR(t)=R′(t)−R(t)

here,
ΔT is the predetermined delay time

### Tenth Embodiment

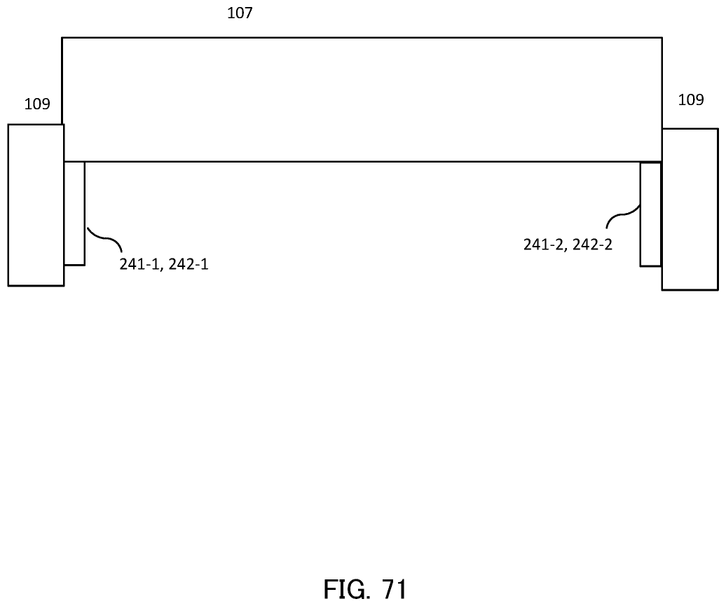

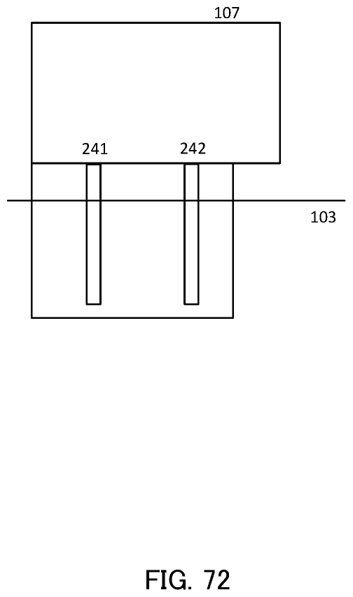

In the tenth embodiment, as shown in FIG. 71 and FIG. 72, the line-type immediately lower front portion detection device 241 and the line-type immediately lower rear portion detection device 242 are arranged. Note that the preceding detection device 221 and the main detection device 223 are not arranged.

Further, in this embodiment, it is not necessary to detect the height of the clamp gauge 107. Therefore, the wire 811, the rotary encoder 813, and the motion detection device 815 are not provided.

Both of the line-type immediately lower front portion detection device 241 and the line-type immediately lower rear portion detection device 242 start from a position directly below the clamp gauge 107 in the height direction and end at a position that is a predetermined distance downward therefrom. The range is the detection range.

, in the depth direction, the line-type immediately lower front portion detection device 241 is disposed on the front portion of the line-type immediately lower rear portion detection device 242.

In order to protect a finger or the like that has just reached the front edge of the clamp gauge 107, it is preferred that the line-type direct lower front portion detection device 241 is disposed as close as possible to the front edge of the clamp gauge 107 in the depth direction. If a finger or the like that is about to enter under the clamp gauge 107 is to be detected before reaching the front edge of the clamp gauge 107, it is preferable to arrange the line-type immediately lower front portion detection device 241 in the depth direction in the front portion of the flat edge of the clamp gauge 107 so that the detection range of the line-type immediately lower from portion detection device 241 includes the front portion of the front edge of the clamp gauge 107.

In addition, as the position in the depth direction of the line-type immediately lower rear portion detection device 242, it is preferable to select a position as far back as possible so that the detection range is an area where the operator's finger is less likely to enter.

According to the configuration according to the tenth embodiment, as in the configuration according to the ninth embodiment, the following can be preformed by using the line-type immediately lower front portion detection device 241 and the line-type immediately lower rear portion detection device 222.

By using the difference between the output level of the line-type immediately lower front portion detection device 241 and the output level of the line-type immediately lower rear portion detection device 242,
the finger inserted between the paper stack 103 and the clamp gauge 107 can be detected regardless of the height of the clamp gauge 107,
even if there is a height difference between the front and rear of the paper stack 103, the finger inserted between the paper stack 103 and the clamp gauge 107 can be detected, and
even if the clamp gauge 107 is stationary, rising or idling (that is, even if the height of the clamp gauge 107 fluctuates), a finger inserted between the paper stack 103 and the clamp gauge 107 can be detected.

In addition, by using the temporal change in the difference between the output level of the line-type immediately lower front portion detection device 241 and the output level of the line-type immediately lower rear portion detection device 242.
a finger entering between the paper stack 103 and the clamp gauge 107 can be detected regardless of the height of the clamp gauge 107,
even if there is a difference in height between the front and rear of the paper stack 103, it is possible to detect a finger entering between the paper stack 103 and the clamp gauge 107,
even if the clamp gauge 107 is stationary, rising or filling (that is, even if the height of the clamp gauge 107 fluctuates), a finger entering between the paper stack 103 and the clamp gauge 107 can be detected, and
it is possible to avoid erroneously detecting the paper stack 103 having a height difference as a finger.

### Eleventh Embodiment

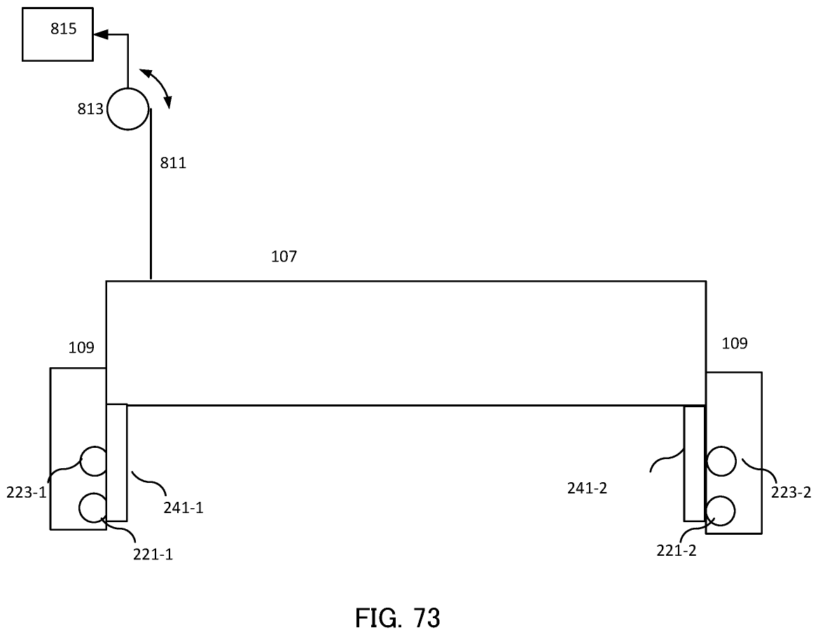

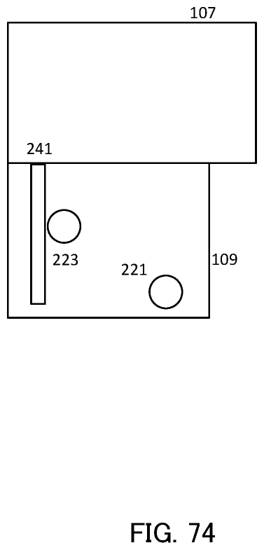

In the eleventh embodiment, as shown in FIGS. 73 and 74, in addition to the preceding detection device 221 and the main detection device 223, the line-type direct lower front portion detection device 241 is arranged. The line-type immediately lower rear portion detection device 242 in the ninth embodiment is omitted.

In the eleventh embodiment, first, the clamp gauge 107 is lowered, and the height of the clamp gauge detected by the height detection device when the line-type direct lower front portion detection device 241 detects the paper stack 103 is initially set as height H0. As the height detection device, a wire 811, a rotary encoder 813, and a motion detection device 815 is shown in FIG. 73 are used, but other devices may be used.

Further, if the line-type direct lower front portion detection device 241 has detected the paper stack from the start of the operation, the height of the clamp gauge detected by the height detection device is determined by the line-type direct lower front portion detection device 241. The initial height H0 is recorded corresponding to the detection level.

The detection level of the line-type direct lower front portion detection device 241 is proportional to the height in the effective region. That is, the detection level E is

E=E max×H/H max

Here, Hmax is the height of the line-type direct lower front portion detection device 241, and H is the detection height when the lower end of the line-type direct lower front portion detection device 241 is used as a reference. Therefore,

H=H max×E/E max

That is, the height of the clamp gauge can be obtained based en the detection level E of the line-type direct lower front portion detection device 241.

Therefore, the height of the upper surface of the paper stack or the height of the upper surface of the finger placed on the upper surface of the paper stack detected by the line-type direct lower front portion detection device 241 (based on the lower end of the line-type direct lower front portion detection device 241)) is represented by A and the height of the clamp gauge detected by the height detection device is represented by B. It can be determined whether or not a finger is placed on the upper surface of the paper stack based on these temporal changes of A and B.

When A and B at a certain time are set as A1 and B1, and A and B at a time after a while are set as A2 and B2, C as defined as

$$C \\ = Δ A + Δ B \\ = ( A 2 - A 1 ) + ( B 2 - B 1 ) .$$

If C exceeds the threshold value TH (for example, half the height of the finger), it can be determined that the finger is placed on the paper stack.

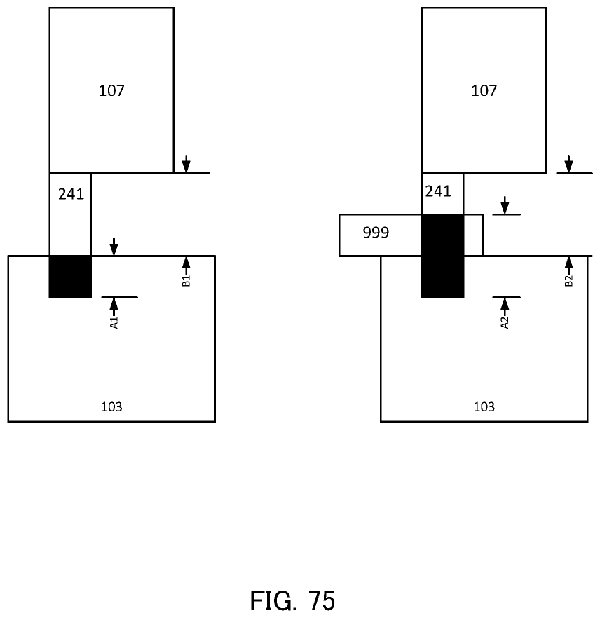

This will be described with reference to FIGS. 75 to 79.

FIG. 75 shows a case where a finger is inserted while the clamp gauge is stationary.

$$\begin{matrix}C = Δ A + Δ B \\ = F > TH\end{matrix}$$

here,
F is finger height
   Therefore, it is possible to detect that a finger has been inserted.

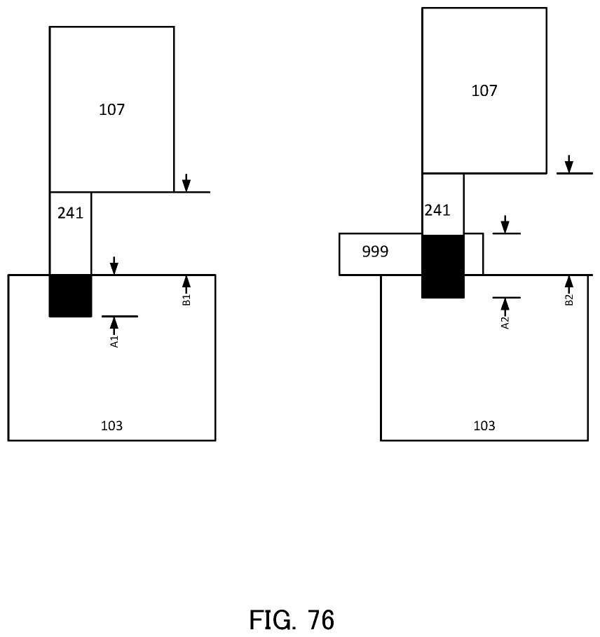

FIG. 76 shows a case where a finger is inserted while the clamp gauge is raised.

$$\begin{matrix}C = Δ A + Δ B \\ = ( F - Δ H ) + Δ H \\ = F > TH\end{matrix}$$

here,
F is finger height
   Therefore, it is possible to detect that a finger has been inserted.

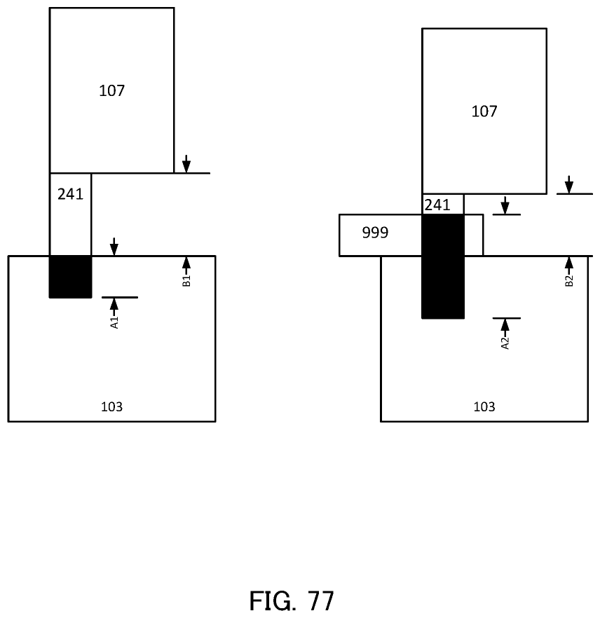

FIG. 77 shows a case where a finger is inserted while the clamp gauge is lowered.

$$\begin{matrix}C = Δ A + Δ B \\ = ( F + Δ H ) - Δ H \\ = F > TH\end{matrix}$$

here,

F is finger height

Therefore, it is possible to detect that a finger has been inserted.

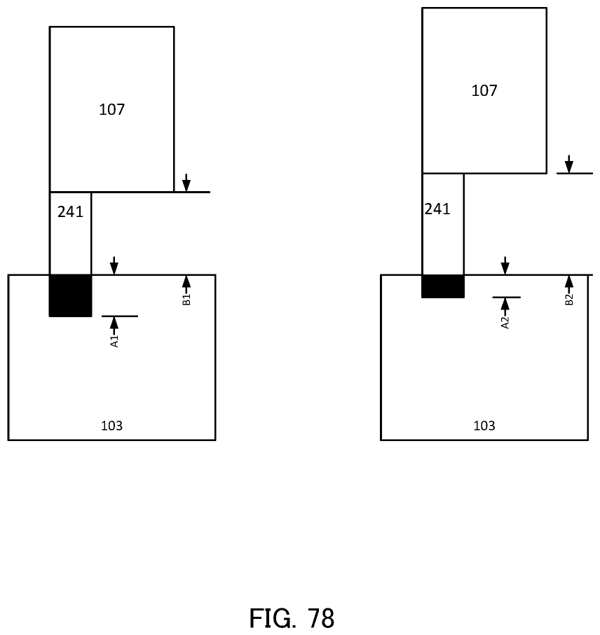

FIG. 78 shows the case where nothing is inserted while the clamp gauge is raised.

$$\begin{matrix}C = Δ A + Δ B \\ = - Δ H + Δ H \\ = 0 < TH\end{matrix}$$

Therefore, it can be determined that nothing has been inserted.

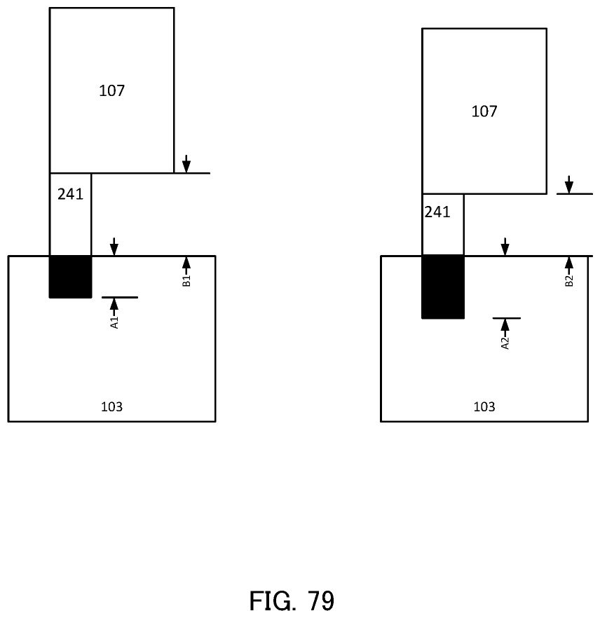

FIG. 79 shows the case where nothing is inserted while the clamp gauge is lowered.

$$\begin{matrix}C = Δ A + Δ B \\ = Δ H - Δ H \\ = 0 < TH\end{matrix}$$

Therefore, it can be determined that nothing has been inserted.

### Twelfth Embodiment

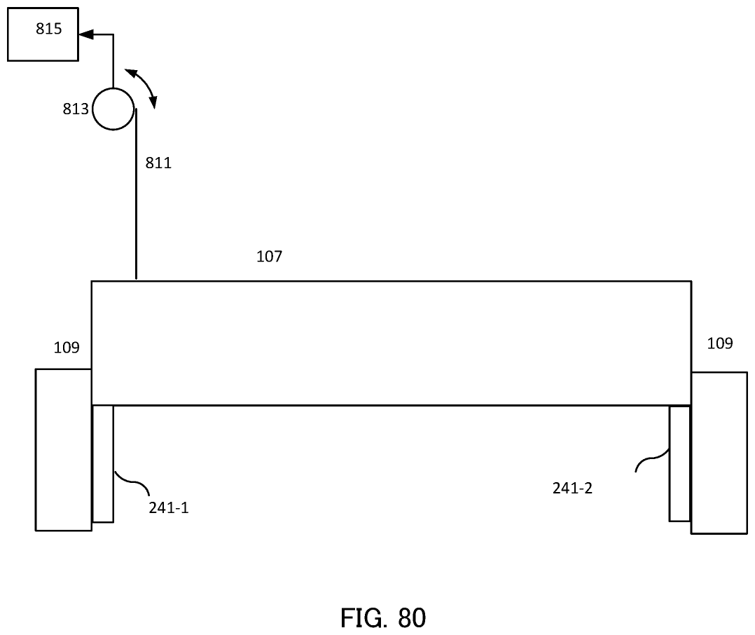

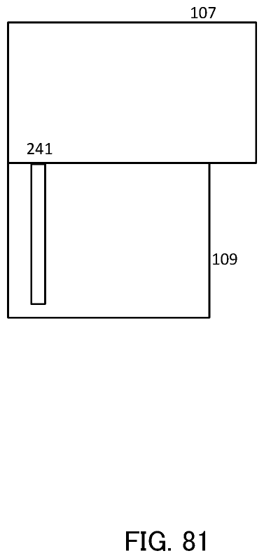

Therefore, if only the detection according to the principle of the eleventh embodiment needs to be performed, the preceding detection device 221 and the main detection device 223 are deleted as shown in FIGS. 80 and 81. It is only necessary to arrange the line-type direct lower front portion detection device 241 and provide a height detection device including, for example, the wire 811, the rotary encoder 813, and the motion detection device 815.

### Thirteenth Embodiment

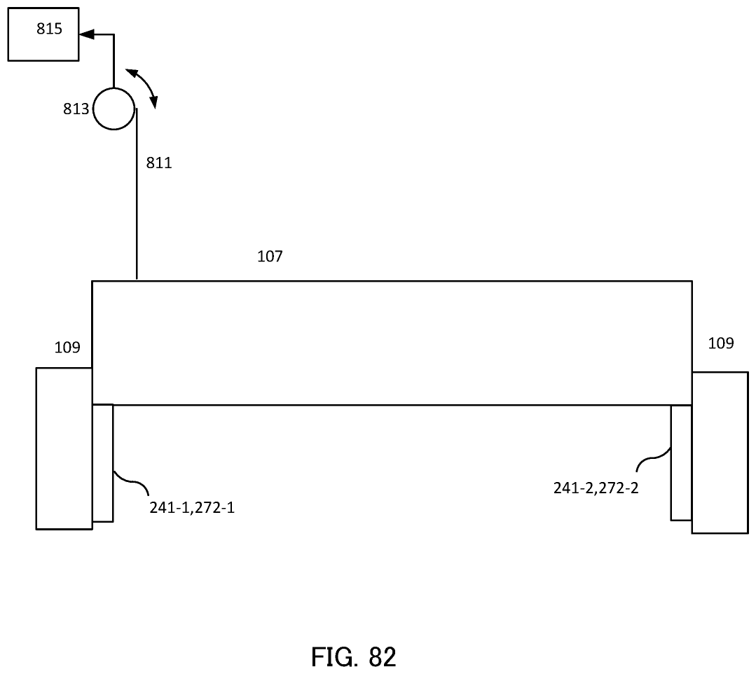

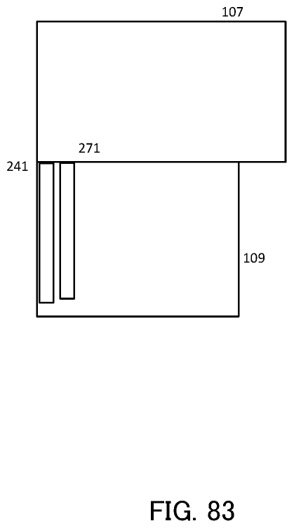

As shown in FIGS. 82 and 83, in the thirteenth embodiment, the first line-type immediately lower front portion detection device 241 and the second line-type immediately lower front portion detection device 271 are arranged as detection devices. The height detection device can be omitted.

The height of the upper surface of the paper stack or the height of the upper surface of the finger placed on the upper surface of the paper stack detected by the first line-type direct lower front portion detection device 241 (when the lower end of the line-type immediately lower front portion detection device 241 is regarded as a reference height) is represented by A. The height of the clamp gauge detected by the second line-type immediately lower front portion detection device 271 is represented by E Whether or not a finger is placed on the upper surface of the paper stack can be determined on the basis of temporal changes of A and E.

A and E at a certain time are represented by A1 and E1, and A and E at a time after that time are represented by A2 and E2. G is defined by

$$\begin{matrix}G = Δ A + Δ E \\ = ( A 2 - A 1 ) + ( E 2 - E 1 )\end{matrix}$$

If G exceeds a threshold value TH (for example, a dimension half the height of the finger), it can be determined that the finger has entered between the paper stack and the clamp gauge.

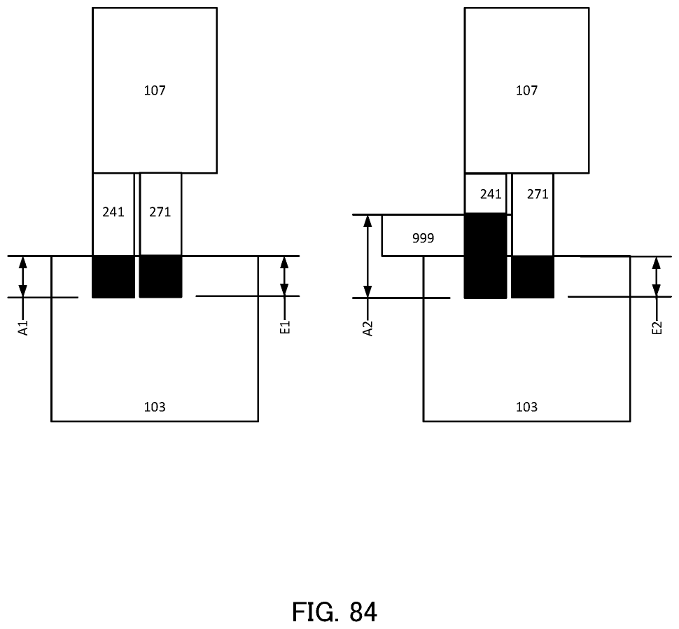

This will be described with reference to FIGS. 84 to 88.

FIG. 84 shows a case where a finger is inserted while the clamp gauge is stationary.

$$\begin{matrix}G = Δ A + Δ E \\ = Δ A \\ = F > TH\end{matrix}$$

here,
F is finger height
   Therefore, it is possible to detect that a finger has been inserted.

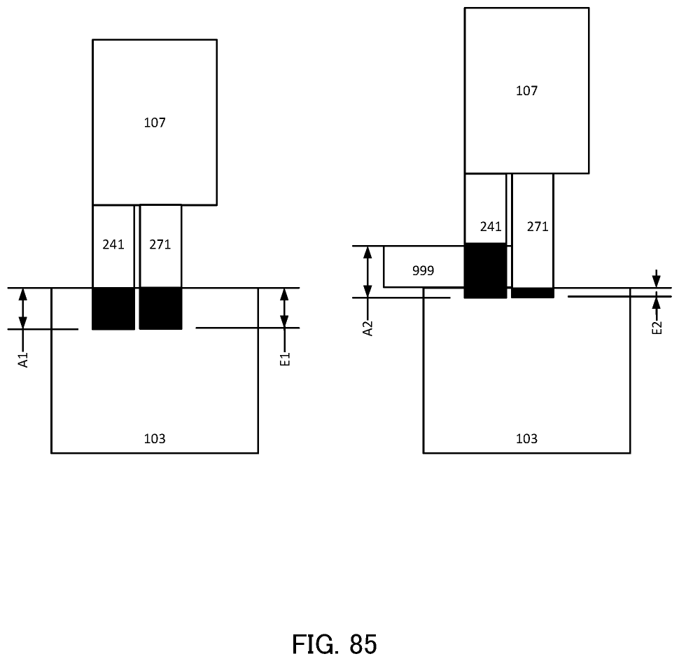

FIG. 85 shows a case where a finger is inserted while the clamp gauge is raised by ΔH.

$$\begin{matrix}G = Δ A + Δ E \\ = ( F - Δ H ) + Δ H \\ = F > TH\end{matrix}$$

here,
F is finger height
   Therefore, it is possible to detect that a finger has been inserted.

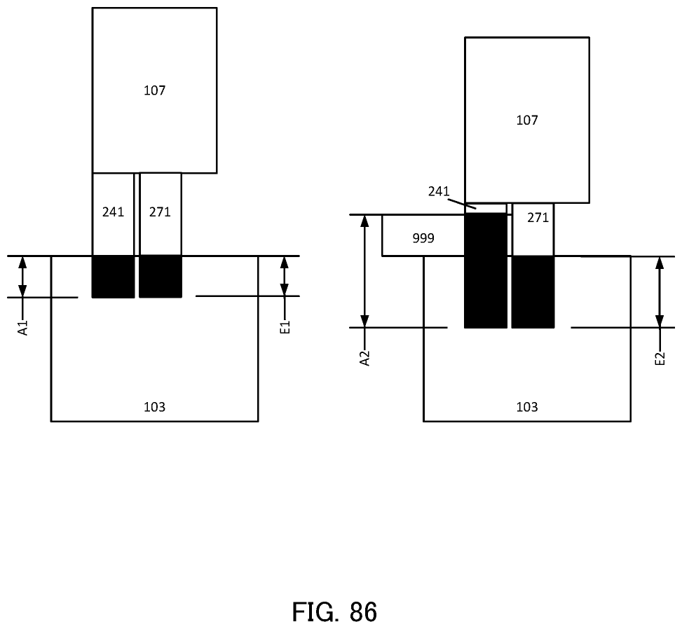

FIG. 86 shows a case where a finger is inserted while the clamp gauge is lowered by ΔH.

$$\begin{matrix}G = Δ A + Δ E \\ = ( F + Δ H ) - Δ H \\ = F > TH\end{matrix}$$

here,
F is finger height
   Therefore, it is possible to detect that a finger has been inserted.

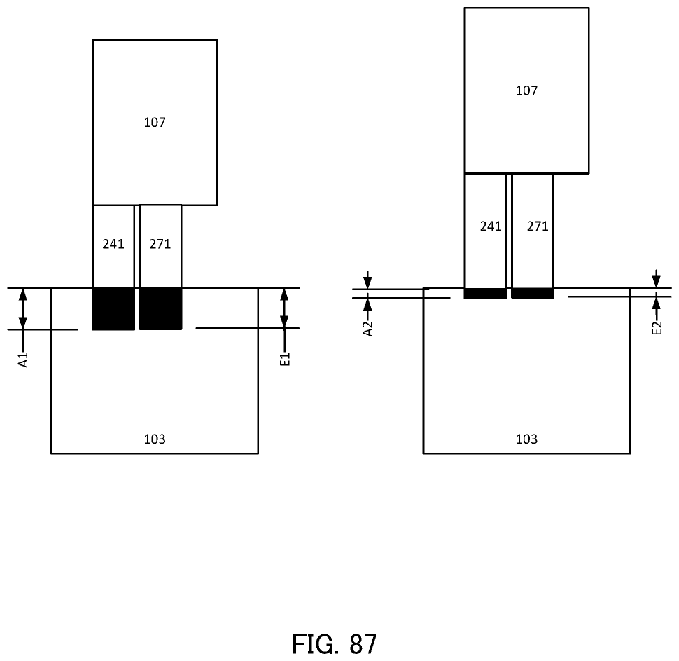

FIG. 87 shows the case where nothing is inserted while the clamp gauge is raised.

$$\begin{matrix}G = Δ A + Δ E \\ = - Δ H + Δ H \\ = 0 < TH\end{matrix}$$

Therefore, it can be determined that nothing has been inserted.

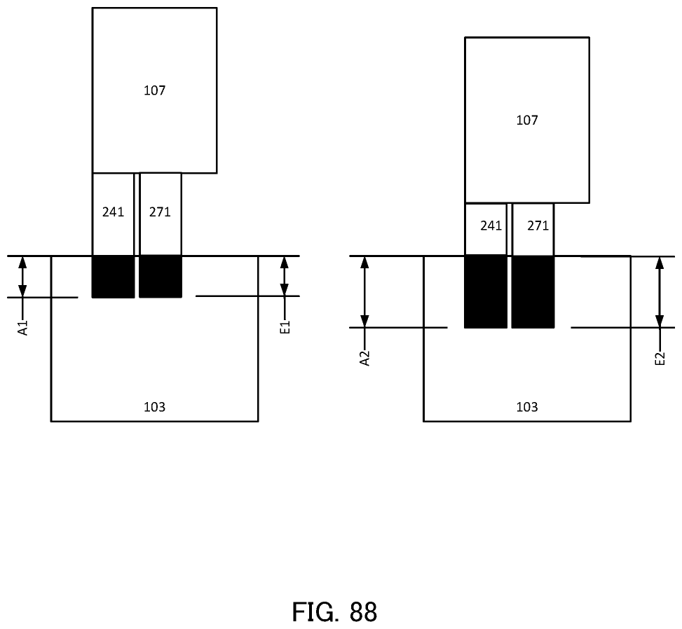

FIG. 88 shows the case where nothing is inserted while the clamp gauge is lowered.

$$\begin{matrix}G = Δ A + Δ E \\ = Δ H - Δ H \\ = 0 < TH\end{matrix}$$

Therefore, it can be determined that nothing has been inserted.

### Fourteenth Embodiment

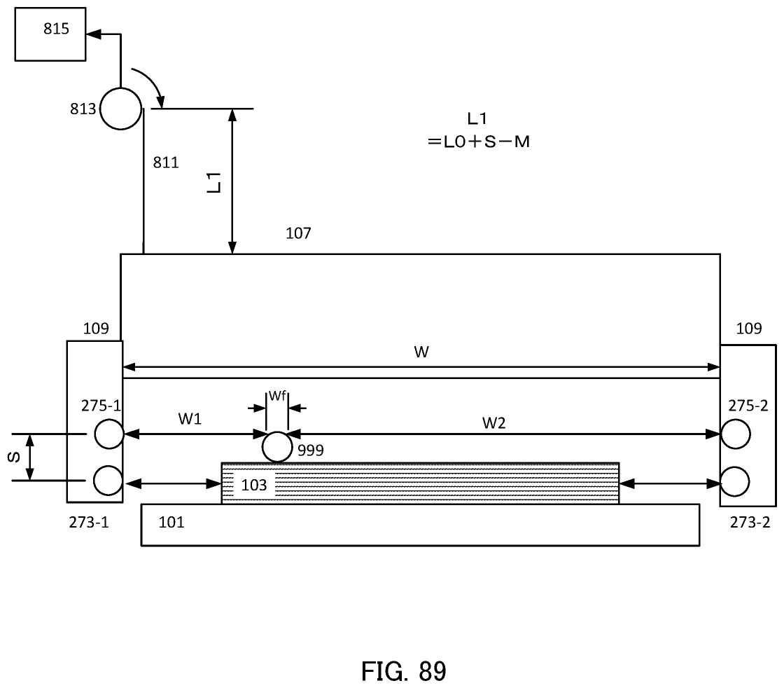

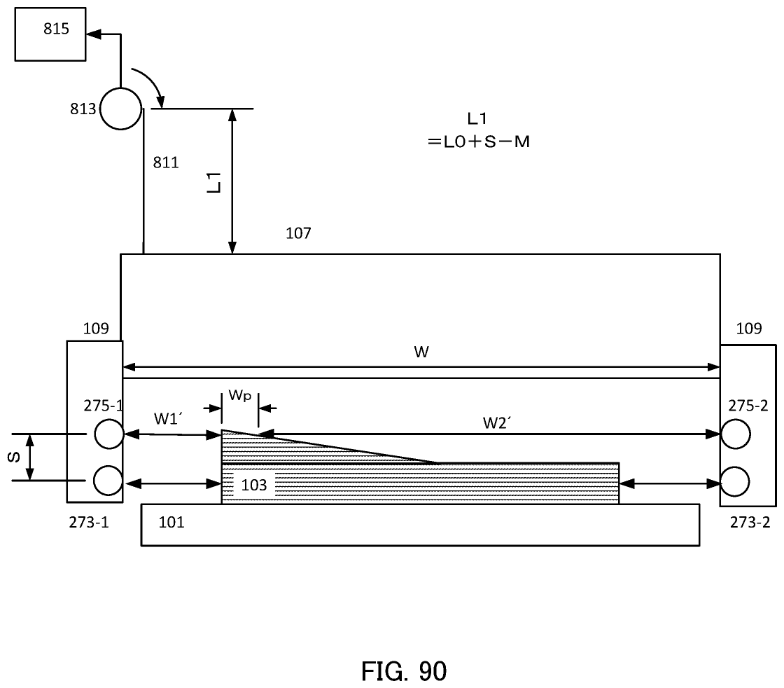

As shown in FIGS. 89 and 90, a reflection type distance measuring device is used as the detecting device. The arrangement of the distance measuring device is the same as that in the first embodiment.

FIG. 89 shows a state where a finger is placed on the paper stack. In this state, a reflective preceding left side detection device 273-1 can measure the distance from the device 273-1 to the left side surface of the paper stack. Further, A reflective preceding right side detection device 273-2 can measure the distance from the device 273-2 to the right side surface of the paper stack. Further, a reflective main left side detection device 275-1 can measure the distance W1′ from the devise 275-1 to the left side surface of the finger Further, a reflective main right side detection device 275-2 can measure the distance W2′ from the device 275-2 to the right side of the finger.

If the distance from the reflective main left side detection device 275-1 to the reflective main right side detection device 275-2 is W, the finger width Wf can be obtained by

Wf=W−(W1′+W2′).

FIG. 90 shows a state in which no finger is placed on the paper stack whose upper end is turned up. In this state, the reflective preceding left side detection device 273-1 can measure the distance from the device 273-1 to the left side surface of the paper stack. Further, the reflective preceding right side detection device 273-2 can measure the distance from the device 273-2 to the right side surface of the paper stack. Further, the reflective main left side detection device 275-1 can measure the distance W1″ from the device 275-1 to the left side of the turned up paper. Further, the reflective main right side detection device 275-2 can measure the distance W2″ from the device 275-2 to the right aide of the turned up paper.

If the distance from the reflective main left side detection device 275-1 to the reflective main right side detection device 275-2 is W, the width Wp of the turned up paper can be obtained by

Wp=W−(W1″+W2′).

Therefore, by committing the value of Wx which is represented by

Wx−W−(W1+W2),

it is possible to determine what the detected object is.

For example, if Wx is Wf±α, it may be determined that a finger has been detected. Here, α is an allowable error range.

If Wx is equal to or less than Wf+α, it may be determined this a finger has been detected.

Alternatively, if the width of the hand is Wh and Wx is equal to or less thin Wh+α, it may be determined that a hand or finger has been detected.

In other cases, it may be determined that the paper that has been turned up or the papa that has not been turned up is detected.

Assuming that the finger of the right hand and the finger of the left hand are placed on the loading paper 103 at the same time, if the width Ws of the shredder width is set as a threshold and Wx is equal to or less than Ws+α, it is determined that the hand or the finger has been detected.

In step S511 shown in FIG. 13, if the determination as to whether

reference distance L1<detector height ice S−foreign substance-derived correction value M′

is YES, it is determined that an intruding object such as a finger is placed on the paper stack 103, and if NO, it is determined that an intruding object such as a finger is not placed on are paper stack 103.

Instead, if the determination as to whether

reference distance L1<detector height difference S−foreign substance-derived correction value M′

and the determination as to whether

Width Wx<Wf+α

Are both YES, it may be determined that an intruding object such as a finger is placed on the paper stack 103. And correspondingly.
if the determination as to whether

reference distance L1<detector height difference S−foreign substance-derived correction value M′

and the determination as to whether

Width Wx≤Wf+α

Are both YES, it may be determined that an intruding object such as a finger is not placed on the paper stack 103. Further, if the determination as to whether

reference distance L1≥detector height difference S−foreign substance-derived correction value M′

is YES, it may be determined that an intruding object such as a finger is not placed on the paper stack 103.

### Fifteenth Embodiment

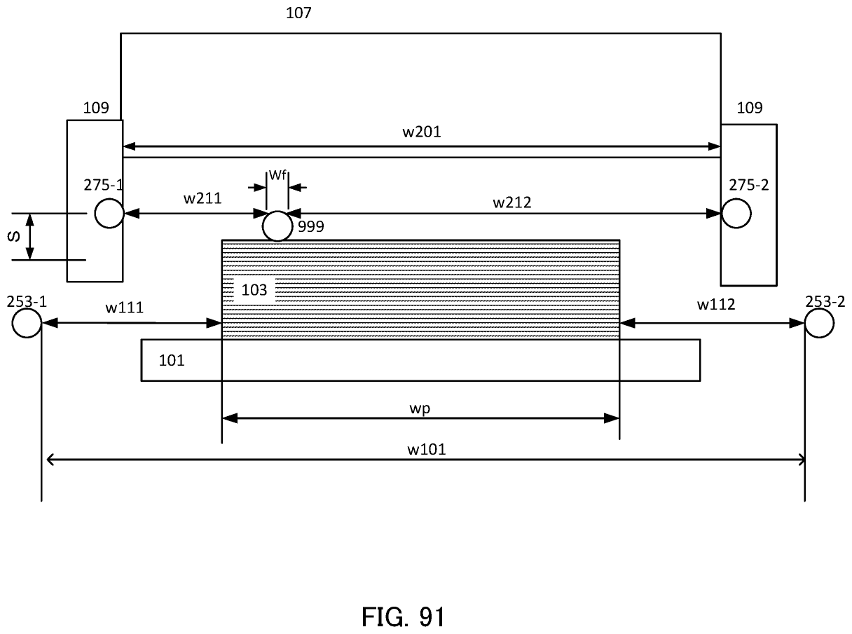

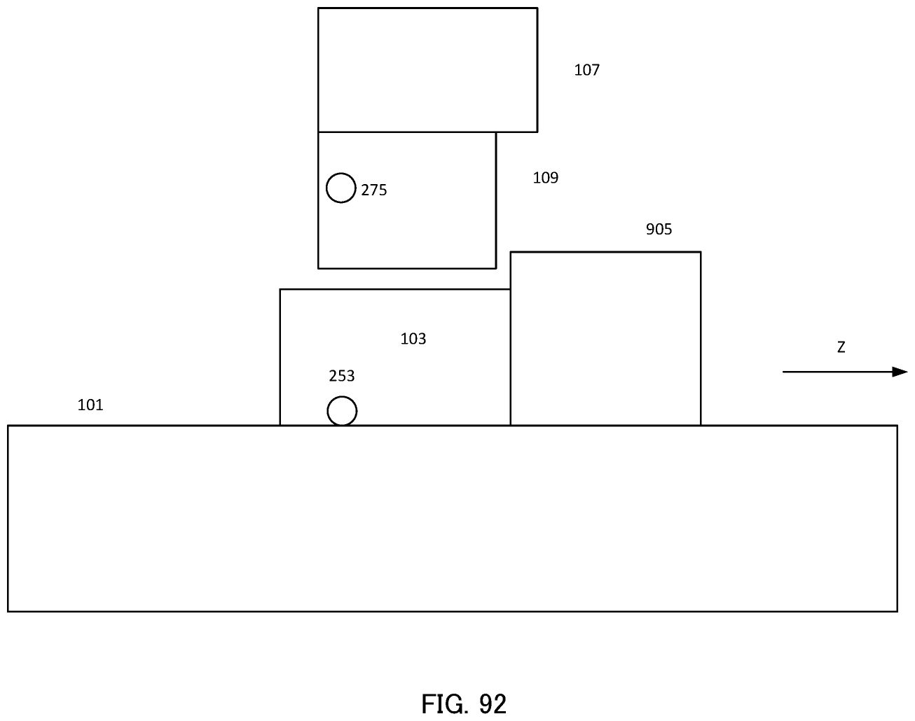

In the fifteenth embodiment, as shown in FIGS. 91 and 92, attentive left main detection device 275-1, a reflective right main detection device 275-2, and a reflective table fixed left detection device 253-1 and a reflection type table fixed right detection device 253-2 are used.

The reflective left main detection device 275-1 and the reflective right main detection device 275-2 are place at the same positions as the light emission side main detection device 221-1 and the light reception side main detection device 221-2 of the first embodiment.

The table fixed 14 side detection device 253-1 and the table fixed right side detection device 253-2 are arranged at both left and right ends of the table 101 in the width direction, and are arranged below the clamp gauge 107 in the depth direction. When viewed in the direction, it is arranged at a position directly above the table 101. In particular, it is preferred that the table fixed left detection device 253-1 and the table fixed right detection device 253-2 are disposed at the same positions as the left main detection device 275-1 and the right main detection device 275-2 when viewed in the depth direction.

The table fixed left side detection device 253-1 and the table fixed right side detection device 253-2 are separated by a distance w101. Therefore, when detecting the paper stack 103 having the width wp placed on the table, the detection distance w111 by the table fixed left side detection device 253-1 and the detection distance w112 by the table fixed right side detection device 253-2 satisfy the following equation.

w101=wp+w111+w112

The left main detection device 275-1 and the right main detection device 275-2 are separated by a distance w201. Therefore, when detecting a finger having a width wf placed on the paper stack 103, the detection distance w211 by the left main detection device 275-1 and the detection distance w212 by the right main detection device 275-2 satisfy the following equation.

w201=wf+w211+w212

Further, the left main detection device 275-1 and the right main detection device 275-2 are separated by a distance w201. Therefore, when detecting a finger of width wp placed on the table 101, the detection distance w211 by the left main detection device 275-1 and the detection distance w212 by the right main detection device 275-2 satisfy the following equation.

w201=wp+w211+w212

Accordingly, when the clamp gauge 107 is lowered and the left main detection device 275-1 and the right main detection device 275-2 detect an object, the width wx of the object is determined by

wx=w201−(w211+w212).

Then, by comparing the width wx and the threshold value wf+α, it can be determined whether or not the object is a finger. That is, if wx<wf+α, it can be determined that the object is a finger.

Further, if the paper stack 103 reaches the position in the predetermined depth direction by the back gauge 905 before the clamp gauge 107 is lowered, the width wp of the paper stack 103 is determined by substituting the distances w111 and w112 respectively detected by the table fixing left side detection device 253-1 and the table fixing right side detection device 253-2 to the following equation

wp=w101−(w111+w112).

It is portable to determine whether or not the object is a finger by comparing the width wp and the width wx. That is, if wx<wp·s, it can be determined that the object is a finger. Here, the value of s is appropriately determined within a range of less than 1.

The table fixed left detection device 253-1 and the table fixed right detection device 253-2 may be deleted, and only the left main detection device 275-1 and the right main detection device 275-2 may be used as detection devices. In that case, if the clamp gauge 107 is lowered and the left main detection device 275-1 and the right main detection device 275-2 detect an object, the width wx of the object is obtained by the following equation

wx=w201−(w211+w212)

Then, it is determined whether or not the object is a finger only by comparing the width wx and the threshold value wf+α. That is, if wx<wf+α, it can be determined that the object is a finger.

Next, the clamp gauge control method according to the present embodiment will be described.

When the descending of the clamp gauge is started, the distance w211 is measured by the left main detection device, the distance w212 is measured by the right main detection device, and the determination by the following comparison digestion is repeated.

w201=(w211+w212)<wf+α

If YES in this determination, it is determined that an intruding object such as a finger is placed on the paper stack, and the clamp gauge is stopped or raised.

### Sixteenth Embodiment

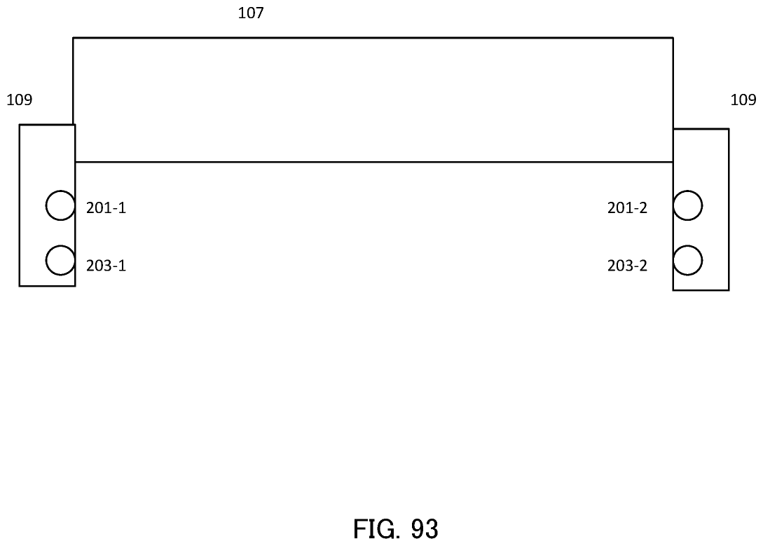

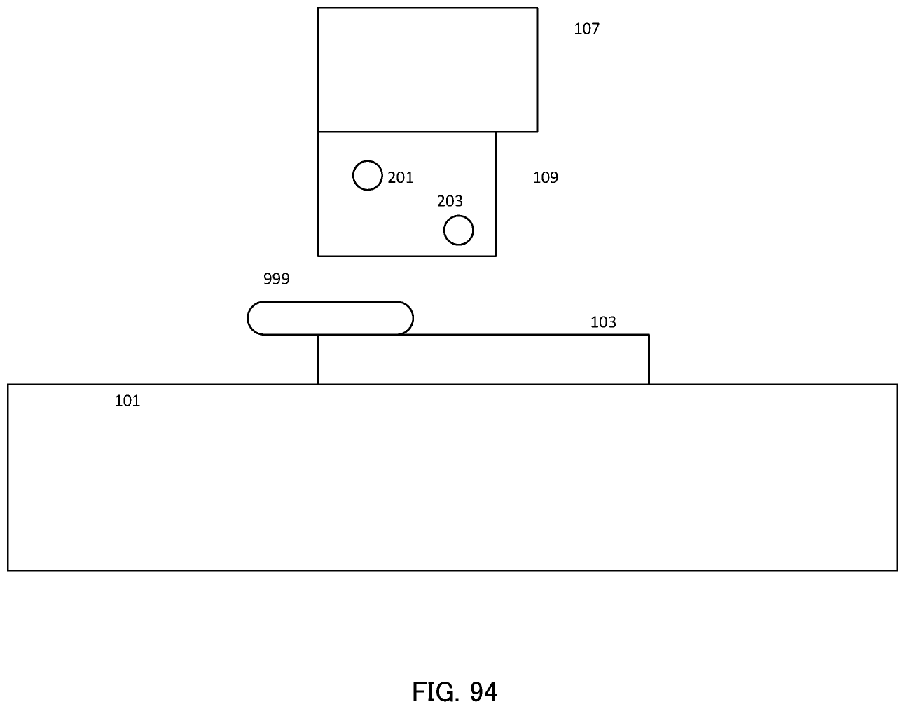

Referring to FIGS. 93 and 94, a paper stack 103 that is a cutting target can be placed on the table 101. There is a case where the clamp gauge 107 is lowered while the operator places the finger 999 on the paper stack 103 due to carelessness.

Safety device mounting plates 109 are attached to both ends of the clamp gauge 107, and an upper detection device 201 and a lower detection device 203 are attached to the safety device mounting plates 109 at both ends. For example, the light emission side upper detection device 201-1 and the light emission side lower detection device 203-1 are attached to the left safety device attachment plate 109, and the light reception side upper detection device 201-2 and the light reception side lower detection device 203-2 are attached to the right safety device attachment plate 109.

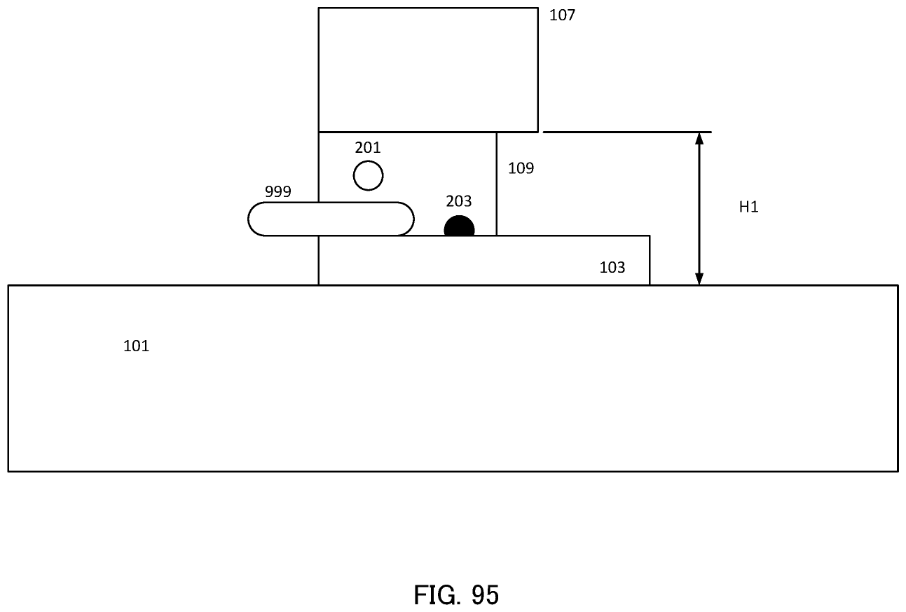

FIG. 95 shows a state in which the lower detection device 203 first detects paper when the finger 999 is placed. In this state, the height of the clamp from the table surface is H1.

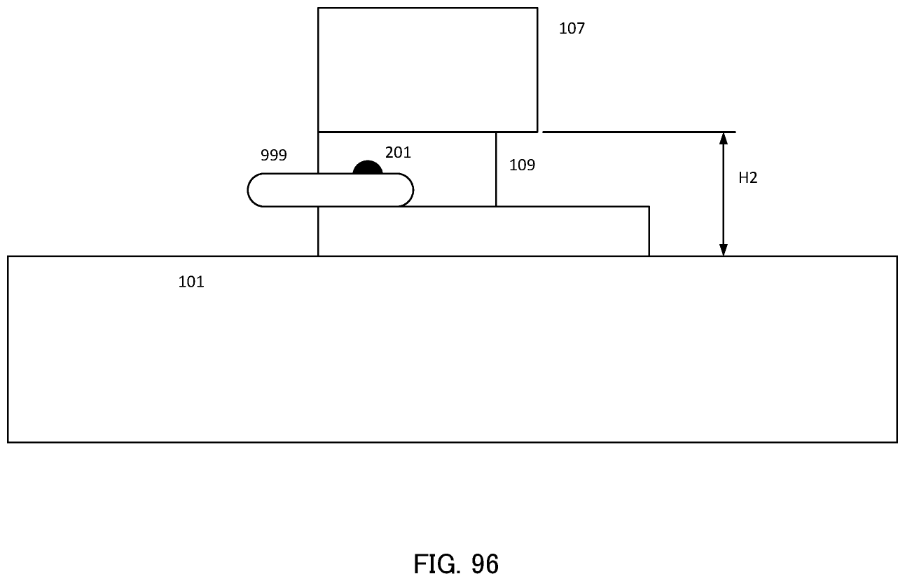

FIG. 96 shows a state in which the upper detection device 201 detects the paper next when the finger 999 is placed. In this state, the height of the clamp from the table surface is H2.

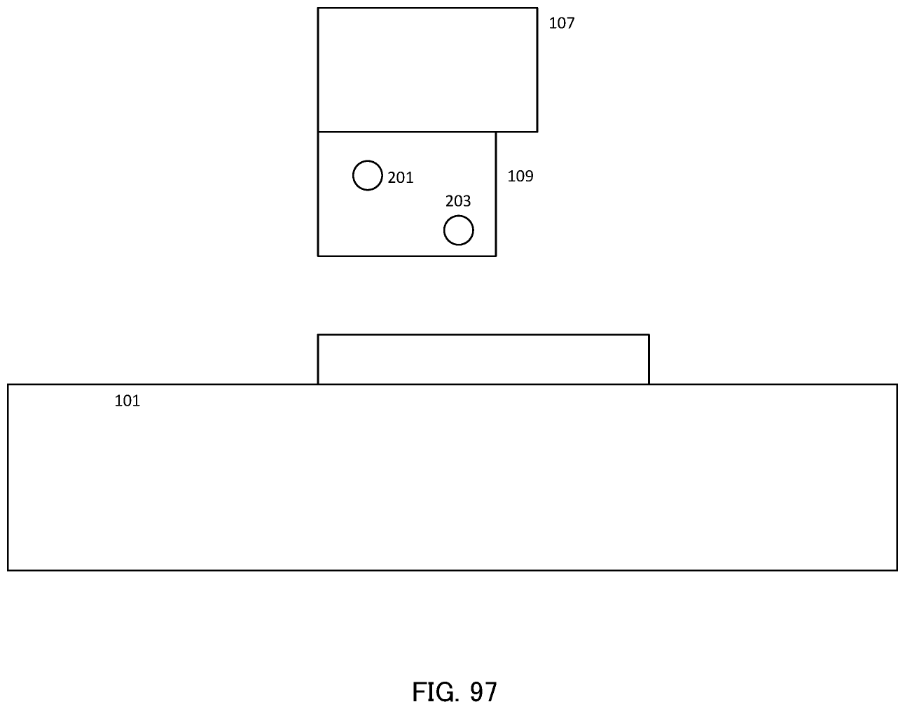

FIG. 97 shows a state where no finger is placed on the paper stack 103.

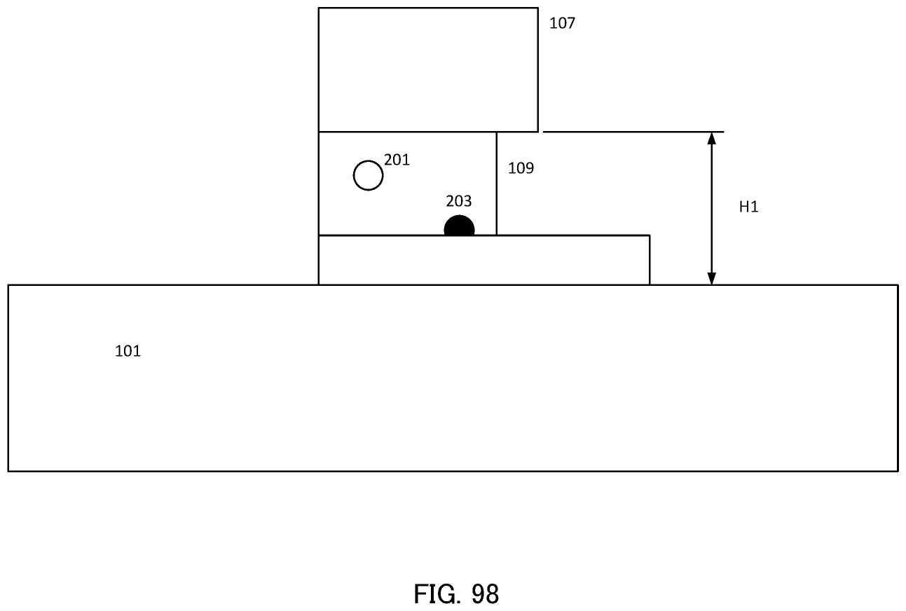

FIG. 98 shows a state in which the lower detection device 203 first detects paper when a finger is not placed. In this state, the height of the clamp from the table surface is H1.

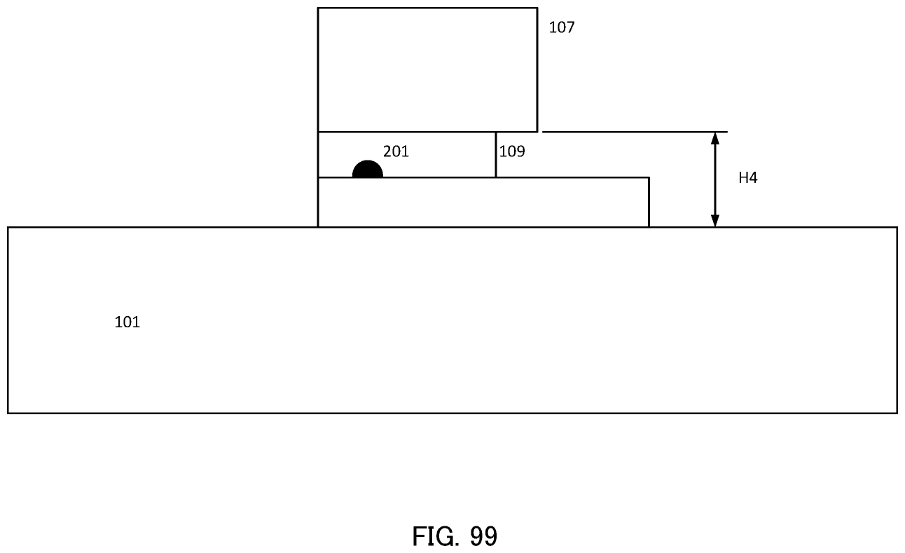

FIG. 99 shows a state where the upper detection device 201 detects paper next when no finger is placed. In this state, the height of the clamp from the table surface is H4.

If the descending velocity of the clamp is V,

The required time T12 from the state of FIG. 95 to the state of FIG. 96 is (H1−H2)/V.

Further, the required time T14 from the state of FIG. 98 to the state of FIG. 99 is (H1−H4)/V.

Here, as is clear from the figure, the required time T12 is shorter than the required time T14 because H1−H2 is shorter than H1−H4.

The required time T14 when the finger is not placed (H1−H4)/V can be known in advance if H1−H4 and V are known. H1−H4 is known because it is the difference in height between the lower detection device 203 and the upper detection device 201. V is also known because it has clamp control.

Therefore, if the upper detection device 201 detects some object before the required time T14 elapses from the state 6, it means that it is an object such as a finger or an arm placed at the paper. become.

Therefore, if the upper detection device 201 detects any object before the required time T14 elapses from the state 6, there is a possibility that a finger or an arm is placed on the paper. By stopping or raising the clamp, it is possible to prevent the fingers and arms from being pinched by the paper and the clamp.

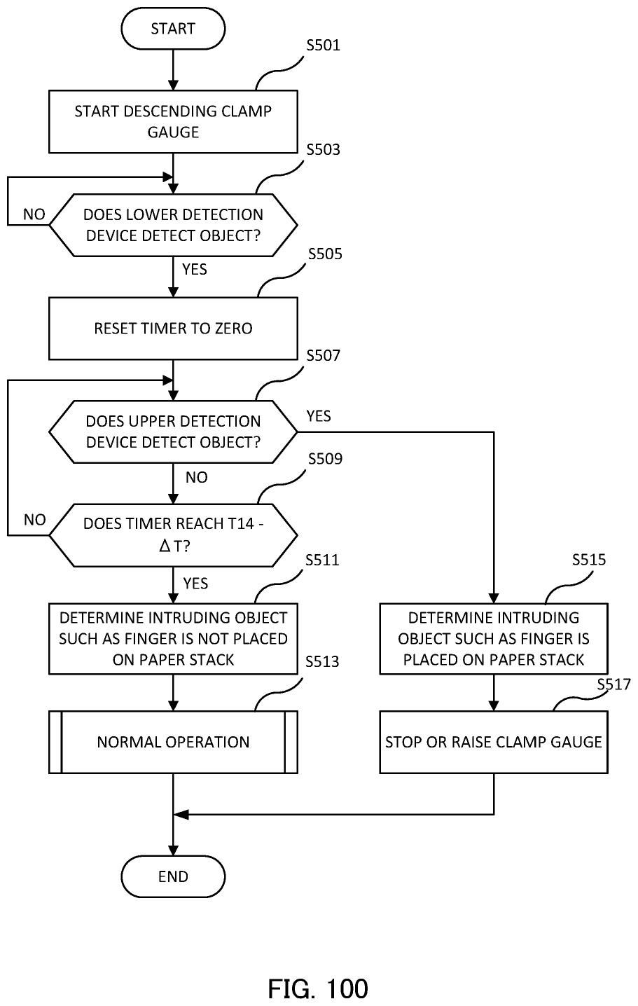

The operation of this embodiment will be described with reference to FIG. 100

First, if there is an instruction to lower the clamp, the lowering of the clamp is started (step S501). Here, the instruction to lower the clamp is, for example, by depressing the clamp pedal.

Next, stay waiting (NO in step S501) for the lower detection apparatus 203 detects an object. If it is detected (YES in step S501), the elapsed time timer t is reset to zero (step S505).

Next, stay waiting (steps S507 and S509) for that the upper detection device 201 detects an object or the elapsed time timer t reaches a predetermined period T14.

If the elapsed time timer t reaches the predetermined period T14 before the upper detection device 201 detects an object (YES in step S509 while NO in step S507), it is determined that an intruding object such as a finger is not placed on the paper stack (step S511), and the normal operation is continued (step S513).

### Seventeenth Embodiment

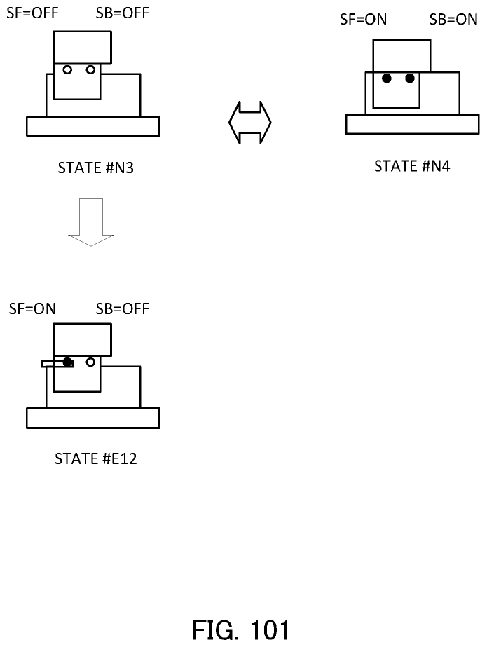

FIG. 101 is an excerpt from FIG. 36.

If the clamp gauge is lowered in state #3, the state transitions to state #4. If the clamp gauge does not descend and the finger is inserted from the front in state #3, the state transitions to state #E12.

In the state #N3, the immediately lower front portion detection device SF is OFF, and the immediately lower rear portion detection device SB is also OFF.

In the state #N4, the immediately lower front portion detection device SF is ON, and the immediately lower rear portion detection device SB is ON.

In state #E12, the immediately lower front portion detection device SF is ON, and the immediately lower rear portion detection device SB is OFF.

Therefore, the transition from the state #N3 to the state #4 and the transition from the state #N3 to the state #E12 are distinguished and detected by the changes in the ON/OFF state of the immediately lower front portion detection device SF and the immediately lower rear portion detection device SB.

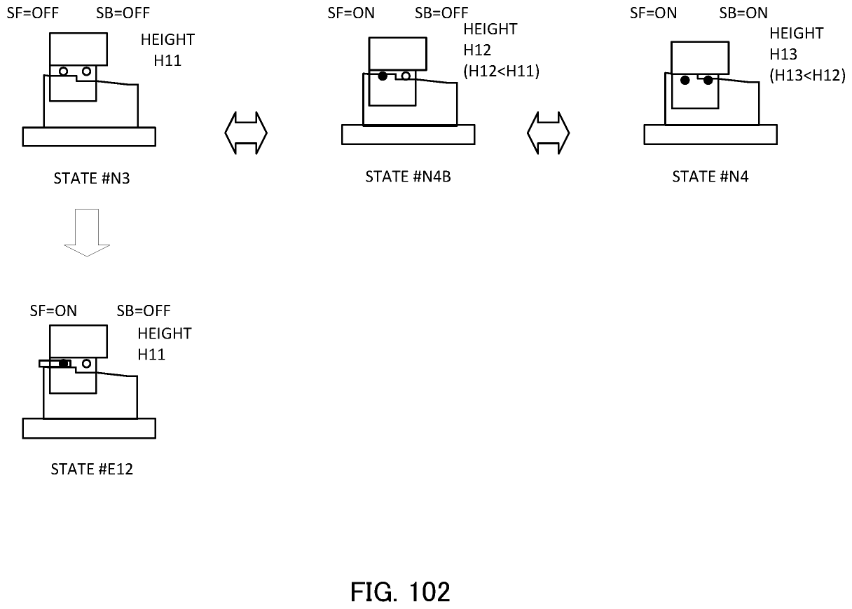

By the way, what is shown in FIG. 101 is the case what the paper stack is flat. Actually, as shown in FIG. 102, the front portion of the paper stack may be raised or jumped up.

In such a case, the state #N4B is sandwiched between the state #N3 and the state #N4.

In the state #N4B, similarly to the state #E12, the immediately lower front portion detection device SF is ON, and the immediately lower rear portion detection device SB is OFF.

Here, it is only necessary to avoid erroneously determining that the state #N4B is the state #E12.

If the clamp gauge continues to descend, even if state #N3 transits to state #4B once, when a short time has passed, the state #4B transits to state #N4.

On the other hand, if the finger is placed on the paper stack while the clamp gauge is not lowered and therefore, the state #N3 transits to the state #E12, the state #E12 is continued and does not transits to state #N4.

Therefore, if the immediately lower rear portion detection device SB is switched from OFF to ON within a predetermined time from the time when the immediately lower front portion detection device SF changes from OFF to ON, the transit on from state N3 ⇒state #N4B⇒state #N4 occurs. If the immediately lower rear portion detection device SB is not switched from OFF to ON within a predetermined time from the time when the immediately lower front portion detection device SF changes from OFF to ON, the transition from state N3⇒state #N12 occurs.

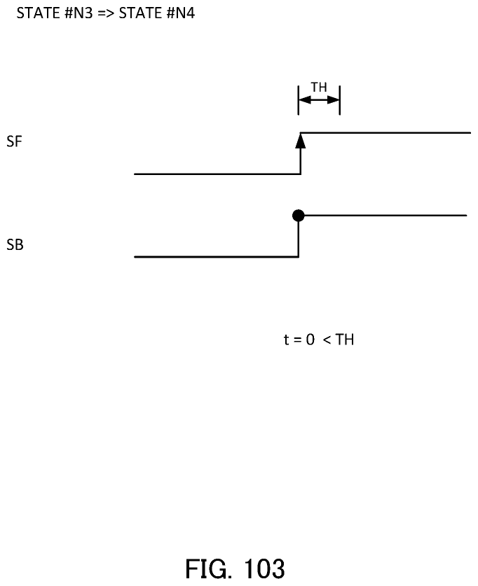

FIG. 103 shows a timing diagram corresponding to the change from the state #N3 to the state #N4 due to the lowering of the clamp gauge when the paper stack is flat as shown in FIG. 101. The timer which starts when it is detected that the immediately lower front portion detection device SF switched from OFF to ON will be stopped when it is detected that the immediately lower rear portion detection device SB becomes ON. Since the timer value stops when it is less than the threshold value TH, the collision avoidance operation is not started. If the front portion of the paper stack is slightly higher than the rear portion, the timer value is slightly increased because the immediately lower rear portion detection device SB is switched from OFF to ON immediately after the immediately lower front portion detection device SF is switched from OFF to ON. To the contrary, if the front portion of the paper stack is slightly lower than the rear portion, the immediately lower front portion detection device SF is switched from OFF to ON immediately after the immediately lower rear portion detection device SB is switched from OFF to ON. The value stops with a count of zero. Therefore, in any case, it can be determined that the paper stack is substantially flat and no finger is placed thereon. Further, the time difference between the time at which the immediately lower front portion detection device SF is switched from OFF to ON and the time at which the immediately lower rear portion detection device SB is switched from OFF to ON may be measured, and the threshold value may be compared therewith. The threshold value may be varied depending on the order of the switchings from OFF to ON. If the time difference is less than the threshold value, it am be determined that the object which turns detection devices SF and SB from OFF to ON is a flat paper stack.

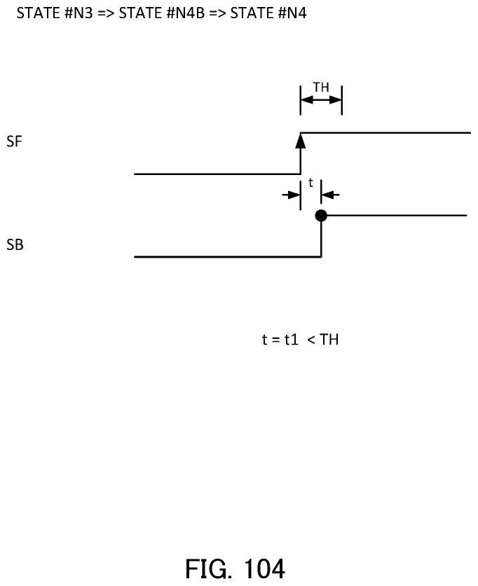

FIG. 104 shows a timing diagram corresponding to the transition of the state #N3→the state #N4B→the state #N4 which is caused by a descending clamp gauge in a case the front portion of the paper stack is raised or bounced up as shown in FIG. 102. When it is detected that the immediately lower front portion detection devise SF has been switched from OFF to ON, a timer is started, and when it is detected that the immediately lower rear portion detection device SB is turned ON, the timer is stopped. Since the timer value t stops when it is less than the threshold value TH, the collision avoidance operation is not started.

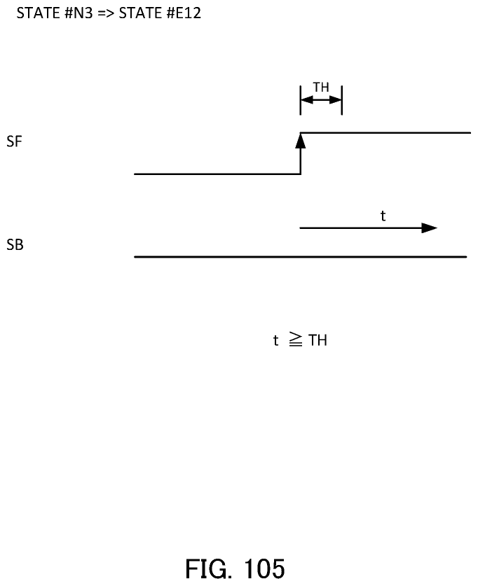

FIG. 105 is a timing diagram corresponding to the transition from the state #N3 to the state #E12 when the finger is inserted from the front portion in the paper state as shown in FIG. 101 or FIG. 102. When it is detected that the immediately lower front portion detection device SF has been switched from OFF to ON, the timer is started. The immediately lower rear portion detection device SB continues to be in the OFF state. When the timer value t reaches the threshold value TH or higher, the collision avoidance operation is started.

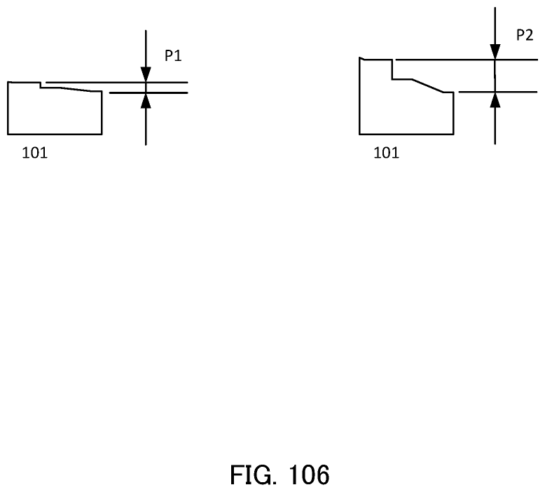

As shown in FIG. 106, comparing the case where the amount of bulging with respect to the rear portion on the front portion of the paper stack 103 is P1 and the case where the amount of protrusion is P2 larger than this, if the descending velocity of the clamp gauge is V, the time T1 for the gauge to descend by the bulging amount P1 is P1/V, and the time T2 for the clamp gauge to descend by the bulging amount P2 is P2/V. Therefore, if the amount of protrusion is large, the timer value t tends to increase, and such possibility that it is erroneously determined a finger has inserted although the finger has not been inserted from the front portion increases. In order to avoid this, the threshold value TH with respect to the timer value t may be increased when it is assumed that amount of bulge is large.

On the contrary, when the estimated amount of bulge is small, the threshold value TH for the timer value t may be reduced. In that case, the sensitivity for detecting the intrusion of the finger is increased.

Next, a case where the rear portion of the paper stack is raised with respect to the front portion will be described.

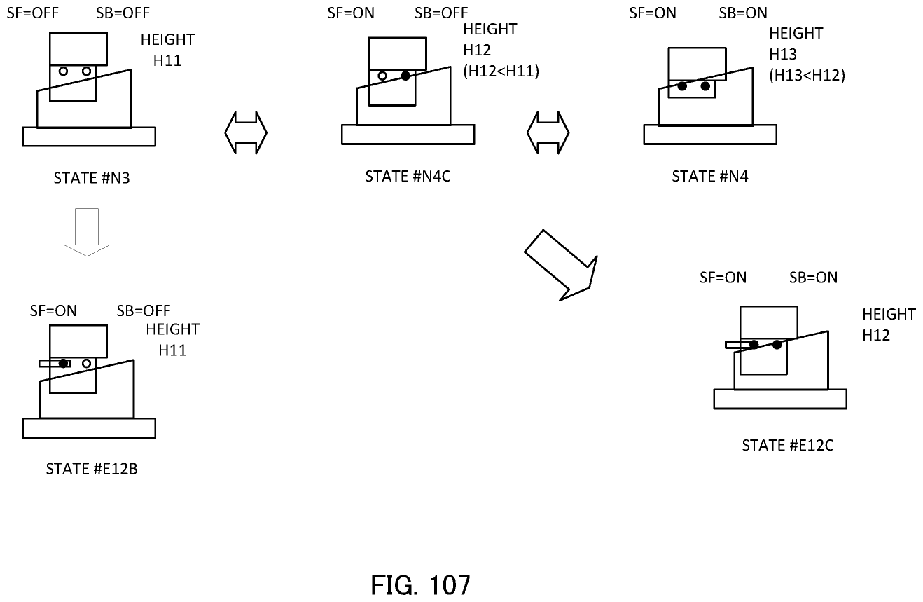

In such a case, if the finger does not enter, as shown in FIG. 107, when the clamp gauge descends, the state #N3 transits to state #N4C, and state #N4C transits to state #N4.

In the state #N3, the height is H11, the immediately lower front portion detection device SF is OFF, and the immediately lower rear portion detection device is also OFF.

In the state #N4C, the height is H12, the immediately lower front portion detection device SF is OFF, and the immediately lower rear portion detection device is ON. Here, H12<H11.

In the state #N4, the height is H13, the immediately lower front portion detection device SF is ON, and the immediately lower rear portion detection device is also ON. Here, H13<H12.

On the other hand, in such a case, if a finger enters, a transition from state #N3 to state #E12B may occur as one case.

In the state #E12B, the height is H11, the immediately lower front portion detection device SF is ON, and the immediately lower rear portion detection device is OFF.

If a finger enters, as another case, a transition from state #N3 to state #N4C and a transition from state #N4C to state #E12C occur in this order.

In the state #E12C, the height is H12, the immediately lower front portion detection device SF is ON, and the immediately lower rear portion detection device is also ON.

That is, provided that the rear portion of the paper stack is raised with respect to the front portion, if the finger enters, a transition from the state #N3 to the state #E12B or a transition from the state #N4C to the state #E12C occurs.

Transition from state #N3 to state #E12B means that the height of the clamp gauge does not change and the immediately lower rear portion detection device remains OFF, but only the immediately lower front portion detection device is switched from OFF to ON due to the entry of a finger. Therefore, this transition can be detected using the height as a judgment material. This is the same even when the front portion of the paper stack is raised with respect to the rear portion. Therefore, regardless of whether the front portion or the rear portion of the paper stack is raised relative to the other; the height of the clamp gauge does not change and the immediately lower rear portion detection device remains OFF, but only the immediately lower front portion detection device is switched from OFF to ON, it can be determined that the finger has intruded.

The transition from the state #N4C to the state #E12C and the transition from the state #N4C to the state #N4 in the case where the rear portion of the paper stack is raised with respect to the front portion can be identified as follows. That is, in any transition, the transition of the detection state of the immediately lower front portion detection device and the immediately lower rear main detection device is a transition from OFF, ON to ON, ON. In addition, the height of the clamp gauge does not change in the transition from the state #N4C to the state #E12C, but the clamp gauge descends in the transition from the state #N4C to the state #N4.

Therefore, the height of the clamp gauge is measured when the immediately lower front portion detection device and the immediately lower rear portion detection device are OFF and ON, and the height of the clamp gauge is measured also when the immediately lower front portion detection device and the immediately lower rear portion detection device turns ON and ON. If the height measured in the latter case is the same as the height measured in the former case, it is determined that a transition from state #N4C to state #E12C has occurred. On the other hand, if the height measured in the latter case is lower than the height measured in the former case, it is determined that a transition from state #N4C to state #N4 has occurred, that is, the clamp gauge has been lowered.

By the way, with reference to FIG. 102 and FIG. 107, the description has been given to the case where the finger enters from the middle and is detected, but even if the finger is already placed on the paper stack when the clamp gauge starts to descend, This can be detected. This will be explained.

The height H11 in the state #N3 shown in FIGS. 102 and 107 is regarded as the height with which the immediately lower front portion detection device switches from OFF to ON and transitions to the state #E12 or the state #E12B if the finger enters at the height.

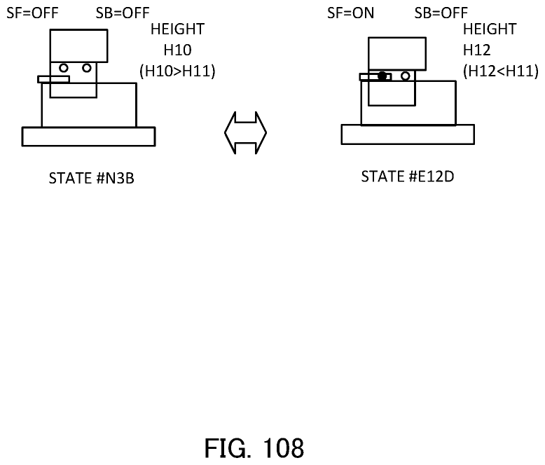

The height H10 in the state #N3B shown in FIG. 108 is regarded as the height that maintains the state #N3B without switching the immediately lower front portion detection device from OFF to ON even if a finger enters at that height (H10>H11).

After that, when the clamp gauge is lowered to the height H12, the immediately lower front portion detection device is switched from OFF to ON and transits to the state #E12D.

Here, as is clear from a comparison between FIG. 102 and FIG. 108 both in the case of a transition such as state #N34⇒state #N4B and in the case of a transition such as state #N3B⇒state #E12D, the immediately lower front portion detection device and the immediately lower rear portion detection device transit from OFF, OFF to ON, OFF. Therefore, it is difficult to determine whether or not a finger is placed at the paper stack based only on the state transition of the immediately lower front portion detection device and the immediately lower rear portion detection device.

However, provided that the estimated height of the finger is M and the estimated height of the paper bulge is C, and C is smaller than M to some degree, if a timer threshold value corresponding to the height between M and C is set, it becomes possible to determine whether or not a finger is placed on the paper stack.

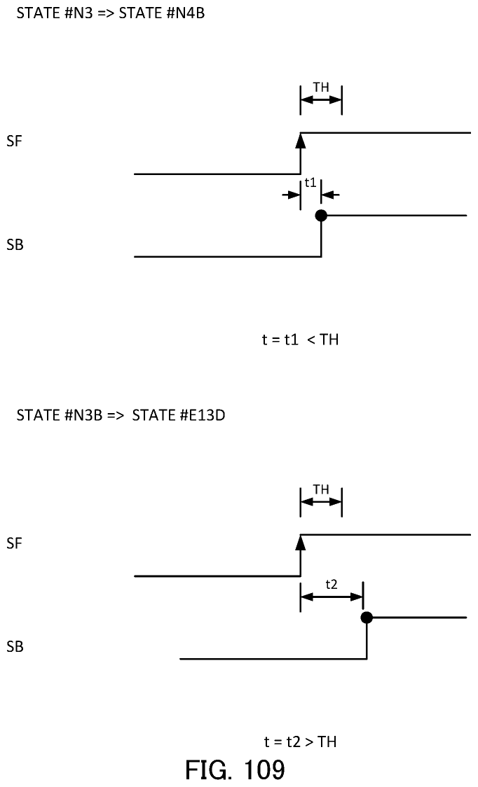

That is, as shown in FIG. 109, provided that C<M, the elapsed time t2 from the time when the immediately lower front portion detection device changes from OFF to ON until the time when the immediately lower rear portion detection device changes from OFF to ON in a case where the state transition from state #N3B to state #E12D takes place is longer than the elapsed time t1 from the time when the immediately lower front portion detection device changes from OFF to ON until the time when the immediately lower rear portion detection device changes from OFF to ON in a case where the state transition from state #N3 to state #N4B takes place (t1<t2). Therefore, by providing a time threshold value TH between than (t1<TH<t2), it becomes possible to discriminate these cases.

Even when the threshold value TH is set in this way, it is possible to detect a change from the state #N3 to the state #E12 due to the finger entering from the middle of the time as shown in FIG. 102. In other words, it is detected that the finger has entered from the middle of the time because the immediately lower rear portion detection device remains OFF even when the time threshold TH has elapsed after the immediately lower front portion detection device has changed from OFF to ON.

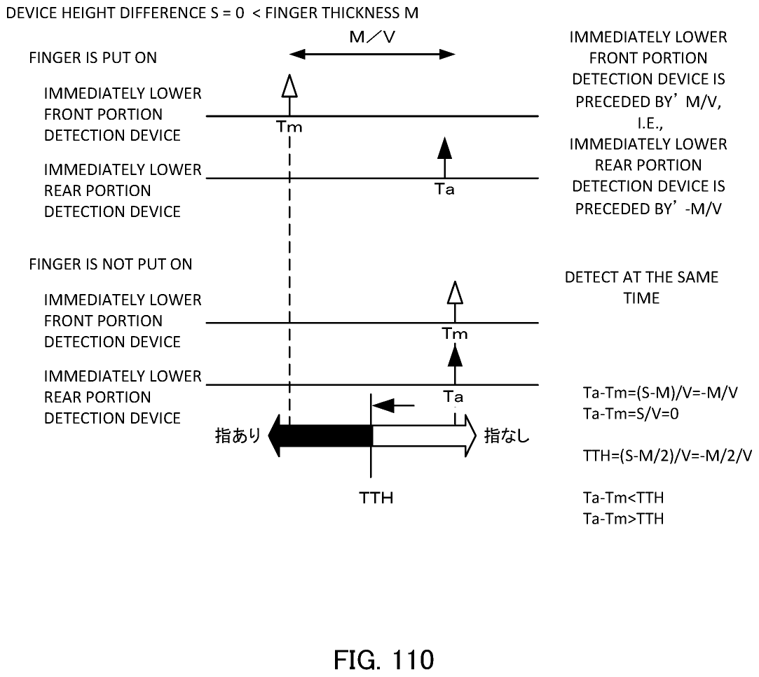

FIG. 110 shows the timing relationship in the following two cases.

(101-1) When there is a finger in the setting of height differences S=0<finger thickness M
(101-2) When there is no finger in the setting of height differences S≤0<finger thickness M
In the case of (102-1), the immediately lower front portion detection device detects the paper at time Tm, and then the immediately lower rear portion detection device detects the finger at time Ta. Ta−Tm=M/V. Therefore, Ta−Tm=M/V.

In the case of (102-2) the main detection device detects the paper at time Tm after the preceding detection device detects the paper at time Ta. Ta−Tm=0.

Therefore, for example, (102-1) and (102-2) can be discriminated by comparing Ta−Tm with (M/2)/V.

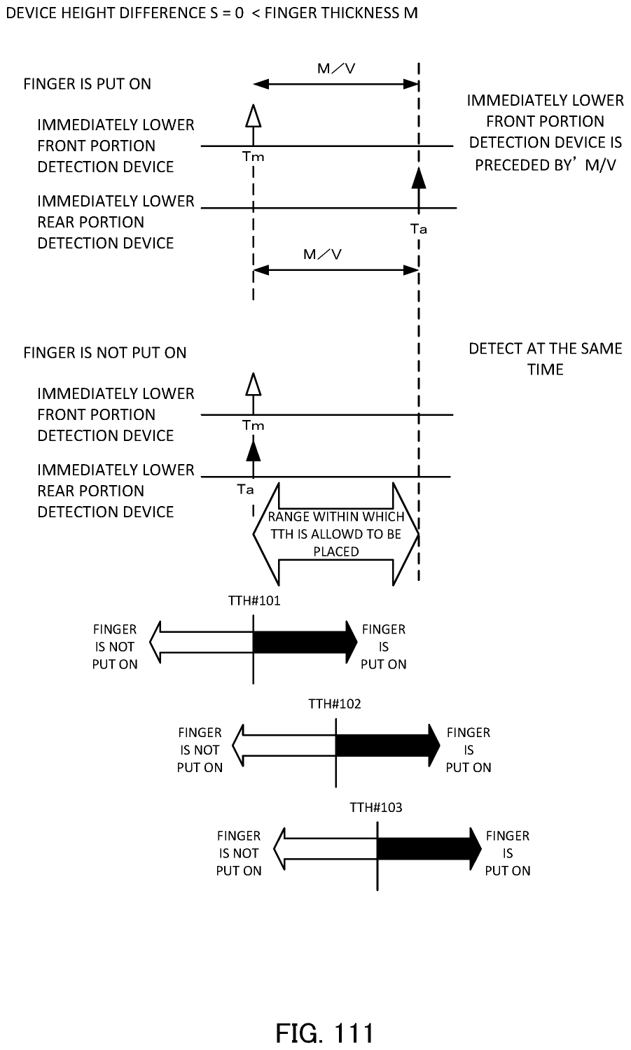

FIG. 110 is a timing diagram drawn on the basis of the time Ta at which the immediately lower rear portion detection device detects the paper stack in a case where the height difference S between the immediately lower front portion detection device and the immediately lower rear portion detection device is zero. On the other hand, FIG. 111 is a timing diagram drawn on the basis of the time Tm at which the immediately lower front portion detection device detects the paper stack or the finger in a case where the height difference S between the immediately lower front portion detection device and the immediately lower rear portion detection device is zero.

Referring to FIG. 111, if is a finger, the immediately lower rear portion detection device detects the paper stack at time Ta, which is M/V later than time Tm when the immediately lower front portion detection device detects the finger. On the other hand, if there is no finger, the immediately lower front portion detection device and the immediately lower rear portion detection device detect the paper stack at the same time.

Therefore, the time difference Ta−Tm is M/V when there is a finger, and zero when there is no finger. In the present embodiment, the threshold time TTH can be set between the time Tm and the time later by M/V than the time Tm.

The threshold time TTH #101 shown in FIG. 111 is set at the same time as the time Tm. The threshold time TTH #102 is set at the time at the center of the TTH settable range (that is, the time later by (M/2)/V than the time Tm). The threshold time TTH #103 is set at a time later than the threshold time TTH #102 (for example, a time later by (3M/4)/V than the time Tm).

If the rear portion of the paper stack is raised as compered with the front portion of the paper stack, there is a possibility that a finger cannot be detected even though the finger is on the paper stack. This possibility is lower when the threshold time Tm #102 is used than when the threshold time TTH #103 is used. Further, this possibility is lower when the threshold time #101 is used than when the threshold time TTH #102 is used.

Therefore, even when the height difference between the immediately lower front portion detection device and the immediately lower rear portion detection device is fixed to zero, it is possible to reduce the possibility that a finger on the paper stack is not detected by adjusting the threshold time TTH in accordance with the rising state of the paper stack.

If the front portion of the paper stack is raised as compared with the rear portion of the paper stack, there is a possibility that it may be erroneously determined that a finger is on the paper stack even though there is no finger on the paper stack. This possibility is lower when the threshold time TTH #102 is used than when the threshold time TTH #101 is used. Further, this possibility is lower when the threshold time #103 is used than when the threshold time TTH #102 is used.

Therefore, even when the height difference between the immediately lower front portion detection device and the immediately lower rear portion detection device is fixed to zero, it is possible to reduce the possibility that it is erroneously determined that a finger is on the paper stack even though there is no finger on the paper stack by adjusting the threshold time TTH in accordance with the rising state of the paper stack.

For example, if the threshold time TTH #102 is used, both errors can be reduced in a balanced manner.

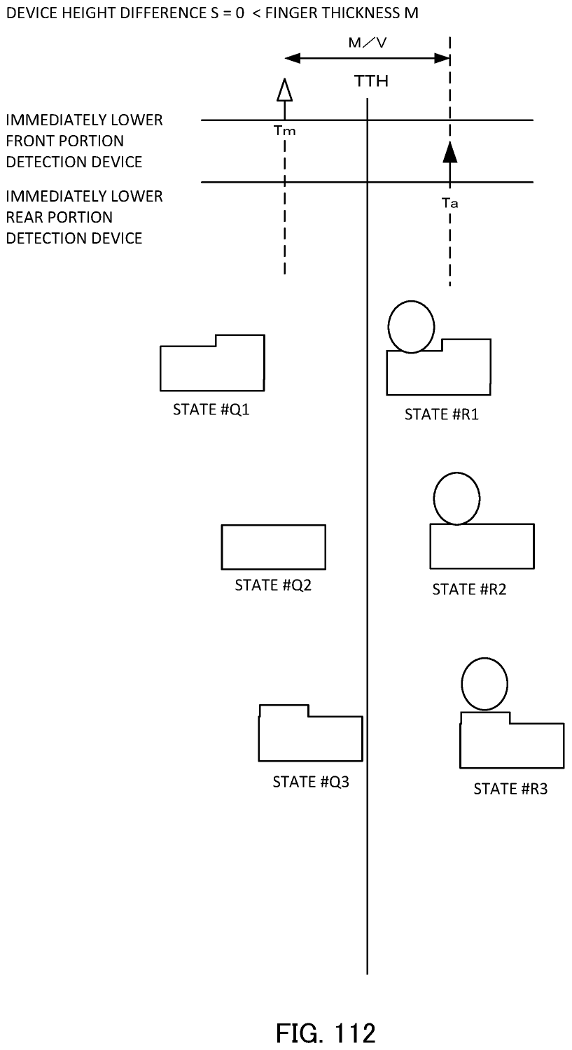

Referring to FIG. 112, for example, if a threshold time near threshold time TTH #102 is used, whether or not a finger is placed on the paper stack can be correctly determined regardless of whether the paper stack is raised. That is, state #Q1 where the rear portion is raised and no finger is placed, state #Q2 where there is no bump and no finger is placed, and state #Q3 where the front portion is raised and no finger is placed are correctly determined as a state where no finger is placed, and state #R1 where the rear portion is raised and a finger is placed, state #R2 where there is no bump and a finger is placed, and state #R3 where the front portion is raised and a finger is placed are correctly determined as a state where a finger is placed.

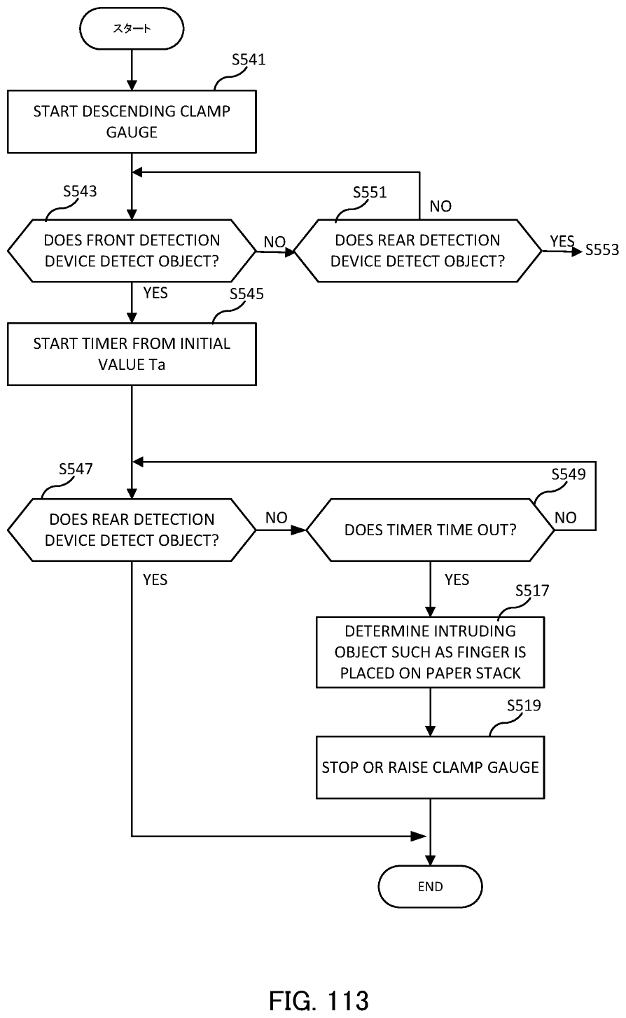

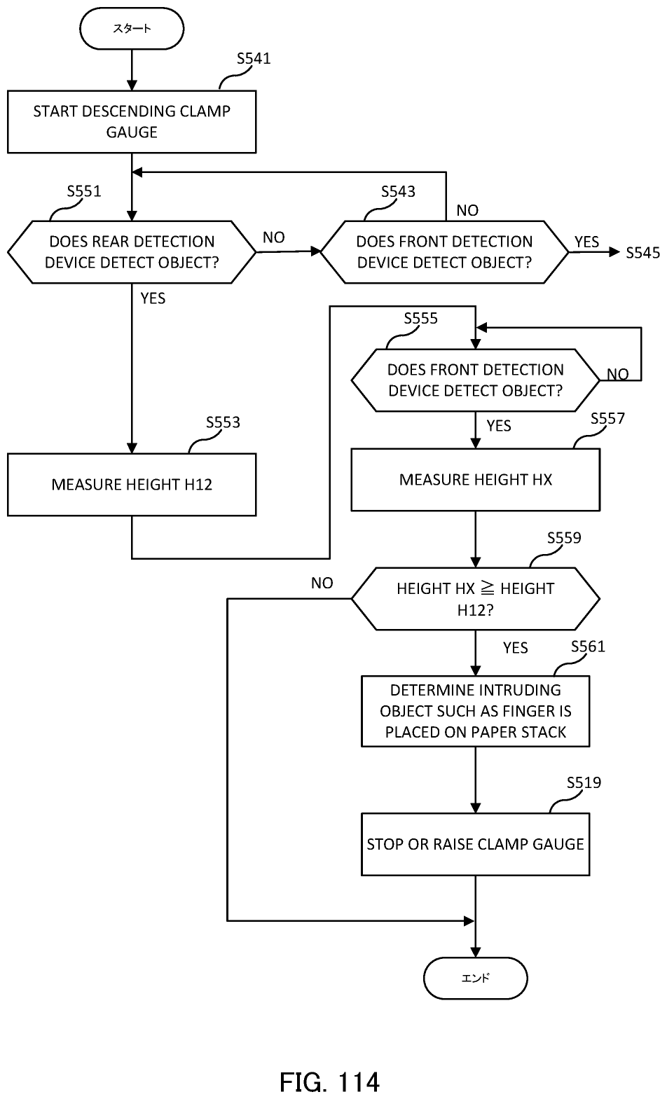

Next, each of the three methods for detecting the finger on the paper stack by the immediately lower front portion detection device and the immediately lower rear portion detection device will be described with reference to FIGS. 113 and 114.

The method shown in FIG. 113 is for the case where the immediately lower front portion detection device detects an object prior to the immediately lower rear portion detection device detects an object, and the method shown in FIG. 114 is for the case where the immediately lower rear portion detection device detects an object prior to the immediately lower front portion detection device detects an object. The method as shown in FIG. 113 is related to detecting the transition from the state #N3 to the state #E12 as shown in FIG. 102, the transition from the state #N3 to the state #E12B as shown in FIG. 107, and the transition from the state #N3B to the state #E12D as shown in FIG. 108. In addition, the method as shown in FIG. 113 is related to discriminating these transitions from the transition of state, #N3B⇒state #E12D⇒state #N4 as shown in FIG. 102.

The method as shown in FIG. 114 is related to detecting the intuition from the state #N4C to the state #E12C as shown in FIG. 107, and related to discriminating this transition from the Munition of state #N4C⇒state #N4 as shown in FIG. 107.

Referring to FIG. 113, after starting to lower the clamp gauge (step S541), if the immediately lower front portion detection device detects an object before the immediately lower rear portion detection device detects an object (if YES in step S543 in the loop of NO in step S551 and NO in step 543), the timer is stated from the initial value Ta (step S545). The initial value Ta here is for setting the above-described threshold time TTH.

Next, if the timer times out before the rear portion detection device detects an object (if YES in step S549 in the loop of NO in step S547 and NO in step 549), it is determined that the object, detected in step S543 is an intruding object such as a finger (Step S517), and the clamp gauge is stopped or raised (step S519).

Next, if the rear portion detection device detects an object before the timer times out (if YES in step S547 in the loop of NO in step S547 and NO in step 549), it is determined that the object detected in step S543 is a paper stack, and the process ends.

Referring to FIG. 114, after stating to lower the clamp gauge (step S541), if the immediately lower rear portion detection device detects an object before the immediately lower front portion detection device detects an object (if YES in step S551 in the loop of NO in step S551 and NO in step 543), the height of the clamp gauge at that time is measured as the height H12 (step S553). Next, when the front portion detection device detects an object (YES in step S555), the height at that time is measured as the height HX (step S557).

Next, the height HX is compared with the height H12. If the height HX is equal to or higher than the height H12 (YES in step S559), it is determined that the object detected in step S555 is an intruding finger or the like. (Step S561), the clamp gauge is stopped or raised (step S519).

If the height HX is lower than the height H12 (YES in step S559), it is determined that the object detected in step S555 is a paper stack (step S561), and the process ends. Instead of H12, H12−|h| may be used. Here, |h| is a margin.

### Eighteenth Embodiment

In the fourteenth embodiment, the total width of the paper is Wp, the width of the rolled-up or raised portion of a paper stack is Wq, and the width of the finger is Wf.

Using W1 and W2 detected when the clamp gauge clamps the paper and the knife actually cuts the paper, a width W is obtained as follows:

W=W0−(W1+W2)

The width W obtained from the above equation is the full width Wp of the paper.

When cutting is repeated while feeding the back gauge forward without rotating the paper on the table, the W1 and W2 detected when the clamp gauge clamps the paper and the knife actually cuts the paper do not change and Wp obtained by

W=W0−(W1+W2)

does not change.

Accordingly, W1, W2, and W=W0−(W1+W2) obtained for the paper in the first cutting in the sequence of cutting continuously while feeding the back gauge forward are stored. If the left side detection device detects a distance longer than W1, the right detection device detects a distance longer than W2, or both occur in the second and subsequent cuttings, it is determined that this is due to detection of a finger.

Further, in the sequence of continuous cutting while feeding the back gauge forward, the height of the clamp gauge at the moment when the paper width Wp is first detected in the first cutting is detected and held. In the cutting, when the left side detection device or the right side detection device detects some object before the clamp gauge descends to its height, it can be determined that this is due to the detection of the finger.

### Nineteenth Embodiment

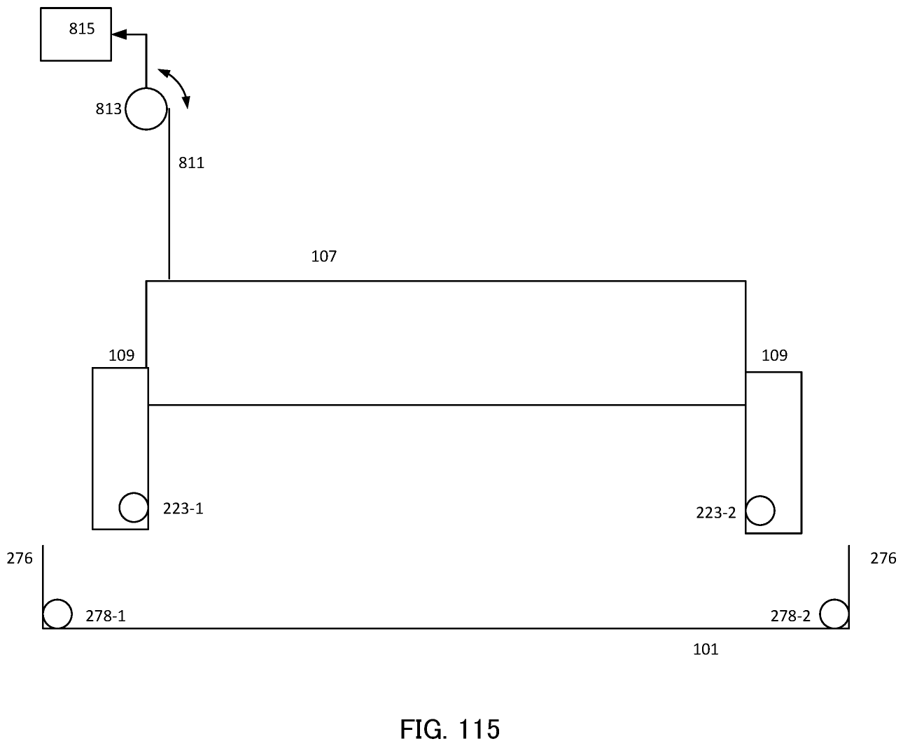

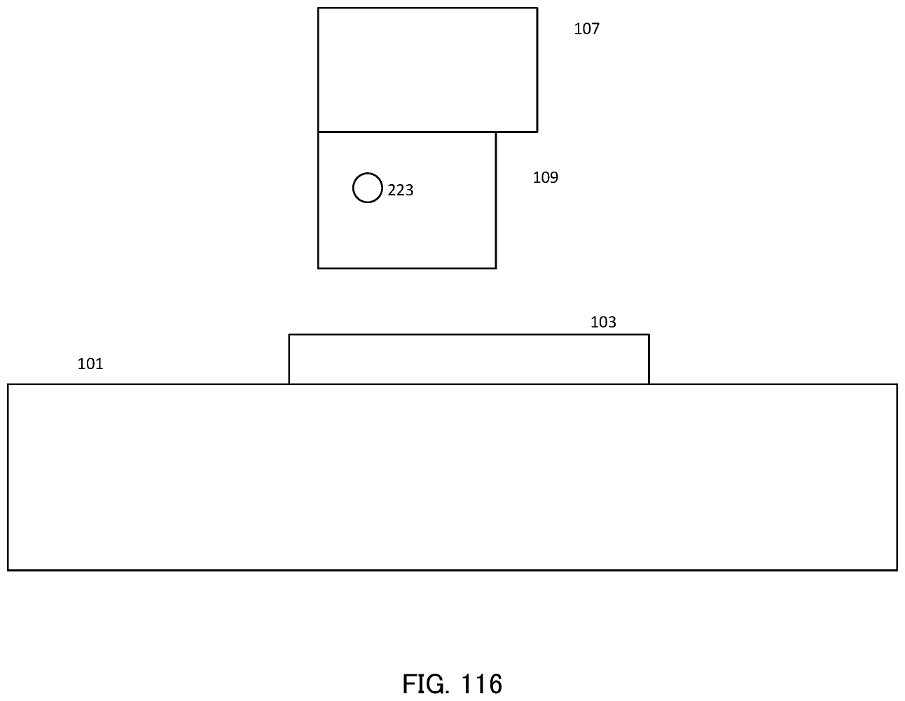

In the nineteenth embodiment, as shown in FIGS. 115 and 116, the reflection type distance measuring devices 275-1 and 278-2 are arranged in the vicinity of both the left and right partition plates 276 at the front of the table 101. These are referred to as a left paper width detection device and a right paper width detection device.

If the detection distances by the left paper width detection device 275-1 and the right paper width detection device 275-2 are W1 and W2, respectively, the paper width Wp is

Wp=W0−(W1+W2).

Accordingly, in each cutting, for example, the paper width Wp is obtained based on W1 and W2 respectively detected by the left paper width detecting device 275-1 and the right paper width detecting device 275-2 at the start of lowering of the clamp gauge. When the left detecting device detects a distance longer than W1 when the right detection device detects a distance longer than W2, or when both occur, it can be determined that this is due to the detection of a finger.

### 20th Embodiment

In the eighteenth or nineteenth embodiment, when the left detection device detects a distance longer than W1, or when the right detection device detects a distance longer than W2, or when both occur, it can be determined that it is due to the detection of a finger.

However, even when these detection devices detect a push plate that pushes paper from the front or side to align the paper, the left detection device detects a distance longer than W1, and the right detection device detects a distance longer than W2.

Therefore, if the width of the push plate is Wc, when W obtained by

W=W0−(W1+W2)

is Wc, it is determined that the push plate is detected. Then, the start of the collision avoidance operation is inhibited as necessary.

### Twenty-First Embodiment

The following four types of setting may be switched as desired.

The first setting is to determine that an intruding object such as a finger is placed on a paper stack if

Wth2≥W>−abs(Wth3)

where

W=W0−(W1+W2).

The second setting is to determine that an intruding object such as a is placed on a paper stack if

Wth2≥W>0

where

W=W0−(W1+W2).

The third setting is to determine that an intruding object such as a finger is placed on a paper stack if

Wp≥W

where

W=W0−(W1+W2).

The fourth setting is to determine that an intruding object such as a finger is placed on a paper stack if

Wp≥W

and

Wc≠Wt

where

W=W0−(W1+W2).

### Twenty-Second Embodiment

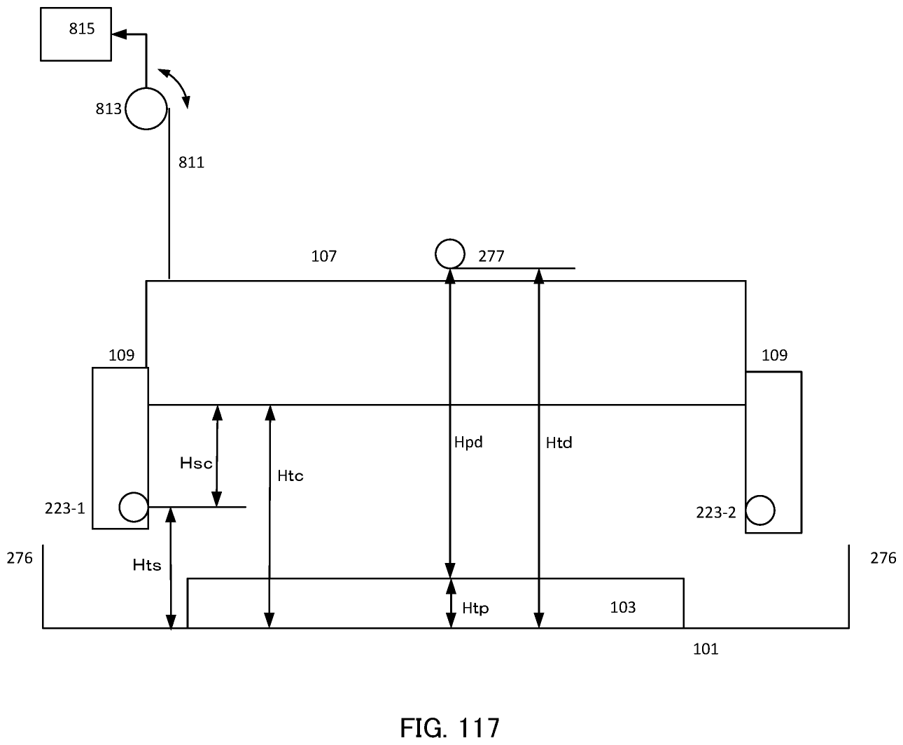

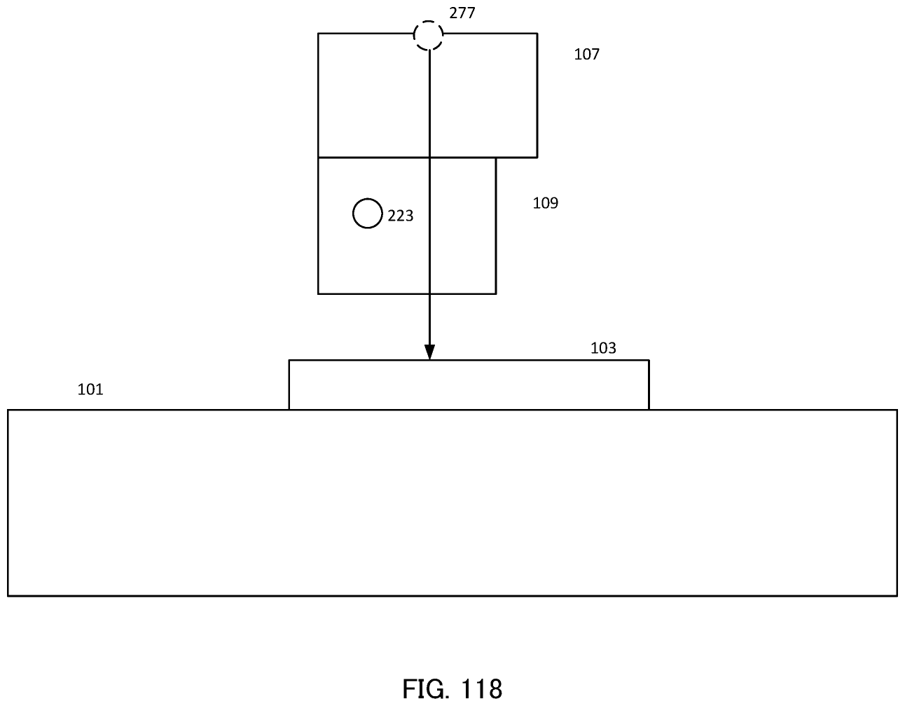

In the twenty-second embodiment, as shown in FIGS. 117 and 118, a paper stack height detection device 277 for detecting the height of the paper stack 103 is added. Further, a clamp gauge height detection device including a wire 811, a rotary encoder 813 and a motion detection device 815 is used. Further, the main detection device 221 is used. As the main detection device 221, a transmission type detection device including the light emission side main detection device 221-1 and the light reception side main detection device 221-2 may be used, or only one reflective detector at the position of the light emission side main detection device 221-1 may be used.

The paper stack height detecting device 277 detects the distance Hpd from itself to the paper stack 103. Using the height Htd from the table 101 to the paper stack height detecting device 277, the height Htp of the paper stack 103 can be obtained by the equation as follows:

Htp=Htd−Hpd

Further, the distance from the lower end of the clamp gauge 107 to the main detection device 221 is denoted as Hsc.

The height Htc of the clamp gauge 107 can be obtained by a clamp gauge height detection device.

If an intruding object such as a finger is not on the paper stack, the main detection device 221 detects a paper stack as an object when the height Htc of the clamp gauge 107 is the same as or less than the height Htp+Hsc which is obtained by adding the distance Hsc to the height Htp of the paper stack 103, i.e., when

Htc≤Htp+Hsc.

However, if an intruding object such as a finger is on the paper stack, the main detection device 221 detects the intruding object as an object when the height Htc of the clamp gauge 107 is between the height Htp+Hsc+Hf and Htp+Hsc, wherein the former is obtained by adding the distance Hsc and the height of the intruding object Hf to the height Htp of the paper stack 103, i.e., when

Htp+Hsc<Htc≤Htp+Hsc+Hf

Therefore, if the main detection device 221 detects an object when the condition

Htp+Hsc≤Htc≤Htp+Hsc+Hf

is satisfied for the height Htc of the clamp gauge 107, it can be determined that the object is an object placed on the paper stack 103.

As the clamp gauge height detection device, devices other than those having the above-described configuration can be used. For example, a reflective distance detection device that measures the distance Hts from the lower end surface of the clamp gauge to the table can be used as the clamp gauge height detection device.

In addition, when the above-described contents are summarized using the height Hts of the main detection device 221,

Hsc=Htc−Hts

and therefore, if the main detection device 221 detects an object when

Htp+Htc−Hts≤Htc≤Htp+Htc−Hts+Hf

is satisfied, it can be determined that the object is an object placed on the paper stack 103.

In addition to this, any device that moves up and down together with the clamp gauge 107 can be used as the clamp gauge height detection device. Further, a device that measures the height of the bottom surface of the clamp gauge 107 from the table surface 101 can be used, and a device that measures the height of the top surface of the clamp gauge 107 from above the clamp gauge can also be used.

Further, if the paper stack height detection device 277 detects the height of only one point of the paper stack 103, the paper stack height detection device 277 can not detect, for example, the height of the paper stack existing only near the left end of the table 103. Therefore, a plurality of paper stack height detection devices 277 may be installed along the width direction so that at least one of them can detect the height of the paper stack.

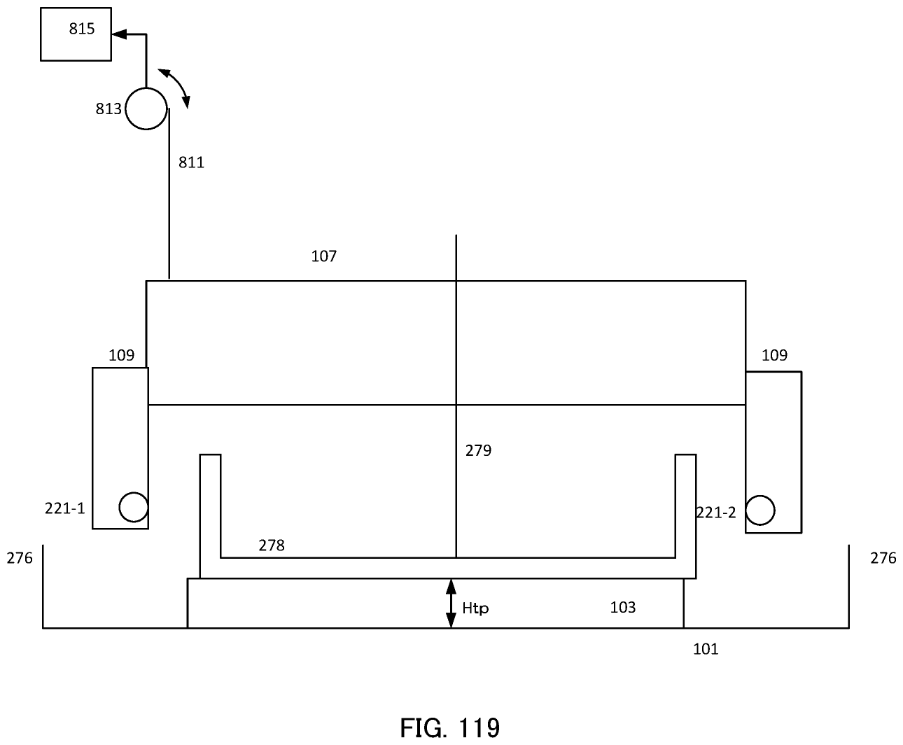

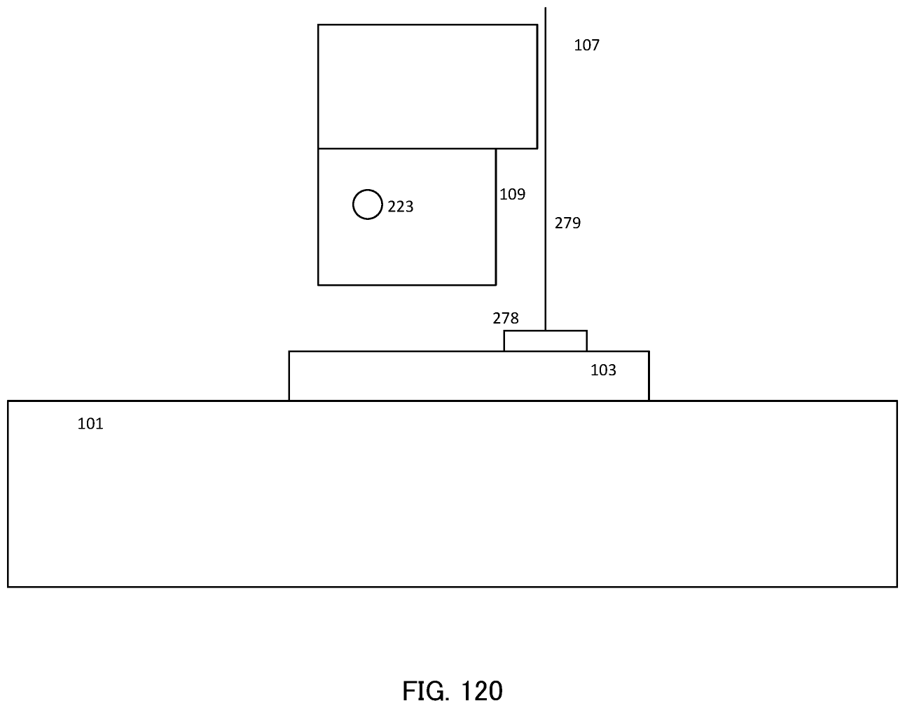

As shown in FIGS. 119 and 120, the plate 278 extending in the width direction and suspended by the suspension means 279 may be used. The height of the paper stack 103 may be measured on the basis of the height of the suspension means 279 when the suspension means 279 descends to reach the paper stack 103 which is at any position in the range of width direction.

Further, if the height of the paper stack is detected from the side surface of the table, it is possible to cope with any range of the paper stack in the width direction of the table.

Furthermore, a clamping mechanism that clamps the paper stack from above may be provided over the entire width direction of the beck gauge, and the height of the paper stack may be determined by the height of the clamping mechanism when the paper stack can be clamped by such a clamping mechanism.

### Twenty-Third Embodiment

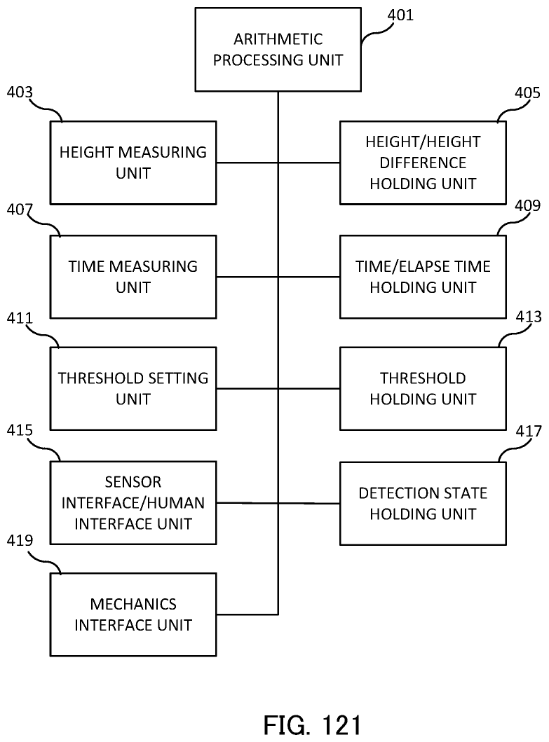

FIG. 121 is a functional block diagram showing the configuration of the clamp gauge control device according to the seventeenth embodiment of the present invention. However, this is common to the other embodiments.

Referring to FIG. 121, this clamp gauge control device includes an arithmetic processing unit 401, a height measuring unit 403, a height/height diatom holding unit 405, a time measuring unit 407, a time/elapsed time holding unit 409, a threshold setting unit 411, a threshold holding unit 413, a sensor interface/human interface unit 415, a detection state holding with 417, and a mechanism interface unit 419.

The height measurement unit 403 includes a wire 811, a rotary encoder 813, and a motion detection device 815 as illustrated in FIG. 73, but may include other components. The height measurement unit 403 measures the height when an instruction for height measurement is received from the arithmetic processing unit 401 and stores it in the height/height difference holding unit 405.

The arithmetic recessing unit 401 selects two heights from the height measured by the height measuring unit 403 or the height held in the height/height difference holding unit 405, and calculates the height difference based on the two heights and stores the height difference in the height/height difference holding unit 405.

The time measurement unit 407 measures the time when a time measurement instruction is issued from the arithmetic processing unit 401 and stores the time in the time/elapsed time holding unit 409.

The arithmetic processing unit 401 selects two times from the time measured by the time measuring unit 407 or the time held in the time/elapsed time holding unit 409, calculates the elapsed time based on the two times, and stores the time/elapsed time to the time/elapsed time holding unit 409.

The threshold setting unit 411 sets a time threshold or a height threshold based on a numerical value or the like input from the sensor interface/human interface unit 415 when a threshold setting instruction is given from the arithmetic processing unit 401, and stores such thresholds to the threshold holding unit 413.

The sensor interface/human interface unit 415 acquires the detection state/non-detection state of the detection device when instructed by the arithmetic processing unit 401, and stores it in the detection state holding unit 417. The sensor interface/human interface unit 415 performs input/output with a user as an opponent via the human interface.

The mechanism interface unit 419 obtains the state of the mechanism and outputs a signal for moving the mechanism.

The arithmetic processing unit 401 performs arithmetic processing based on the data acquired from each unit, saves the arithmetic results in various holding units, and outputs an instruction signal to the mechanism interface unit 419 based on the arithmetic results.

The clamp gauge control device described above can be realized by hardware, software, or a combination thereof. The clamp gauge control method performed by the clamp gauge central device can also be realized by hardware, software, or a combination thereof. Here, “realized by software” means realized by a computer reading and executing a program.

The program may be stored using various types of non-transitory computer readable media and supplied to the computer. Non-transitory computer readable media include various types of tangible storage media. Examples of non-transitory computer-readable media include magnetic recording media (for example, flexible disks, magnetic tapes, hard disk drives), magneto-optical recording media (for example, magneto-optical disks), CD-ROMs (Read Only Memory), CD-ROMs, R, CD-R/W, semiconductor memory (for example, mask ROM, PROM (Programmable ROM), EPROM (Erasable PROM), flash ROM, RAM (random access memory)). The program may also be supplied to the computer by various types of transitory computer readable media. Examples of transitory computer readable media include electrical signals, optical signals, and electromagnetic waves. The temporary computer-readable medium can supply the program to the computer via a wired communication path such as an electric wire and an optical fiber, or a wireless communication path.

### Twenty-Fourth Embodiment

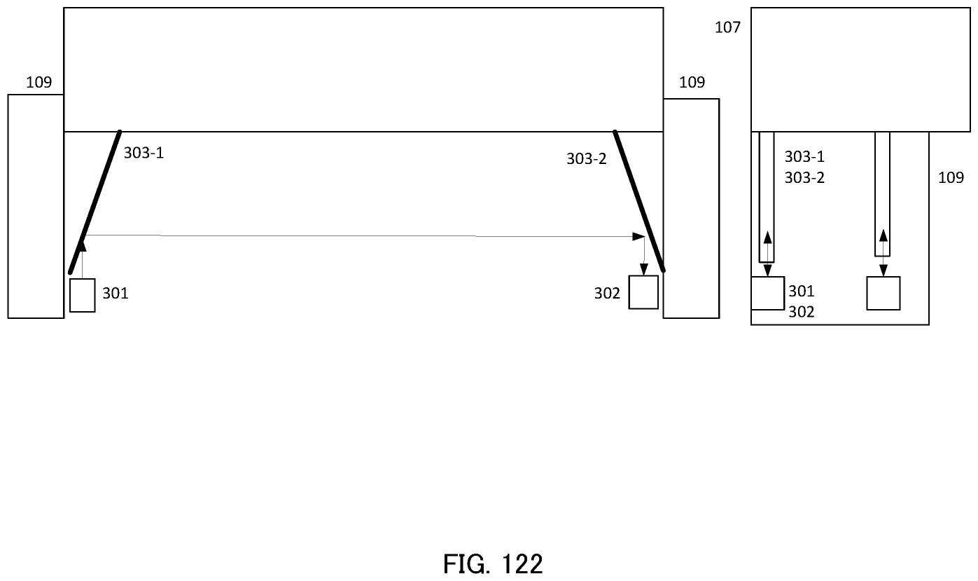

FIG. 122 shows an example of the configuration of the optical system of the line-type immediately lower front portion detection device 241 and the line-type immediately lower rear portion detection device 242.

Each of the line-type immediately lower front portion detection device 241 and the line-type immediately lower rear portion detection device 242 includes a light emission side detection device 301, a light reception side detection device 302, a first deflection element 303-1, and a second deflection element 303-2, respectively.

The light emitted upward from the light emitting side detection device 301 is deflected into light in the horizontal direction by the first deflecting element 303-1. The light traveling in the horizontal direction is deflected downward by the second deflecting element 303-2 and reaches the light receiving side detection device 302.

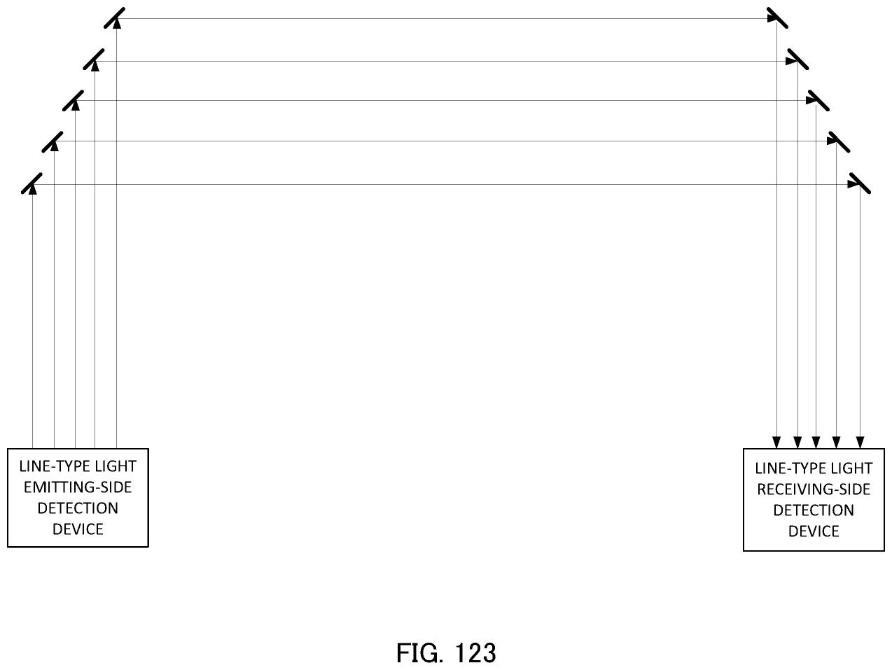

In particular, the width of the light in the horizontal direction needs to be wider than the width of the light in the upward direction and the width of the light in the downward direction. For this purpose, the first deflection element 303-1 and the second deflection element 303-2 are required to have a configuration as shown in FIG. 123, for example. The deflecting elements having such a configuration are arranged continuously in the horizontal direction and discretely in the vertical direction.

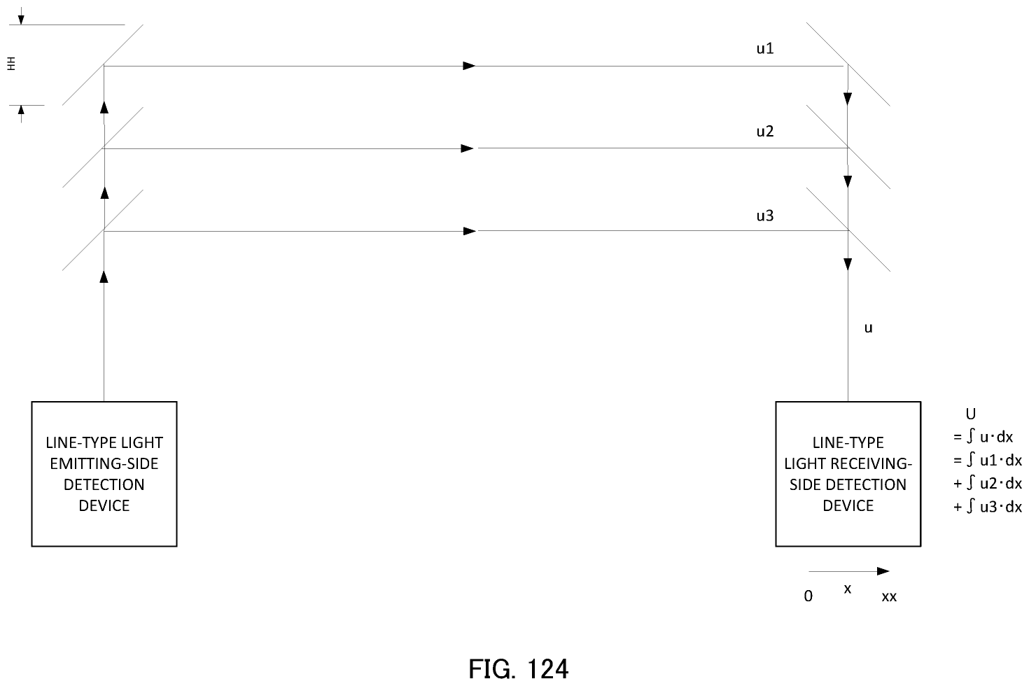

Further, the first deflection element 303-1 and the second deflection element 303-2 may have a configuration as shown in FIG. 124. The changing element having such a configuration includes a plurality of elements that transmit a part of light and deflect the remaining light by 90 degrees. For example, transmission/deflection may be switched depending on the wavelength of light, transmission/deflection may be switched in a time division manner at a predetermined frequency (for example, several kilohertz or more), or transmission/deflection may be switched depending on the polarization direction. These may be combined.

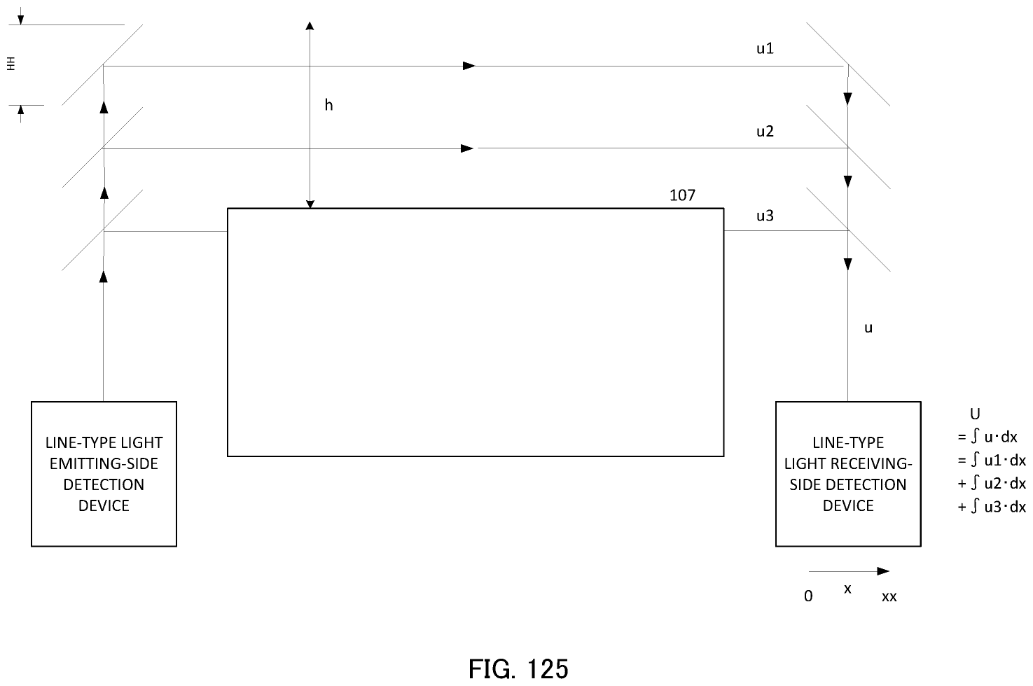

FIGS. 125 to 127 show how the light reaching from the light-emitting side detection device 301 to the light-receiving side detection device 302 changes depending on the height of the clamp gauge 107.

The received light intensity U of the light receiving side detection device 302 can be expressed as the sum of the intensity U1 of light passing through the upper part, the intensity U2 of light passing through the middle part, and the intensity U3 of light passing through the lower part.

If the height of the clamp gauge 107 is the height as shown in FIG. 125, the received light intensity U is expressed by

$$\begin{matrix}U = U 1 + U 2 + U 3 \\ = \int u 1 \cdot dx + \int u 2 \cdot dx + \int u 3 \cdot dx\end{matrix}$$

here, the integration range of

∫u1·dx

is from zero to XX corresponding to the entire light receiving range of the light receiving side device 302. Also, the integration range of

∫u2·dx

is also from zero to XX corresponding to the entire light receiving range of the light receiving side device 302. Furthermore, the integration range of

∫u3·dx

is from zero to x corresponding to the range corresponding to the height of the clamp game in the light receiving region of the light receiving side device 302.

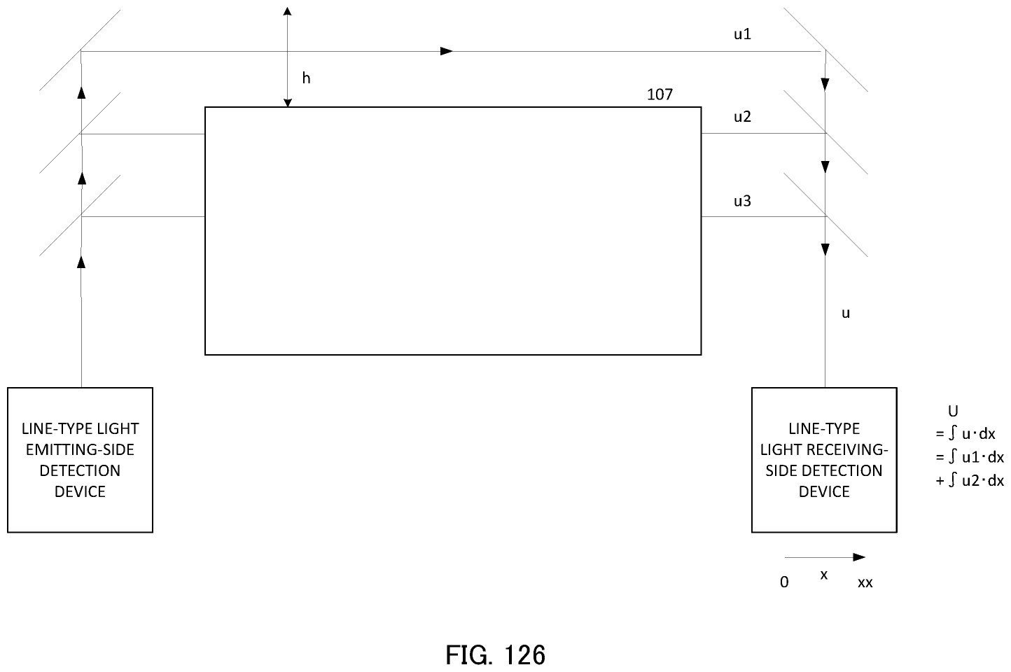

If the height of the clamp gauge 107 is the height shown in FIG. 126, the received light intensity U is expressed by

$$\begin{matrix}U = U 1 + U 2 \\ = \int u 1 \cdot dx + \int u 2 \cdot dx\end{matrix}$$

here, the integration range of

∫u1·dx

is from zero to XX corresponding to the entire light receiving of the light receiving side device 302. Also, the integration range of

∫u2·dx

is from zero to x corresponding to the range correspond to the height of the clamp gauge in the light receiving region of the light receiving side device 302.

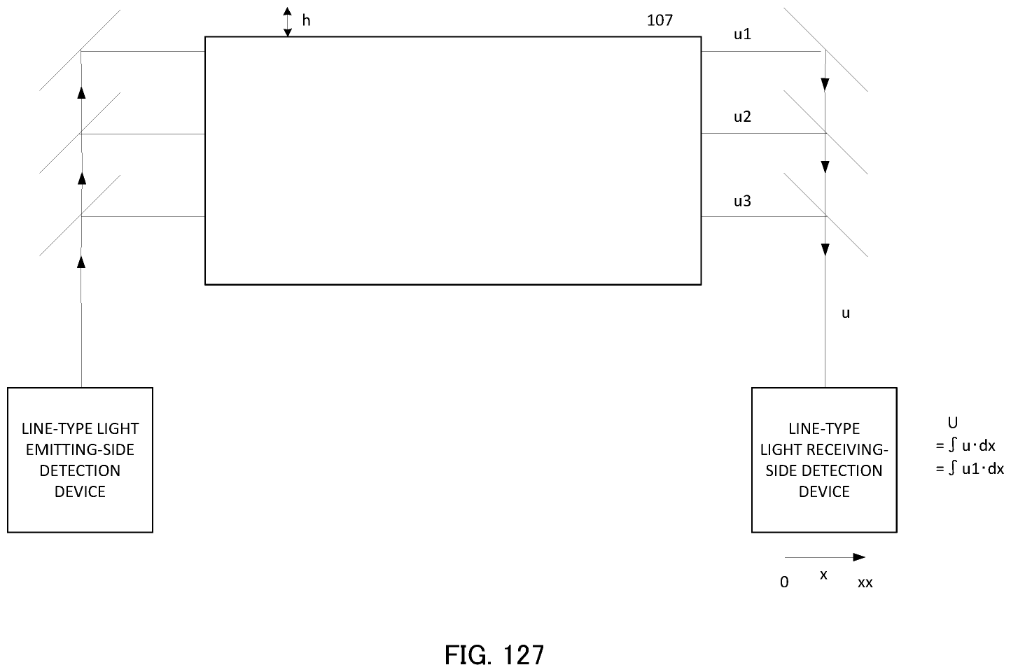

If the height of the clamp gauge 107 is the height shown in FIG. 127, the received light intensity U is expressed by

U=U1

=∫u1·dX

here, the integration range of

∫u1·dx

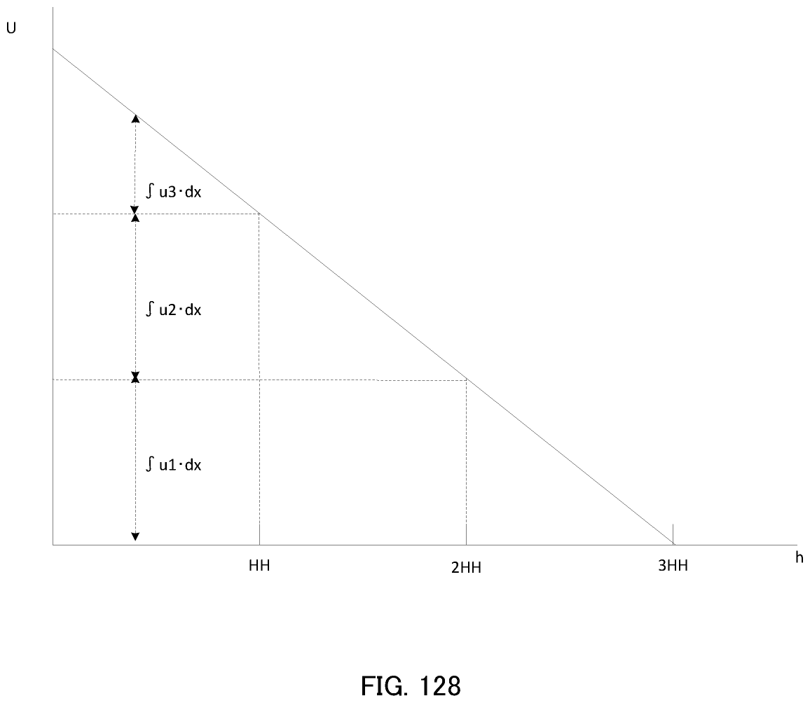

is from zero to x corresponding to the range corresponding to the height of the clamp gauge in the light receiving region of the light receiving side device 302.
Therefore, the relationship between the height of the clamp gauge 107 and the received light intensity U of the light receiving side detection device 302 is as shown in FIG. 128.

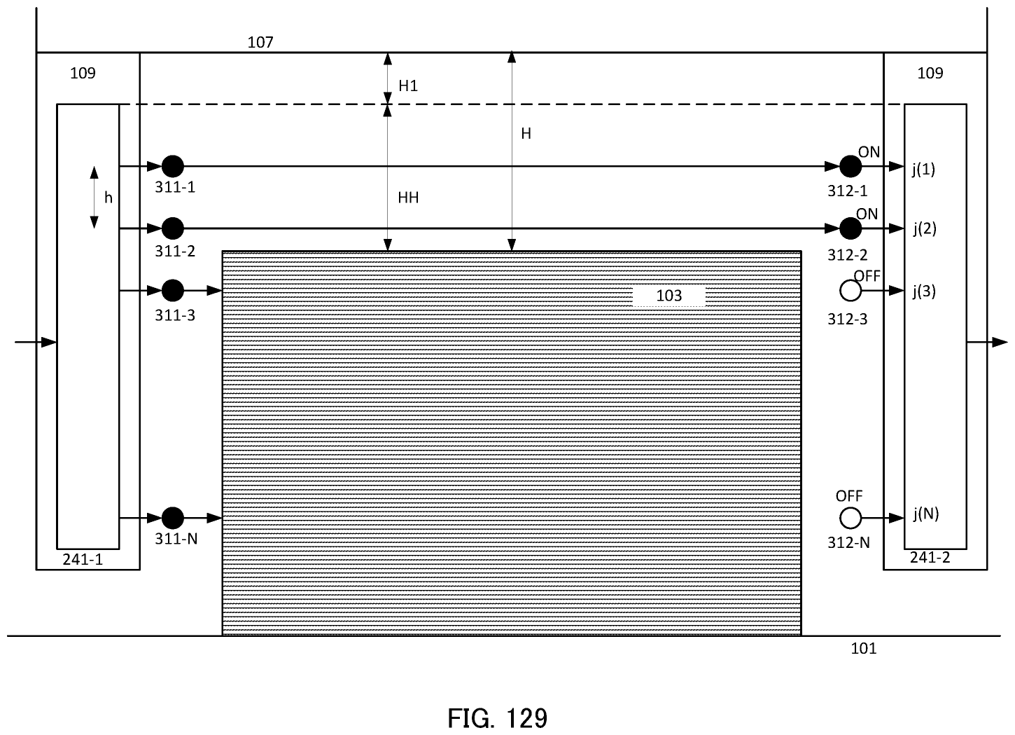

FIG. 129 is a conceptual diagram showing another configuration of the line-type immediately lower front portion detection device 241 and its peripheral portion. It should be noted that other line type detection devices such as the line-type immediately lower rear portion detection device 243 can have the same configuration.

Referring to FIG. 129, the light-emitting-side line-type immediately lower front portion detection device 241-1 includes N light emitting units 311-1, 311-2, . . . , 311-N. For example, the light-emitting-side line-type immediately lower front portion detection device 241 includes a demultiplexing unit that demultiplexes an incident bundle of light into N bundles, and the outputs of the demultiplexing unit are supplied to light emitting units 311-1 and 311-2, . . . , 311-N.

The light-receiving-side line-type immediately lower front portion detection device 241-2 includes N light-receiving units 312-1, 312-2, . . . , 312-N. For example, the light-receiving-side line-type immediately lower front portion detection device 241-2 includes therein a multiplexing unit that multiplexes the incident N bundle light into one bundle, and the lights received by the receiving units 312-1, 312-2, . . . , 312-N are supplied to the light multiplexing unit.

In the example as shown in FIG. 129, the light receiving units 312-1 and 312-2 receive light, but the light receiving units 312-3, . . . , 312-N do not receive light. In this case, if the intensities of lights received by the light receiving units 312-1 and 312-2 are respectively j(1) and j(2), the light-receiving-side line-type immediately lower front portion detection device 241-2 outputs light having an intensity of j(1)+j(2).

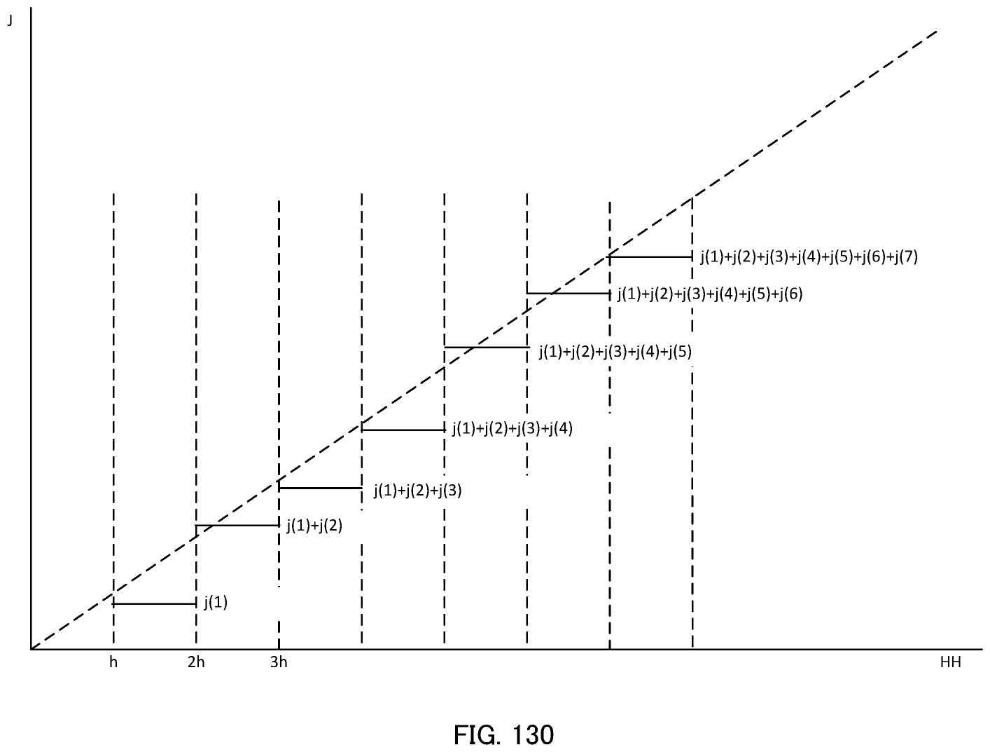

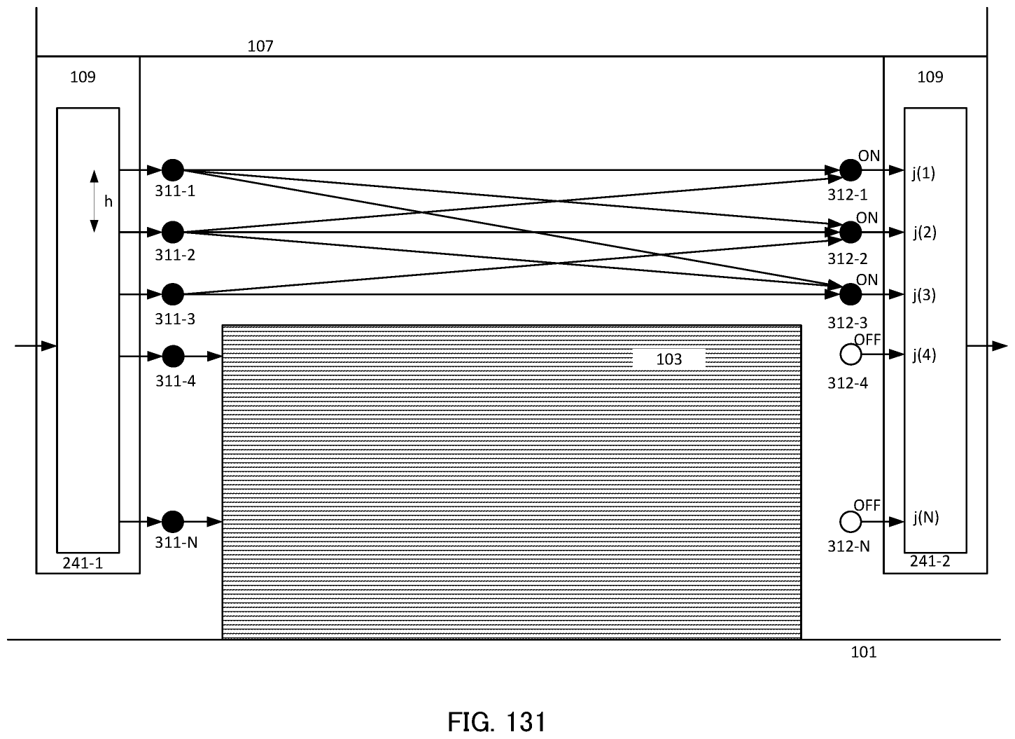

FIG. 130 shows a relationship between the distance HH and the light receiving intensity J of the light-receiving-side line-type immediately lower front portion detection device 241-2, wherein the distance HH is a distance from the lower end of the line-type immediately lower front portion detection device 241 the upper end of the paper stack 103. The distance H from the lower end of the clamp gauge 107 to the upper end of the paper stack 103 is divided into the distance H1 from the lower end of the clamp gauge 107 to the upper end of the line-type immediately lower front portion detection device 241 and the distance HH from the upper end of the line-type immediately lower front portion detection device 241 the upper end of the paper stack 103.

Starting from zero, each time the distance HH increases by h, the received light intensity J increases as follows:

$$0 ( when 0 \leq HH < h ) , \\ j ( 1 ) ( when h \leq HH < 2 h ) , \\ j ( 1 ) + j ( 2 ) ( when 2 h \leq HH < 3 h ) , \\ j ( 1 ) + j ( 2 ) + j ( 3 ) ( when 3 \leq HH < 4 h ) , \\ ⋮ \\ j ( 1 ) + j ( 2 ) + j ( 3 ) + … + j ( N - 1 ) ( when ( n - 1 ) h \leq HH < nh ) \qquad$$

Here, in general,

j(a)≠j(b) (where a≠b)

Therefore, it is possible to know the distance HH by determining whether the received light intensity J is

$$0 , \\ j ( 1 ) , \\ j ( 1 ) + j ( 2 ) , \\ j ( 1 ) + j ( 2 ) + j ( 3 ) , \\ ⋮ , or \\ j ( 1 ) + j ( 2 ) + j ( 3 ) + … + j ( N - 1 ) \qquad$$

with a resolution of h.

Here, if the received light intensity J when 0≤HH<h is measured and recorded on the recording medium as 0,

the received light intensity J when h≤HH<2h is measured and recorded on the recording medium as j(1),
the received light intensity J when 2h≤HH<3h is measured and recorded on the recording medium as j(1)+j(2),
the received light intensity J when 3h≤HH<4h is measured and record on the receding medium as j(1)+j(2)+j(3),
*
*
*
   The received light intensity J when (n−1)h≤HH<nh is measured and recorded on the recording medium as j(1)+j(2)+j(3)+ . . . +3(N−1), then the distance HH can be obtained with a resolution of h based on the light reception intensity J as described above.

Even if the light from the a-th light emitting unit 311-a reaches not only the a-th light receiving unit 312-a but also the surrounding light receiving unit (excluding the light receiving unit that cannot receive light by the paper stack 103 or the finger) as shown in GIG. 131, the relationships as mentioned above can be used.

Further, if the light emitting side and the light receiving side are reversed between the line-type immediately lower front portion detection device 241 and the line-type immediately lower rear portion detection device 242, the light interference between the two detection devices can be greedy reduced.

In addition, by operating the line-type immediately lower front portion detection device 241 and the line-type immediately lower rear portion detection device 242 in a time-sharing manner at a predetermined frequency (for example, several kilohertz or more), light interference between the detection devices can be reduced.

The present invention can be implemented in various other forms without departing from the spirit or main features thereof. Therefore, each embodiment descried above is merely an example, and should not be interpreted in a limited manner. The scope of the present invention is indicated by the claims, and is not restricted by the text of the specification. Further, all modifications and changes belonging to the equivalent scope of the claims are within the scope of the room invention.

### INDUSTRIAL APPLICABILITY

The present invention can be used for a cutting machine. Further, it can be used to avoid a moving object colliding with an obstacle.

### EXPLANATION OF SYMBOLS

101 tables
103 loading paper
107 clamp gauge
109 detection device mounting plate
221 advance detection device
223 main detection device
227 immediately lower front portion detection device
229 immediately lower rear portion detection device
231-1, 231-2, . . . , 231-n auxiliary detection device
601 clamp gauge control device
811 wire
813 rotary encoder
815 motion detection device
901 frames
905 back gauge
907 knife

1. A cutting machine for clamping a paper stack loaded on a table with a clamp gauge from above and cutting the paper stack with a knife, comprising:
a front portion detection means which is spaced apart from a lower end surface of the clamp gauge by a first predetermined distance downwardly, and which is arranged at a position near a front edge of the clamp gauge in the depth direction of the clamp gauge;
a back portion detection means which is spaced apart from the lower end surface of the clamp gauge by a second predetermined distance that is different from the first predetermined distance, and which is arranged at a position behind the front portion detection means in the depth direction of the clamp gauge; and
determination means which determines whether an unknown object is the paper stack or an intruding object on the basis of a height of the clamp gauge when detection state/non-detection state of the back portion detection means is switched due to the paper stack while the clamp gauge is moving up and down, a height of the clamp gauge when detection state/non-detection state of the front portion detection means is switched due to the unknown object while the clamp gauge is moving up and down or stational, a difference between the first predetermined distance and the second predetermined distance, and an estimated length of the intruding object along vertical direction of the clamp gauge.

2. A cutting machine for clamping a paper stack loaded on a table with a clamp gauge from above and cutting the paper stack with a knife, comprising:
a front portion detection means which is spaced apart from a lower end surface of the clamp gauge by a first predetermined distance downwardly, and which is arranged at a position near a front edge of the clamp gauge in the depth direction of the clamp gauge;
a back portion detection means which is spaced apart from the lower end surface of the clamp gauge by a second predetermined distance that is different from the first predetermined distance, and which is arranged at a position behind the front portion detection means in the depth direction of the clamp gauge; and
determination means which determines whether an unknown object is the paper stack or an intruding object on the basis of a first time when detection state/non-detection state of the back portion detection means is switched due to the paper stack while the clamp gauge is moving up and down, a second time when detection state/non-detection state of the front portion detection means is switched due to the unknown object while the clamp gauge is moving up and down continuously from the first time in the same direction, a difference between the first predetermined distance and the second predetermined distance, an ascending speed or a descending speed of the clamp gauge, and an estimated length of the intruding object along vertical direction of the clamp gauge.

3. A cutting machine for clamping a paper stack loaded on a table with a clamp gauge from above and cutting the paper stack with a knife, comprising:
a front portion detection means which is spaced apart from a lower end surface of the clamp gauge by a first predetermined distance downwardly, and which is arranged at a position near a front edge of the clamp gauge in the depth direction of the clamp gauge;
a back portion detection means which is spaced apart from the lower end surface of the clamp gauge by the first predetermined distance, and which is arranged at a position behind the front portion detection means in the depth direction of the clamp gauge; and
determination means which determines that an unknown object is an intruding object if the back portion detection means is not switched from non-detection state to detection state even a first predetermined period has elapsed from a time when the front portion detection means is switched from non-detection state to detection state due to the unknown object.

4. The cutting machine according to claim 3,
wherein the determination means determines that an unknown object is the paper stack if the back portion detection means is switched from non-detection state to detection state before the first predetermined period has elapsed from a time when the front portion detection means is switched from non-detection state to detection state due to the unknown object.

5. The cutting machine according to claim 3 or 4,
wherein the determination means determines that an unknown object is the paper stack if the front portion detection means is switched from non-detection state to detection state before a second predetermined period which is the same as or different from the first predetermined period has elapsed from a time when the back portion detection means is switched from non-detection state to detection state.

6. The cutting machine according to any one of claims 3 to 5,
wherein the determination means determines that an unknown object is an intruding object if the front portion detection means is switched from non-detection state to detection state by the unknown object and the clamp gauge has not descended more than a predetermined distance in a predetermined period including the switching of the front portion detection means, while the back portion detection means is kept in detection state and the front portion detection means is kept in non-detection state.

7. The cutting machine according to any one of claims 3 to 6,
wherein the determination means determines that an unknown object is a paper stack if the front portion detection means is switched from non-detection state to detection state by the unknown object and the clamp gauge has descended more than a predetermined distance in a predetermined period including the switching of the front portion detection means, while the back portion detection means is kept in detection state and the front portion detection means is kept in non-detection state.

8. A cutting machine for clamping a paper stack loaded on a table with a clamp gauge from above and cutting the paper stack with a knife, comprising:
a front portion detection means which is arranged at a position near a front edge of the clomp gauge in the depth direction of the clamp gauge and which measures a distance, as a front portion distance, from an object which is disposed under the front edge of the clamp gauge to the clamp gauge;
a back portion detection means which is arranged at a position behind the front portion detection means in the depth direction of the clamp gauge and which measures a distance, as a back position distance, from an object to the clamp gauge at a position in the depth direction which is behind the position at which the front portion detection means measures the front position distance; and
determination means which determines whether an intruding object is on the paper stack on the basis of a difference between the front portion distance and the back portion distance.

9. A cutting machine for clamping a paper stack loaded on a table with a clamp gauge from above and carting the paper stack with a knife, comprising:
a front portion detection means which is arranged at a position near a front edge of the clamp gauge in the depth direction of the clamp gauge and which measures a distance, as a front portion distance, from an object which is disposed under the front edge of the clamp gauge to the clamp gauge;
a back portion detection means which is arranged at a position behind the front portion detection means in the depth direction of the clamp gauge and which measures a distance, as a back position distance, from an object to the clamp gauge at a position in the depth direction which is behind the position at which the front portion detection means measures the front position distance; and
determination means which determines whether an intruding object is on the paper stack on the basis of a temporal change of a difference between the front portion distance and the back portion distance.

10. A cutting machine for clamping a paper stack loaded on a table with a clamp gauge from above and cutting the paper stack with a knife, comprising:
a front portion detections means which is arranged at a position near a front edge of the clamp gauge in the depth direction of the clamp gauge and which measures a distance, as a front portion distance, from an object which is disposed under the front edge of the clamp gauge to the clamp gauge;
height detection means for measuring a height of the claim gauge; and
determination means which determines whether an intruding object is on the paper stack on the basis of a temporal change of a difference between the front portion distance and the height.

11. The cutting machine according to any one of claims 1 to 10,
collision avoiding means for operating either one or both of the clamp gauge and the knife to take collision avoidance movement.
